(19) United States
(12) Patent Application Publication
(10) Pub. No.: US 2025/0175743 A1
(43) Pub. Date: May 29, 2025

(54) ACOUSTIC APPARATUS

(71) Applicant: LG Display Co., Ltd., Seoul (KR)

(72) Inventors: Taehyung KIM, Paju-si (KR); GyungBo HA, Paju-si (KR); SeulKi NAM, Paju-si (KR)

(73) Assignee: LG Display Co., Ltd., Seoul (KR)

(21) Appl. No.: 18/399,057

(22) Filed: Dec. 28, 2023

(30) Foreign Application Priority Data
Nov. 28, 2023 (KR) 10-2023-0168256

(51) Int. Cl. H04R 17/00

(52) U.S. Cl. CPC H04R 17/00

(57) ABSTRACT

An acoustic apparatus in on example includes a vibration member having a first length in a first direction that is longer than a second length in a second direction perpendicular to the first direction, at least one vibration apparatus including a long side in the second direction, and a housing including an internal space provided at a rear surface of the vibration member.

### CROSS-REFERENCE TO RELATED APPLICATION

This application claims priority to Korean Patent Application No. 10-2023-0168256 filed in the Republic of Korea on Nov. 28, 2023, the entire contents of which is hereby expressly incorporated by reference into the present application.

### BACKGROUND OF THE DISCLOSURE

### Technical Field

The present disclosure relates to an acoustic apparatus.

### Discussion of the Related Art

Speakers applied to acoustic apparatuses can be, for example, an actuator including a magnet and a coil. In a case where an actuator is applied to an apparatus, there is a drawback where a thickness of an acoustic apparatus is increased. To reduce the thickness, Piezoelectric devices for implementing a slim acoustic apparatus are attracting much attention, and research is ongoing to better use piezoelectric devices to generate sound in the acoustic apparatus.

Acoustic apparatuses including a piezoelectric device are lightweight and have low power consumption, and thus, are being used for various purposes such as speakers. In piezoelectric devices, a lowest resonance frequency increases due to high stiffness of the piezoelectric device, and due to this, a sound pressure level of a low-pitched sound band is often insufficient to provide a full range of sounds and volumes. Therefore, acoustic apparatuses including a piezoelectric device have a technical problem where a sound pressure level of the low-pitched sound band is insufficient.

### SUMMARY OF THE DISCLOSURE

Therefore, the inventors have recognized the limitations described above and have performed extensive research and experiments for enhancing a sound characteristic and/or a sound pressure level characteristic of a low-pitched sound band of an acoustic apparatus. Based on extensive research and experiments, the inventors have invented an apparatus which can enhance a sound characteristic and/or a sound pressure level characteristic of the low-pitched sound band of the acoustic apparatus.

An aspect of the present disclosure is directed to providing an acoustic apparatus which can enhance a sound characteristic and/or a sound pressure level characteristic of a low-pitched sound band and can enhance a flatness characteristic of a sound pressure level of a middle-low-pitched sound band and a high-pitched sound band.

Additional features and aspects will be set forth in the description that follows, and in part will be apparent from the description, or can be learned by practice of the inventive concepts provided herein. Other features and aspects of the inventive concepts can be realized and attained by the structure particularly pointed out in the written description, or derivable therefrom, and the claims hereof as well as the appended drawings.

An acoustic apparatus according to one or more embodiments of the present disclosure can include a vibration member having a first length in a first direction that is longer than a second length in a second direction perpendicular to the first direction, at least one vibration apparatus including a long side in the second direction, and a housing including an internal space provided in a rear surface of the vibration member.

An acoustic apparatus according to various embodiments of the present disclosure can include a vibration member having a first length in a first direction and a second length in a second direction, the first length of the vibration member being greater than the second length of the vibration member, a vibration apparatus on the vibration member and having a first length in the first direction and a second length in the second direction, the second length of the vibration apparatus being greater than the first length of the vibration apparatus, and a housing under the vibration member and having a first length in the first direction and a second length in the second direction, the first length of the housing being greater than the second length of the housing. The first length of the housing can be greater than or equal to the first length of the vibration member, and the second length of the housing can be greater than or equal to the second length of the vibration member.

According to an embodiment of the present disclosure, an acoustic apparatus can be provided where a sound characteristic and/or a sound pressure level characteristic of a low-pitched sound band can be enhanced and a flatness characteristic of a sound pressure level of a middle-low-pitched sound band and a high-pitched sound band can be enhanced.

According to an embodiment of the present disclosure, a piezoelectric device which is lightweight and has low power consumption can be used, and a sound characteristic and/or a sound pressure level characteristic of a low-pitched sound band can be enhanced, thereby providing an acoustic apparatus which is implemented or configured to be lightweight or have low power consumption.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the present disclosure. Nothing in this section should be taken as a limitation on the present disclosure. Further aspects and advantages are discussed below in conjunction with aspects of the disclosure.

It is to be understood that both the foregoing description and the following description are exemplary and explanatory and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain principles of the disclosure.

FIG. 1 illustrates an acoustic apparatus according to an embodiment of the present disclosure;

FIG. 2 is a cross-sectional view taken along line I-I′ illustrated in FIG. 1 according to an embodiment of the present disclosure;

FIG. 3 illustrates an acoustic apparatus according to an embodiment of the present disclosure;

FIG. 4 illustrates an acoustic apparatus according to another embodiment of the present disclosure;

FIG. 5 illustrates an acoustic apparatus according to another embodiment of the present disclosure;

FIG. 6 is a cross-sectional view taken along line A-A′ illustrated in FIG. 3 according to another embodiment of the present disclosure;

FIG. 7 is a cross-sectional view taken along line B-B′ illustrated in FIG. 4 according to another embodiment of the present disclosure;

FIG. 8 is a cross-sectional view taken along line C-C′ illustrated in FIG. 5 according to another embodiment of the present disclosure;

FIG. 9 is a cross-sectional view taken along line C-C′ illustrated in FIG. 5 according to another embodiment of the present disclosure;

FIG. 10 is a cross-sectional view taken along line C-C′ illustrated in FIG. 5 according to another embodiment of the present disclosure;

FIG. 11 is a cross-sectional view taken along line C-C′ illustrated in FIG. 5 according to another embodiment of the present disclosure;

FIG. 12 is a cross-sectional view taken along line C-C′ illustrated in FIG. 5 according to another embodiment of the present disclosure;

FIG. 13 is a cross-sectional view taken along line C-C′ illustrated in FIG. 5 according to another embodiment of the present disclosure;

FIG. 14 illustrates an acoustic apparatus according to another embodiment of the present disclosure;

FIG. 15 illustrates an acoustic apparatus according to another embodiment of the present disclosure;

FIG. 16 illustrates an acoustic apparatus according to another embodiment of the present disclosure;

FIG. 17 illustrates an acoustic apparatus according to another embodiment of the present disclosure;

FIG. 18 illustrates an acoustic apparatus according to another embodiment of the present disclosure;

FIG. 19 illustrates a vibration apparatus according to an embodiment of the present disclosure;

FIG. 20 is a cross-sectional view taken along line II-II′ illustrated in FIG. 19 according to an embodiment of the present disclosure;

FIG. 21 is a cross-sectional view taken along line III-III′ illustrated in FIG. 19 according to an embodiment of the present disclosure;

FIG. 22 illustrates a vibration portion according to another embodiment of the present disclosure;

FIG. 23 illustrates a vibration portion according to another embodiment of the present disclosure;

FIG. 24 illustrates an acoustic apparatus according to another embodiment of the present disclosure;

FIG. 25 is a cross-sectional view taken along line IV-IV′ illustrated in FIG. 24 according to another embodiment of the present disclosure;

FIG. 26 is a cross-sectional view taken along line V-V′ illustrated in FIG. 24 according to another embodiment of the present disclosure;

FIG. 27 is a cross-sectional view taken along line IV-IV′ illustrated in FIG. 24 according to another embodiment of the present disclosure;

FIG. 28 is a cross-sectional view taken along line V-V′ illustrated in FIG. 24 according to another embodiment of the present disclosure;

FIG. 29 is a cross-sectional view taken along line IV-IV′ illustrated in FIG. 24 according to another embodiment of the present disclosure;

FIG. 30 is a cross-sectional view taken along line V-V′ illustrated in FIG. 24 according to another embodiment of the present disclosure;

FIG. 31 is an exploded perspective view illustrating an acoustic apparatus according to another embodiment of the present disclosure;

FIG. 32 illustrates an acoustic apparatus according to another embodiment of the present disclosure;

FIG. 33 illustrates an acoustic apparatus according to another embodiment of the present disclosure;

FIG. 34 illustrates an acoustic apparatus according to another embodiment of the present disclosure;

FIG. 35 illustrates a driving circuit of an acoustic apparatus according to an embodiment of the present disclosure;

FIG. 36 illustrates a sound output characteristic of an acoustic apparatus according to an embodiment of the present disclosure;

FIG. 37 illustrates a sound output characteristic of an acoustic apparatus according to an embodiment of the present disclosure;

FIG. 38 illustrates a sound output characteristic of an acoustic apparatus according to an embodiment of the present disclosure;

FIG. 39 illustrates a total harmonic distortion characteristic of an acoustic apparatus according to an embodiment of the present disclosure;

FIG. 40 illustrates a sound output characteristic of an acoustic apparatus according to an embodiment of the present disclosure;

FIG. 41 illustrates a total harmonic distortion characteristic of an acoustic apparatus according to an embodiment of the present disclosure; and

FIG. 42 illustrates an impulse response characteristic of an acoustic apparatus according to an embodiment of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof can be exaggerated for clarity, illustration, and/or convenience.

### DETAILED DESCRIPTION OF THE EMBODIMENTS

Reference is now made in detail to embodiments of the present disclosure, examples of which can be illustrated in the accompanying drawings. In the following description, when a detailed description of well-known functions, structures or configurations can unnecessarily obscure aspects of the present disclosure, the detailed description thereof can have been omitted for brevity. Further, repetitive descriptions can be omitted for brevity. The progression of processing steps and/or operations described is an example.

The sequence of steps and/or operations is not limited to that set forth herein and can be changed to occur in an order that is different from an order described herein, with the exception of steps and/or operations necessarily occurring in a particular order. In one or more examples, two operations in succession can be performed substantially concurrently, or the two operations can be performed in a reverse order or in a different order depending on a function or operation involved.

Unless stated otherwise, like reference numerals can refer to like elements throughout even when they are shown in different drawings. In one or more aspects, identical elements (or elements with identical names) in different drawings can have the same or substantially the same functions and properties unless stated otherwise. Names of the respective elements used in the following explanations are selected only for convenience and can be thus different from those used in actual products.

Advantages and features of the present disclosure, and implementation methods thereof, are clarified through the embodiments described with reference to the accompanying drawings. The present disclosure can, however, be embodied in different forms and should not be construed as limited to the embodiments set forth herein. Rather, these embodiments are examples and are provided so that this disclosure can be thorough and complete, to assist those skilled in the art to understand the inventive concepts without limiting the protected scope of the present disclosure.

Shapes (e.g., sizes, lengths, widths, heights, thicknesses, locations, radii, diameters, and areas), sizes, ratios, angles, numbers, and the like disclosed herein, including those illustrated in the drawings are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

When the term “comprise,” “have,” “include,” “contain,” “constitute,” “made of,” “formed of,” or the like is used with respect to one or more elements, one or more other elements can be added unless a term such as “only” or the like is used. The terms used in the present disclosure are merely used in order to describe example embodiments, and are not intended to limit the scope of the present disclosure. The terms of a singular form can include plural forms unless the context clearly indicates otherwise.

The word “exemplary” is used to mean serving as an example or illustration. Aspects are example aspects. “Embodiments,” “examples,” “aspects,” and the like should not be construed as preferred or advantageous over other implementations. An embodiment, an example, an example embodiment, an aspect, or the like can refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range can be caused by various factors (e.g., process factors, internal or external impact, noise, or the like). In interpreting a numerical value, the value is interpreted as including an error range unless explicitly stated otherwise.

In describing a positional relationship, when the positional relationship between two parts (e.g., layers, films, regions, components, sections, or the like) is described, for example, using “on,” “upon,” “on top of,” “over,” “under,” “above,” “below,” “beneath,” “near,” “close to,” “adjacent to,” “beside,” “next to,” “at or on a side of,” or the like, one or more parts can be located between two other parts unless a more limiting term, such as “immediate(ly),” “direct(ly),” or “close(ly),” is used. For example, when a structure is described as being positioned “on,” “upon,” “on top of,” “over,” “under,” “above,” “below,” “beneath,” “near,” “close to,” “adjacent to,” “beside,” “next to,” “at or on a side of,” or the like another structure, this description should be construed as including a case in which the structures contact each other as well as a case in which one or more additional structures are disposed or interposed therebetween. Furthermore, the terms “front,” “rear,” “back,” “left,” “right,” “top,” “bottom,” “downward,” “upward,” “upper,” “lower,” “up,” “down,” “column,” “row,” “vertical,” “horizontal,” and the like refer to an arbitrary frame of reference.

Spatially relative terms, such as “below,” “beneath,” “lower,” “on,” “above,” “upper” and the like, can be used to describe a correlation between various elements (e.g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, can include all directions of “above” and “below.” Likewise, an exemplary term “above” or “on” can include both directions of “above” and “below.”

In describing a temporal relationship, when the temporal order is described as “after,” “subsequent,” “next,” “before,” “preceding,” “prior to,” or the like a case which is not consecutive or not sequential can be included and thus one or more other events can occur therebetween, unless a more limiting term, such as “just,” “immediate(ly),” or “direct(ly)” is used.

The terms, such as “below,” “lower,” “above,” “upper” and the like, can be used herein to describe a relationship between element(s) as illustrated in the drawings. It will be understood that the terms are spatially relative and based on the orientation depicted in the drawings.

It is understood that, although the terms “first”, “second,” or the like can be used herein to describe various elements (e.g., layers, films, regions, components, sections, or the like), these elements should not be limited by these terms, for example, to any particular order, sequence, precedence, or number of elements. These terms are used only to partition one element from another. For example, a first element could be a second element, and, similarly, a second element could be a first element, without departing from the scope of the present disclosure. Furthermore, the first element, the second element, and the like can be arbitrarily named according to the convenience of those skilled in the art without departing from the scope of the present disclosure. For clarity, the functions or structures of these elements (e.g., the first element, the second element and the like) are not limited by ordinal numbers or the names in front of the elements. Further, a first element can include one or more first elements. Similarly, a second element or the like can include one or more second elements or the like.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element (e.g., layer, film, region, component, section, or the like) is “connected,” “coupled,” “attached,” “adhered,” or the like to another element, the element can not only be directly connected, coupled, attached, adhered, or the like to another element, but also be indirectly connected, coupled, attached, adhered, or the like to another element with one or more intervening elements disposed or interposed between the elements, unless otherwise specified.

For the expression that an element (e.g., layer, film, region, component, section, or the like) is “contacts,” “overlaps,” or the like with another element, the element can not only directly contact, overlap, or the like with another element, but also indirectly contact, overlap, or the like with another element with one or more intervening elements disposed or interposed between the elements, unless otherwise specified.

The phase that an element (e.g., layer, film, region, component, section, or the like) is “provided in,” “disposed in,” or the like in another element can be understood as that at least a portion of the element is provided in, disposed in, or the like in another element, or that the entirety of the element is provided in, disposed in, or the like in another element. The phase that an element (e.g., layer, film, region, component, section, or the like) “contacts,” “overlaps,” or the like with another element can be understood as that at least a portion of the element contacts, overlaps, or the like with a least a portion of another element, that the entirety of the element contacts, overlaps, or the like with a least a portion of another element, or that at least a portion of the element contacts, overlaps, or the like with the entirety of another element.

The terms such as a “line” or “direction” should not be interpreted only based on a geometrical relationship in which the respective lines or directions are parallel or perpendicular to each other, and can be meant as lines or directions having wider directivities within the range within which the components of the present disclosure can operate functionally. For example, the terms “first direction,” “second direction,” and the like, such as a direction parallel or perpendicular to “x-axis,” “y-axis,” or “z-axis,” should not be interpreted only based on a geometrical relationship in which the respective directions are parallel or perpendicular to each other, and can be meant as directions having wider directivities within the range within which the components of the present disclosure can operate functionally.

The term “at least one” should be understood as including any and all combinations of one or more of the associated listed items. For example, each of the phrases of “at least one of a first item, a second item, or a third item” and “at least one of a first item, a second item, and a third item” can represent (i) a combination of items provided by two or more of the first item, the second item, and the third item or (ii) only one of the first item, the second item, or the third item.

The expression of a first element, a second elements “and/or” a third element should be understood as one of the first, second and third elements or as any or all combinations of the first, second and third elements. By way of example, A, B and/or C can refer to only A; only B; only C; any of A, B, and C (e.g., A, B, or C); or some or some combination of A, B, and C (e.g., A and B; A and C; or B and C); or all of A, B, and C. Furthermore, an expression “A/B” can be understood as A and/or B. For example, an expression “A/B” can refer to only A; only B; A or B; or A and B.

In one or more aspects, the terms “between” and “among” can be used interchangeably simply for convenience unless stated otherwise. For example, an expression “between a plurality of elements” can be understood as among a plurality of elements. In another example, an expression “among a plurality of elements” can be understood as between a plurality of elements. In one or more examples, the number of elements can be two. In one or more examples, the number of elements can be more than two. Furthermore, when an element (e.g., layer, film, region, component, sections, or the like) is referred to as being “between” at least two elements, the element can be the only element between the at least two elements, or one or more intervening elements can also be present.

In one or more aspects, the phrases “each other” and “one another” can be used interchangeably simply for convenience unless stated otherwise. For example, an expression “different from each other” can be understood as being different from one another. In another example, an expression “different from one another” can be understood as being different from each other. In one or more examples, the number of elements involved in the foregoing expression can be two. In one or more examples, the number of elements involved in the foregoing expression can be more than two.

In one or more aspects, the phrases “one or more among” and “one or more of” can be used interchangeably simply for convenience unless stated otherwise.

The term “or” means “inclusive or” rather than “exclusive or.” For example, unless otherwise stated or clear from the context, the expression that “x uses a or b” means any one of natural inclusive permutations. For example, “a or b” can mean “a,” “b,” or “a and b.” For example, “a, b or c” can mean “a,” “b,” “c,” “a and b,” “b and c,” “a and c,” or “a, b and c.”

Features of various embodiments of the present disclosure can be partially or entirety coupled to or combined with each other, can be technically associated with each other, and can be variously inter-operated, linked or driven together. The embodiments of the present disclosure can be implemented or carried out independently of each other, or can be implemented or carried out together in a co-dependent or related relationship. In one or more aspects, the components of each apparatus according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein.

The terms used herein have been selected as being general in the related technical field; however, there can be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term can be arbitrarily selected by an applicant, and in this case, the detailed meaning thereof is described herein. Therefore, the terms used herein should be understood based on not only the name of the terms, but also the meaning of the terms and the content hereof.

In present disclosure, a display apparatus including a vibration apparatus can be implemented with a user interface device such as a central control panel in automobiles, and thus, can be applied to vehicles.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

In the following description, various example embodiments of the present disclosure are described in detail with reference to the accompanying drawings. With respect to reference numerals to elements of each of the drawings, the same elements can be illustrated in other drawings, and like reference numerals can refer to like elements unless stated otherwise. The same or similar elements can be denoted by the same reference numerals even though they are depicted in different drawings. In addition, for convenience of description, a scale, dimension, size, and thickness of each of the elements illustrated in the accompanying drawings can be different from an actual scale, dimension, size, and thickness, and thus, embodiments of the present disclosure are not limited to a scale, dimension, size, and thickness illustrated in the drawings.

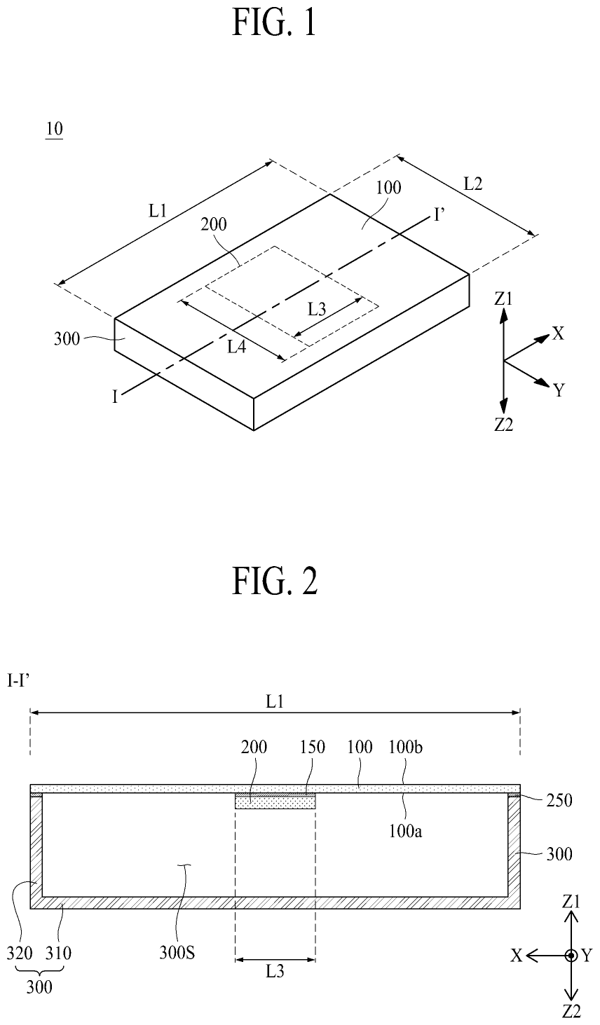

FIG. 1 illustrates an acoustic apparatus 10 according to an embodiment of the present disclosure. FIG. 2 is a cross-sectional view taken along line I-I′ illustrated in FIG. 1 according to an embodiment of the present disclosure. All components of each acoustic apparatus according to all embodiments of the present disclosure are operatively coupled and configured.

Referring to FIGS. 1 and 2, the acoustic apparatus 10 according to an embodiment of the present disclosure can implement or configure a sound output apparatus, a sound generating apparatus, a sound bar, an acoustic system, an acoustic apparatus for electronic devices, an acoustic apparatus for displays, an acoustic apparatus for vehicular apparatuses, or a sound bar for vehicular apparatuses. For example, the vehicular apparatus can include a vehicle, a train, a ship, or an aircraft, but embodiments of the present disclosure are not limited thereto. The acoustic apparatus 10 according to an embodiment of the present disclosure can be configured to be transparent, semitransparent, or opaque.

The acoustic apparatus 10 according to an embodiment of the present disclosure can include a vibration member 100, a vibration apparatus 200, and a housing 300.

The vibration member 100 can generate a vibration or can output a sound (or a sound wave), based on a displacement (or driving) of the vibration apparatus 200. The vibration member 100 can be a vibration object, a passive vibration plate, a vibration panel, a sound plate, a sound panel, a passive vibration panel, a sound output plate, or a sound vibration plate, but embodiments of the present disclosure are not limited thereto.

The vibration member 100 can include a polygonal shape such as a rectangular shape or a square shape, a circular shape, an oval shape, or a round-polygonal shape, and other shapes or patterns, but embodiments of the present disclosure are not limited thereto. The vibration member 100 can include a first length L1 parallel to a first direction X and a second length L2 parallel to a second direction Y. For example, with respect to the same plane, the first direction X can be a first horizontal direction or a first length L1 direction of the vibration member 100 (or a long-side direction of the vibration member), and the second direction Y can be a second horizontal direction perpendicular to the first direction X or a second length L2 direction of the vibration member 100 (or a short-side direction of the vibration member).

The vibration member 100 according to an embodiment of the present disclosure can include a shape where the first length L1 parallel to the first direction X is longer than the second length L2 parallel to the second direction Y perpendicular to the first direction X. For example, the vibration member 100 can include a tetragonal shape or a rectangular shape, an oval shape, or a round-polygonal shape having a curved shape (or a round shape). But embodiments of the present disclosure are not limited thereto. For example, the vibration member 100 can include a tetragonal shape or a rectangular shape, an oval shape, or a round-polygonal shape having a curved shape (or a round shape), where the first length L1 parallel to the first direction X is longer than the second length L2 parallel to the second direction Y perpendicular to the first direction X, but embodiments of the present disclosure are not limited thereto.

The vibration member 100 can include a structure which entirely has the same thickness, but embodiments of the present disclosure are not limited thereto. For example, the vibration member 100 can include a plate structure which entirely has the same thickness, but embodiments of the present disclosure are not limited thereto as the plate structure can have portions with different thicknesses. For example, the vibration member 100 can include a nonplanar structure including a convex portion and/or a concave portion.

According to an embodiment of the present disclosure, the vibration member 100 can include a first surface 100a and a second surface 100b opposite to (or different from) the first surface 100a. For example, in the vibration member 100, the first surface 100a can be a rear surface, a backside surface, or a lower surface in a direction (or a vertical direction of a lower portion Z2) facing the housing 300, and the second surface 100b can be a front surface or an upper surface in a direction (or a vertical direction of an upper portion Z1) facing air, but embodiments of the present disclosure are not limited thereto.

The vibration member 100 according to an embodiment of the present disclosure can be configured to be transparent, semitransparent, or opaque. The vibration member 100 can include a material (or a substance) having a material characteristic suitable for outputting a sound, based on a vibration. For example, the vibration member 100 can include one or more materials (or substances) of a metal material, plastic, fiber reinforced plastic, fiber, leather, wood, cloth, rubber, carbon, glass, and paper, but embodiments of the present disclosure are not limited thereto. For example, the paper can be cone paper for speakers. For example, the cone paper can be pulp or foamed plastic, but embodiments of the present disclosure are not limited thereto.

According to an embodiment of the present disclosure, the metal material of the vibration member 100 can include one or more of stainless steel, aluminum (Al), an Al alloy, magnesium (Mg), a Mg alloy, a copper (Cu) alloy, and a magnesium-lithium (Mg—Li) alloy, but embodiments of the present disclosure are not limited thereto.

According to an embodiment of the present disclosure, the plastic material of the vibration member 100 can include polycarbonate, polyethylene terephthalate, polyarylate, polyethylene naphthalate, polysulfone, polyethersulfone, or cyclo-olefin copolymer, but embodiments of the present disclosure are not limited thereto. For example, the styrene material can be an acrylonitrile-butadiene-styrene (ABS) material. The ABS material can be acrylonitrile, butadiene, and styrene.

According to an embodiment of the present disclosure, the fiber reinforced plastic of the vibration member 100 can be carbon fiber reinforced plastic (CFRP), but embodiments of the present disclosure are not limited thereto.

According to another embodiment of the present disclosure, the vibration member 100 can include a porous material. For example, the vibration member 100 can include a micro cellular plastic material. For example, the vibration member 100 can include a micro cellular polyethylene terephthalate (MCPET) material. The vibration member 100 including MCPET can be low in density and good in elastic force and can thus have a source sound reproduction capability, thereby enhancing the quality of a sound. For example, the vibration member 100 having the porous material can have the amount of displacement (or bending force or driving force) which is relatively large with respect to a vibration (or displacement) of the vibration apparatus 200, based on porosity, and thus, a sound characteristic and/or a sound pressure level characteristic of a low-pitched sound band generated based on a vibration of the vibration member 100 can be improved. Accordingly, in the vibration member 100 having the porous material, a dip phenomenon and a peak phenomenon can decrease in a sound of the low-pitched sound band generated based on a vibration, and a sound pressure level of the low-pitched sound band can increase. For example, the number of dip portions and peak portions can decrease in a sound of 1 kHz or less generated based on a vibration, and thus, the flatness of a sound can be enhanced. The flatness of a sound pressure level can be a difference between a highest sound pressure level and a lowest sound pressure level in a specific frequency.

According to another embodiment of the present disclosure, the vibration member 100 can be a single layer, or can be a plurality of layers, such as two or more layers. When the vibration member 100 is a single layer, the vibration member 100 can include a single type of material or can include a combination of materials. When the vibration member 100 includes two or more layers, the two or more layers can be sheets of the same material, sheets of different materials, sheets of combinations of same and different materials, or each sheet can be combinations of different materials. When the vibration member 100 includes two or more layers, the two or more layers can have thicknesses that are the same or different.

The vibration apparatus 200 can be configured to vibrate the vibration member 100. The vibration apparatus 200 can be disposed or configured in the vibration member 100. The vibration apparatus 200 can be disposed or configured on at least one surface of the vibration member 100. For example, the vibration apparatus 200 can be disposed or configured at a first surface 100a (or a rear surface) of the vibration member 100. Alternatively, the vibration apparatus 200 can be disposed or configured at a second surface 100b (or a front surface) of the vibration member 100. Alternatively, the vibration apparatus 200 can be provided as one or more and can be disposed or configured at each of the first surface 100a (or the rear surface) and the second surface 100b (or the front surface) of the vibration member 100. The vibration apparatus 200 can vibrate based on a driving signal (or a vibration driving signal or a voice signal) applied from a driving circuit to vibrate (or displace or drive) the vibration member 100. For example, the vibration apparatus 200 can be an active vibration member, a vibration generator, a vibration structure material, a vibrator, a vibration generating device, a sound generator, a sound device, a sound generating structure material, or a sound generating device, but embodiments of the present disclosure are not limited thereto.

The vibration apparatus 200 according to an embodiment of the present disclosure can include a piezoelectric material or an electroactive material having a piezoelectric characteristic. The vibration apparatus 200 can autonomously vibrate (or displace or drive) based on a vibration (or displacement or driving) of the piezoelectric material based on a driving signal applied from the driving circuit, or can vibrate (or displace or drive) the vibration member 100. The vibration apparatus 200 can alternately repeat contraction and/or expansion based on a piezoelectric effect (or a piezoelectric characteristic) to vibrate (or displace or drive). For example, the vibration apparatus 200 can alternately repeat contraction and/or expansion based on an inverse piezoelectric effect to vibrate (or displace or drive) in a vertical direction (or a thickness direction) (Z1, Z2).

The vibration apparatus 200 can include a tetragonal shape or a rectangular shape, which has a third length L3 parallel to the first direction X and a fourth length L4 parallel to the second direction Y. For example, the vibration apparatus 200 can have a shape which differs from that of the vibration member 100. The vibration apparatus 200 can be configured to have a size which is less than that of the vibration member 100.

The vibration apparatus 200 according to an embodiment of the present disclosure can include a tetragonal shape or a rectangular shape, where the fourth length L4 parallel to the second direction Y is longer than the third length L3 parallel to the first direction X. For example, the vibration apparatus 200 can include a tetragonal shape or a rectangular shape, which has a long side in the second direction Y. For example, with respect to the same plane, the first direction X can be the first horizontal direction or the first length L1 direction of the vibration member 100 (or a long-side direction of the vibration member) or a third length L3 direction of the vibration apparatus 200 (or a short-side direction of the vibration apparatus), and the second direction Y can be the second horizontal direction or the second length L2 direction of the vibration member 100 (or a short-side direction of the vibration member) or a fourth length L4 direction of the vibration apparatus 200 (or a long-side direction of the vibration apparatus). For example, the fourth length L4 direction of the vibration apparatus 200 (or the long-side direction of the vibration apparatus) can be configured to intersect with the first length L1 direction of the vibration member 100 (or the long-side direction of the vibration member). The vibration apparatus 200 can use the vibration member 100 as a sound generating member or a sound output member for sound output.

FIG. 2 shows the long side of the vibration apparatus 200 having the fourth length L4, and being perpendicular to a long side of the vibration member 100 having the first length L1. But embodiments of the present disclosure are not limited thereto. For example, the long side of the vibration apparatus 200 having the fourth length L4 can be parallel to the long side of the vibration member 100 having the first length L1, so that long sides and short sides of the vibration apparatus 200 and the vibration member 100 are aligned. Also, the long side of the vibration apparatus 200 and the long side of the vibration member 100 can be at an angle to each other.

The acoustic apparatus 10 according to an embodiment of the present disclosure can further include a connection member 150.

The connection member 150 can be disposed or connected between the vibration apparatus 200 and the vibration member 100. The connection member 150 can be disposed between the vibration apparatus 200 and the vibration member 100 and can connect or couple the vibration apparatus 200 to the vibration member 100. For example, the vibration apparatus 200 can be connected with or coupled to the vibration member 100 by the connection member 150. For example, the vibration apparatus 200 can be connected with or supported by the first surface 100a (or the rear surface) of the vibration member 100 by the connection member 150, but embodiments of the present disclosure are not limited thereto. For example, the connection member 150 can be a first connection member, an adhesive member, or a first adhesive member, but embodiments of the present disclosure are not limited thereto.

The connection member 150 according to an embodiment of the present disclosure can include an adhesive layer which is good in adhesive force or attaching force. For example, the connection member 150 can include a material including an adhesive layer which is good in adhesive force or attaching force with respect to each of the first surface 100a (or the rear surface) of the vibration member 100 and the vibration apparatus 200. For example, the connection member 150 can include a foam pad, a double-sided tape, a double-sided foam pad, a double-sided foam tape, an adhesive, a double-sided adhesive, a double-sided adhesive tape, a double-sided adhesive foam pad, or an adhesive sheet, but embodiments of the present disclosure are not limited thereto. For example, when the connection member 150 includes an adhesive sheet (or an adhesive layer), the connection member 150 can include only an adhesive layer or a tacky layer without a base member such as a plastic material.

The adhesive layer of the connection member 150 according to an embodiment of the present disclosure can include an adhesive material such as a pressure sensitive adhesive (PSA), an optically cleared adhesive (OCA), optically cleared resin (OCR), epoxy resin, acrylic resin, silicone resin, or urethane resin, but embodiments of the present disclosure are not limited thereto. For example, the adhesive layer of the connection member 150 can include an acryl-based material having a characteristic where an adhesive force is relatively good and hardness is high. Accordingly, the transfer efficiency of a vibration force (or a displacement force) transferred from the vibration apparatus 200 to the vibration member 100 can increase.

The adhesive layer of the connection member 150 according to another embodiment of the present disclosure can further include an additive such as a tackifier, a wax component, or an antioxidant. The additive can prevent the connection member 150 from being detached (or striped) from the vibration member 100 by a vibration of the vibration apparatus 200. For example, the tackifier can be rosin derivatives, and the wax component can be a paraffin wax, but embodiments of the present disclosure are not limited thereto. For example, the antioxidant can be a phenolic antioxidant such as thioester, but embodiments of the present disclosure are not limited thereto.

According to another embodiment, the connection member 150 can further include a hollow portion provided between the vibration member 100 and the vibration apparatus 200. The hollow portion of the connection member 150 can provide an air gap between the vibration member 100 and the vibration apparatus 20. The air gap can allow a sound wave (or a sound pressure level) based on a vibration of the vibration apparatus 200 to concentrate on the vibration member 100 without being dispersed by the connection member 150, and thus, the loss of a vibration by the connection member 150 can be minimized, thereby increasing a sound characteristic and/or a sound pressure level characteristic of a sound generated based on a vibration of the vibration member 100.

The acoustic apparatus 10 according to an embodiment of the present disclosure can further include a housing 300 which is disposed at the rear surface of the vibration member 100.

The housing 300 can be configured or disposed at the first surface 100a (or the rear surface) of the vibration member 100. The housing 300 can be configured or disposed to cover the first surface 100a (or the rear surface) of the vibration member 100. The housing 300 can be configured to support a periphery portion (or an edge portion) of the vibration member 100. The housing 300 can be configured to support a periphery portion (or an edge portion) of the first surface 100a of the vibration member 100. The housing 300 can be configured to cover the first surface 100a of the vibration member 100 and the vibration apparatus 200.

The housing 300 according to an embodiment of the present disclosure can include an internal space 300S which surrounds the first surface 100a (or the rear surface) of the vibration member 100. For example, the housing 300 can be configured to include the internal space 300S and can be connected with (or coupled to) the first surface 100a of the vibration member 100. For example, the acoustic apparatus 10 according to one or more embodiments of the present disclosure can include the internal space 300S which is provided between the vibration member 100 and the housing 300. For example, the acoustic apparatus 10 according to one or more embodiments of the present disclosure can include the internal space 300S which is provided between the first surface 100a of the vibration member 100 and the housing 300. For example, the housing 300 can include a box shape where one side (or an upper side) is opened, so as to provide (or configure) the internal space 300S. For example, the housing 300 can be an enclosure, a case, an outer case, a case member, a housing member, a cabinet, a sealing member, a sealing cap, a sealing box, or a sound box, but embodiments of the present disclosure are not limited thereto. For example, the acoustic apparatus 10 or the internal space 300S of the housing 300 can be an accommodating space, a receiving space, a gap space, an air space, a vibration space, a sound space, a sounding cylinder, or a sealing space, but embodiments of the present disclosure are not limited thereto. The housing 300 need not be rectangular, but can also be cylindrical, polygonal, hemispherical, or other shapes, but embodiments of the present disclosure are not limited thereto.

The housing 300 according to an embodiment of the present disclosure can be configured to be transparent, semitransparent, or opaque. But embodiments of the present disclosure are not limited thereto, and the housing 300 can be configured to be a combination of being transparent, semitransparent, or opaque in one or more portions. For example, the housing 300 can include one or more materials of a metal material and a nonmetal material (or a complex nonmetal material), but embodiments of the present disclosure are not limited thereto. For example, the housing 300 can include one or more materials of a metal material, plastic, and wood, but embodiments of the present disclosure are not limited thereto. For example, the housing 300 can include a metal material of an aluminum material, or can include a plastic material of a styrene material or plastic, but embodiments of the present disclosure are not limited thereto. For example, the styrene material can be an Acrylonitrile butadiene styrene (ABS) material. The ABS material can include acrylonitrile, butadiene, and styrene.

The housing 300 according to an embodiment of the present disclosure can include a bottom portion 310 and a supporting portion 320.

The bottom portion 310 can be configured (or disposed) in parallel to the vibration member 100, but embodiments of the present disclosure are not limited thereto. The bottom portion 310 can be configured (or disposed) in parallel to the vibration member 100 with the vibration apparatus 200 therebetween. The bottom portion 310 can be disposed to face the first surface 100a (or the rear surface) of the vibration member 100. The bottom portion 310 can be disposed to cover the first surface 100a of the vibration member 100 and the vibration apparatus 200. The bottom portion 310 can be spaced apart from the first surface 100a of the vibration member 100. The bottom portion 310 can be disposed to face the first surface 100a of the vibration member 100 with the internal space 300S therebetween. For example, the bottom portion 310 can be spaced apart from the first surface 100a of the vibration member 100 with the internal space 300S therebetween. For example, the bottom portion 310 can be a bottom plate, a supporting plate, a housing plate, a housing bottom portion, an enclosure plate, or an enclosure bottom portion, but embodiments of the present disclosure are not limited thereto.

The supporting portion 320 can be configured to support the periphery portion of the vibration member 100. The supporting portion 320 can be configured or disposed at the periphery portion of the vibration member 100. The supporting portion 320 can be connected with an edge portion of the bottom portion 310. For example, the supporting portion 320 can include a structure which is bent from the edge portion of the bottom portion 310. For example, the supporting portion 320 can be parallel with the vertical direction (Z1, Z2) perpendicular to the ground. For example, the supporting portion 320 can be connected with the periphery portion of the bottom portion 310, and moreover, can protrude vertically from the bottom portion 310 and can be connected with the periphery portion of the vibration member 100. The supporting portion 320 can protrude in the vertical direction (Z1, Z2) and can be connected with or coupled to the periphery portion of the first surface 100a of the vibration member 100. For example, the housing 300 can include four supporting portions 320 which are connected with one another. For example, the supporting portion 320 can be a lateral portion, a sidewall, a supporting sidewall, a housing lateral surface, a housing sidewall, an enclosure lateral surface, or an enclosure sidewall, but embodiments of the present disclosure are not limited thereto. For example, the supporting portion 320 can have a tetragonal frame or tetragonal band shape.

The supporting portion 320 can be provided as one body with the bottom portion 310. For example, the bottom portion 310 and the supporting portion 320 can be provided as one body. Therefore, the internal space 300S surrounded by the supporting portion 320 can be provided on the bottom portion 310. Accordingly, the housing 300 can include a box shape where one side (or an upper side) is opened by the bottom portion 310 and the supporting portion 320. But embodiments of the present disclosure are not limited thereto. For example, the supporting portion 320 on opposite sides of the housing can have different lengths, so that the bottom portion 310 is not parallel to the vibration member 100. Also, the supporting portion 320 need not be perpendicular to at least one of the bottom portion 310 and the vibration member 100 so that the supporting portion 320 can be angled to at least one of the bottom portion 310 and the vibration member 100.

The housing 300 can be connected with or coupled to the vibration member 100 by a coupling member 250. The housing 300 can be connected with or coupled to the first surface 100a (or the rear surface) of the vibration member 100 by the coupling member 250. For example, the housing 300 can be connected with or coupled to the periphery portion of the first surface 100a of the vibration member 100 by the coupling member 250. With reference to FIG. 2, the vibration member 100 can be placed on an upper surface of the support portion 320, so that vibration member 100 can be an uppermost structure of the acoustic apparatus 10. But embodiments of the present disclosure are not limited thereto. For example, the vibration member 100 can be located between the upper surface of the support portion 320 and the bottom portion 310, whereby edges of the vibration member 100 can be inserted into a side of the support portion 320. In this instance, the coupling member 250 can be located extend from the first surface 100a to the second surface 100b via the edge of the vibration member 100.

The coupling member 250 can be configured to minimize or prevent the transfer of a vibration of the vibration member 100 to the housing 300. The coupling member 250 can include a material characteristic suitable for blocking of a vibration. For example, the coupling member 250 can include a material having elasticity. For example, the coupling member 250 can include a material having elasticity for vibration absorption (or impact absorption). The coupling member 250 according to an embodiment of the present disclosure can include polyurethane or polyolefin, but embodiments of the present disclosure are not limited thereto. For example, the coupling member 250 can include one or more of a double-sided adhesive member, a double-sided tape, a double-sided foam tape, a double-sided foam pad, and a double-sided cushion tape, but embodiments of the present disclosure are not limited thereto.

According to another embodiment of the present disclosure, the coupling member 250 can include a waterproof structure or a waterproof member for preventing the penetration of water into the internal space 300S from the outside. For example, the coupling member 250 can include one or more of a waterproof tape and a waterproof pad, but embodiments of the present disclosure are not limited thereto. For example, in a case where the acoustic apparatus 10 is applied to a vehicular apparatus such as a vehicle, the penetration of water into the internal space 300S from the outside can be prevented or reduced.

The coupling member 250 according to an embodiment of the present disclosure can prevent a physical contact (or friction) between the vibration member 100 and the supporting portion 320 of the housing 300, and thus, can prevent the occurrence of sound noise (or noise or an undesired sound) caused by the physical contact (or friction) between the vibration member 100 and the supporting portion 320. For example, the coupling member 250 can be a buffer member, an elastic member, a damping member, a vibration absorption member, a vibration prevention member, or a vibration blocking member, but embodiments of the present disclosure are not limited thereto.

The coupling member 250 according to another embodiment of the present disclosure can be configured to minimize or prevent the transfer of a vibration of the vibration member 100 to the housing 300 and decrease the reflection of a sound wave which is generated based on the vibration of the vibration member 100 and is incident thereon.

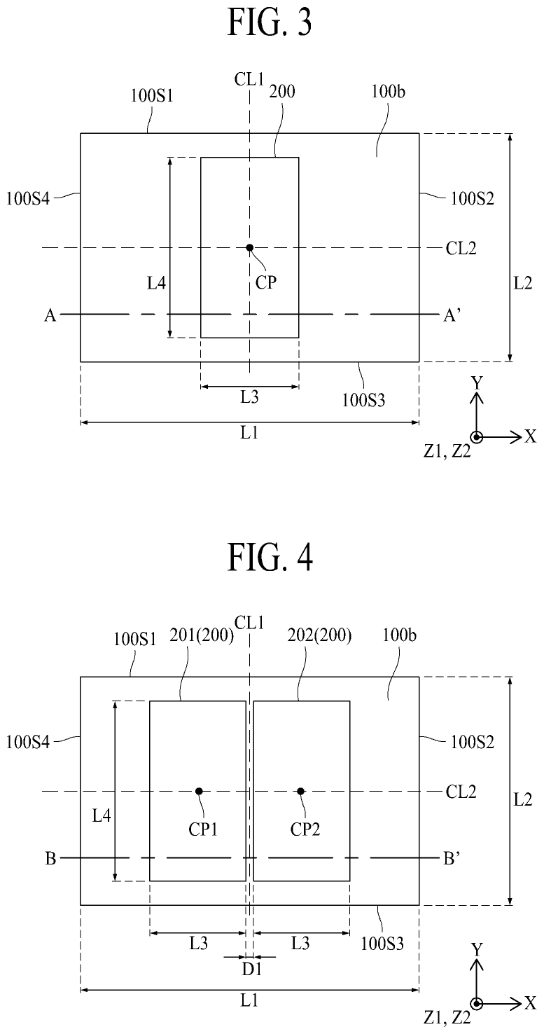

FIG. 3 illustrates an acoustic apparatus 10 according to an embodiment of the present disclosure. FIG. 3 illustrates an arrangement structure of a vibration apparatus 200 provided at a second surface 100b (or a front surface) of a vibration member 100 in the acoustic apparatus 10 according to an embodiment of the present disclosure.

Referring to FIG. 3, the vibration member 100 or the second surface 100b of the vibration member 100 can have a first length L1 parallel to a first direction X and can have a second length L2 parallel to a second direction Y. For example, the vibration member 100 or the second surface 100b of the vibration member 100 can have a tetragonal shape or a rectangular shape, where the first length L1 in the first direction X is longer than the second length L2 in the second direction Y, but embodiments of the present disclosure are not limited thereto. For example, the vibration member 100 or the second surface 100b of the vibration member 100 can include a tetragonal shape or a rectangular shape, an oval shape, or a round-polygonal shape having a curved shape (or a round shape). For example, the vibration member 100 can include a tetragonal shape or a rectangular shape, an oval shape, or a round-polygonal shape having a curved shape (or a round shape), where the first length L1 parallel to the first direction X is longer than the second length L2 parallel to the second direction Y perpendicular to the first direction X, but embodiments of the present disclosure are not limited thereto. For example, the round-polygonal shape can include a curved shape (or a round shape) where at least one side or at least one corner portion of the vibration member 100 has a certain curvature radius. For example, the round-polygonal shape can include a shape having a curved shape (or a round shape) where at least a pair of sides facing each other have a certain curvature radius. For example, the round-polygonal shape can include a shape having a curved shape (or a round shape) where at least a pair of sides with one side therebetween have a certain curvature radius.

According to an embodiment of the present disclosure, the vibration member 100 or the second surface 100b of the vibration member 100 can include a tetragonal shape or a rectangular shape, which includes a first side 100S1 (or an upper side) having the first length L1, a second side 100S2 (or a right side) having the second length L2, a third side 100S3 (or a lower side) which is parallel to the first side and has the first length L1, and a fourth side 100S4 (or a left side) which is parallel to the second side and has the second length L2. For example, the first side 100S1 can be a side or a rectilinear side which is parallel to the first direction X and has the first length L1, the second side 100S2 can be a side or a rectilinear side which is connected with the first side 100S1 in parallel to the second direction Y and has the second length L2, the third side 100S3 can be a side or a rectilinear side which is connected with the second side 100S2 in parallel to the first side 100S1 and has the first length L1, and the fourth side 100S4 can be a side or a rectilinear side which is connected with the first side 100S1 and the third side 100S3 in parallel to the second side 100S2 and has the second length L2.

In the vibration member 100 or the second surface 100b of the vibration member 100, a first center line CL1 can be parallel to the second direction Y and can be disposed at a center between the second side 100S2 (or the right side) and the fourth side 100S4 (or the left side). For example, in the vibration member 100 or the second surface 100b of the vibration member 100, a distance between the first center line CL1 and each of the second side 100S2 (or the right side) and the fourth side 100S4 (or the left side) in the first direction X can be half of the first length L1.

In the vibration member 100 or the second surface 100b of the vibration member 100, a second center line CL2 can be parallel to the first direction X and can be disposed at a center between the first side 100S1 (or the upper side) and the third side 100S3 (or the lower side). For example, in the vibration member 100 or the second surface 100b of the vibration member 100, a distance between the second center line CL2 and each of the first side 100S1 (or the upper side) and the third side 100S3 (or the lower side) can be half of the second length L2. For example, a center portion of the vibration member 100 or the second surface 100b of the vibration member 100 can be a portion or a point at which the first center line CL1 intersects with the second center line CL2.

According to another embodiment of the present disclosure, the vibration member 100 or the second surface 100b of the vibration member 100 can include an oval shape or a round-polygonal shape, which has a long axis having the first length L1 in the first direction X and has a short axis having the second length L2 in the second direction Y. For example, the vibration member 100 or the second surface 100b of the vibration member 100 can include an oval shape having an oval side, which has a long axis having the first length L1 in the first direction X and has a short axis having the second length L2 in the second direction Y. For example, the vibration member 100 or the second surface 100b of the vibration member 100 can include a round-diagonal shape having a round-diagonal side, which has a long axis having the first length L1 in the first direction X and has a short axis having the second length L2 in the second direction Y.

The vibration apparatus 200 can be configured to vibrate the vibration member 100. Therefore, the vibration member 100 can vibrate based on a vibration of the vibration apparatus 200 to generate or output one or more of a vibration and a sound. The vibration apparatus 200 can be connected with at least one surface of the vibration member 100 by the connection member 150, but embodiments of the present disclosure are not limited thereto. For example, the vibration apparatus 200 can be connected with or coupled to the first surface 100a (or the rear surface) of the vibration member 100 by the connection member 150. For example, the vibration apparatus 200 can be connected with or coupled to the second surface 100b (or the front surface), which is opposite to the first surface 100a, of the vibration member 100 by the connection member 150. For example, the vibration apparatus 200 can be connected with or coupled to each of the first surface 100a (or the rear surface) and the second surface 100b (or the front surface) of the vibration member 100 by the connection member 150. For example, the vibration apparatuses 200 disposed at each of the first surface 100a and the second surface 100b of the vibration member 100 can be disposed to be symmetrical and overlap each other with the vibration member 100 therebetween.

The vibration apparatus 200 can have a third length L3 parallel to the first direction X and a fourth length L4 parallel to the second direction Y. For example, the vibration apparatus 200 can have a tetragonal shape or a rectangular shape, where the fourth length L4 parallel to the second direction Y is longer than the third length L3 parallel to the first direction X. For example, the vibration apparatus 200 can have a tetragonal shape or a rectangular shape, which has a long side in the second direction Y intersecting with a long-side direction of the vibration member 100. For example, a first length L1 direction (or a long-side direction) of the vibration member 100 and a fourth length L4 direction (or a long-side direction) of the vibration apparatus 200 can be configured to intersect with each other.

The vibration apparatus 200 can be disposed to overlap a center portion (or the first center line CL1 or the second center line CL2) of the vibration member 100, on at least one surface of the vibration member 100. The vibration apparatuses 200 can be disposed or arranged to be symmetrical with each other with respect to the center portion (or the first center line CL1 or the second center line CL2) of the vibration member 100.

The vibration apparatus 200 can overlap the first center line CL1 of the vibration member 100 at the first surface 100a (or the rear surface) or the second surface 100b (or the front surface) of the vibration member 100, and a plurality of vibration apparatuses 200 can be disposed or arranged to be symmetrical with each other with respect to the first center line CL1. For example, a center portion CP of the vibration apparatus 200 can be disposed to overlap the first center line CL1 of the vibration member 100, at the first surface 100a (or the rear surface) or the second surface 100b (or an upper surface) of the vibration member 100. The vibration apparatus 200 can be configured so that a left portion and a right portion thereof in the first direction X are symmetrical with each other with respect to the first center line CL1 parallel to the second direction Y, at the first surface 100a (or the rear surface) or the second surface 100b (or the upper surface) of the vibration member 100.

The vibration apparatus 200 can overlap the second center line CL2 of the vibration member 100 at the first surface 100a (or the rear surface) or the second surface 100b (or the front surface) of the vibration member 100, and a plurality of vibration apparatuses 200 can be disposed or arranged to be symmetrical with each other with respect to the second center line CL2. For example, the center portion CP of the vibration apparatus 200 can be disposed to overlap the second center line CL2 of the vibration member 100, at the first surface 100a (or the rear surface) or the second surface 100b (or the upper surface) of the vibration member 100. The vibration apparatus 200 can be configured so that an upper portion and a lower portion thereof in the second direction Y are symmetrical with each other with respect to the second center line CL2 parallel to the first direction X.

The vibration apparatus 200 can overlap the first center line CL1 and the second center line CL2 of the vibration member 100 at the first surface 100a (or the rear surface) or the second surface 100b (or the front surface) of the vibration member 100, and a plurality of vibration apparatuses 200 can be disposed or arranged to be symmetrical with each other with respect to each of the first center line CL1 and the second center line CL2. For example, the center portion CP of the vibration apparatus 200 can overlap a portion or a point at which the first center line CL1 and the second center line CL2 of the vibration member 100 intersects with each other, at the first surface 100a (or the rear surface) or the second surface 100b (or the upper surface) of the vibration member 100. The vibration apparatus 200 can be configured so that a left portion and a right portion thereof in the first direction X are symmetrical with each other with respect to the first center line CL1 parallel to the second direction Y and an upper portion and a lower portion thereof in the second direction Y are symmetrical with each other with respect to the second center line CL2 parallel to the first direction X.

According to an embodiment of the present disclosure, the vibration apparatus 200 can be provided as one or more, and the one or more vibration apparatuses 200 can be disposed to overlap each other at each of the first surface 100a (or the rear surface) and the second surface 100b (or the front surface) of the vibration member 100. For example, the vibration apparatus 200 disposed at the first surface 100a (or the rear surface) of the vibration member 100 can be disposed to overlap the vibration apparatus 200 disposed at the second surface 100b (or the front surface) of the vibration member 100 with the vibration member 100 therebetween. For example, the vibration apparatus 200 disposed at the first surface 100a (or the rear surface) of the vibration member 100 and the vibration apparatus disposed at the second surface 100b (or the front surface) of the vibration member 100 can be disposed to be symmetrical with each other with the vibration member 100 therebetween.

FIG. 4 illustrates an acoustic apparatus 10 according to another embodiment of the present disclosure. FIG. 4 illustrates an arrangement structure of one or more vibration apparatuses 200 provided at a first surface 100a (or a rear surface) of a vibration member 100 in the acoustic apparatus 10 according to another embodiment of the present disclosure. FIG. 4 illustrates an embodiment implemented by providing one or more vibration apparatuses 200 in the acoustic apparatus 10 described above with reference to FIG. 3. Therefore, in the following description, the same other elements except elements relevant to the arrangement of the one or more vibration apparatuses 200 are referred to by like reference numerals, and repeated descriptions thereof are omitted or will be briefly given.

Referring to FIG. 4, the vibration member 100 or a second surface 100b of the vibration member 100 can have a tetragonal shape or a rectangular shape, where a first length L1 in a first direction X is longer than a second length L2 in a second direction Y, but embodiments of the present disclosure are not limited thereto. For example, the vibration member 100 or the second surface 100b of the vibration member 100 can include an oval shape or a round-polygonal shape, which has a long axis having the first length L1 in the first direction X and has a short axis having the second length L2 in the second direction Y.

According to an embodiment of the present disclosure, the vibration member 100 or the second surface 100b of the vibration member 100 can include a tetragonal shape or a rectangular shape, which includes a first side 100S1 (or an upper side) having the first length L1, a second side 100S2 (or a right side) having the second length L2, a third side 100S3 (or a lower side) which is parallel to the first side and has the first length L1, and a fourth side 100S4 (or a left side) which is parallel to the second side and has the second length L2, but embodiments of the present disclosure are not limited thereto.

In the vibration member 100 or the second surface 100b of the vibration member 100, a first center line CL1 can be parallel to the second direction Y and can be disposed at a center between the second side 100S2 (or the right side) and the fourth side 100S4 (or the left side). In the vibration member 100 or the second surface 100b of the vibration member 100, a second center line CL2 can be parallel to the first direction X and can be disposed at a center between the first side 100S1 (or the upper side) and the third side 100S3 (or the lower side). For example, a center portion of the vibration member 100 or the second surface 100b of the vibration member 100 can be a portion or a point at which the first center line CL1 intersects with the second center line CL2.

The vibration apparatus 200 can include one or more vibration apparatuses 201 and 202. For example, the one or more vibration apparatuses 201 and 202 disposed on at least one surface of the vibration member 100 can be provided as an even number. For example, the one or more vibration apparatuses 201 and 202 can include a first vibration generator 201 and a second vibration generator 202.

The first vibration generator 201 and the second vibration generator 202 can be configured to vibrate the vibration member 100. Therefore, the vibration member 100 can vibrate based on vibrations of the first vibration generator 201 and the second vibration generator 202 to generate or output one or more of a vibration and a sound. The first vibration generator 201 and the second vibration generator 202 can be connected with at least one surface of the vibration member 100 by the connection member 150, but embodiments of the present disclosure are not limited thereto. For example, the first vibration generator 201 and the second vibration generator 202 can be connected with or coupled to the first surface 100a (or the rear surface) of the vibration member 100 by the connection member 150. For example, the first vibration generator 201 and the second vibration generator 202 can be connected with or coupled to the second surface 100b (or the front surface), which is opposite to the first surface 100a (or the rear surface), of the vibration member 100 by the connection member 150. For example, the first vibration generator 201 and the second vibration generator 202 can be connected with or coupled to each of the first surface 100a (or the rear surface) and the second surface 100b (or the front surface) of the vibration member 100 by the connection member 150. For example, the first vibration generator 201 and the second vibration generator 202 disposed at each of the first surface 100a and the second surface 100b of the vibration member 100 can be disposed to be symmetrical and overlap each other with the vibration member 100 therebetween.

Each of the first vibration generator 201 and the second vibration generator 202 can have a third length L3 parallel to the first direction X and a fourth length L4 parallel to the second direction Y. The first vibration generator 201 and the second vibration generator 202 can have the same size or shape. For example, each of the first vibration generator 201 and the second vibration generator 202 can have a tetragonal shape or a rectangular shape, where the fourth length L4 parallel to the second direction Y is longer than the third length L3 parallel to the first direction X. For example, each of the first vibration generator 201 and the second vibration generator 202 can have a tetragonal shape or a rectangular shape, which has a long side in the second direction Y intersecting with a long-side direction of the vibration member 100. For example, a first length L1 direction (or a long-side direction) of the vibration member 100 and a fourth length L4 direction (or a long-side direction) of each of the first vibration generator 201 and the second vibration generator 202 can be configured to intersect with each other.

The first vibration generator 201 and the second vibration generator 202 can be arranged to be spaced apart from each other in the first direction X parallel to the first length L1 direction (or the long-side direction) of the vibration member 100. The first vibration generator 201 and the second vibration generator 202 can be arranged in parallel to the second direction Y parallel to the second length L2 direction (or the short-side direction) of the vibration member 100. For example, the first vibration generator 201 and the second vibration generator 202 can be disposed or configured to be spaced apart from each other in the first direction X in parallel to the second direction Y at the first surface 100a (or the rear surface) of the vibration member 100. For example, the first vibration generator 201 and the second vibration generator 202 can be disposed or configured to be spaced apart from each other in the first direction X in parallel to the second direction Y at the second surface 100b (or the front surface) of the vibration member 100. For example, the first vibration generator 201 and the second vibration generator 202 can be disposed to overlap each other at each of the first surface 100a and the second surface 100b of the vibration member 100, but embodiments of the present disclosure are not limited thereto.

The first vibration generator 201 and the second vibration generator 202 can be disposed to be symmetrical with each other with respect to a center portion (or the first center line CL1 or the second center line CL2) of the vibration member 100, at the first surface 100a (or the rear surface) or the second surface 100b (or the front surface) of the vibration member 100.

The first vibration generator 201 and the second vibration generator 202 can be disposed to be symmetrical with each other with respect to the first center line CL1 parallel to the second direction Y, at the first surface 100a (or the rear surface) or the second surface 100b (or the front surface) of the vibration member 100. For example, center portions CP1 and CP2 of the first vibration generator 201 and the second vibration generator 202 can be disposed to be symmetrical with each other with respect to the first center line CL1 of the vibration member 100, at the first surface 100a (or the rear surface) or the second surface 100b (or the front surface) of the vibration member 100. The first vibration generator 201 and the second vibration generator 202 can be disposed to be symmetrical with each other and not to overlap with respect to the first center line CL1 of the vibration member 100, at the first surface 100a (or the rear surface) or the second surface 100b (or the front surface) of the vibration member 100. For example, the center portions CP1 and CP2 of the first vibration generator 201 and the second vibration generator 202 can be disposed to overlap each other with respect to the second center line CL2 of the vibration member 100, at the first surface 100a (or the rear surface) or the second surface 100b (or the front surface) of the vibration member 100. Each of the first vibration generator 201 and the second vibration generator 202 can be configured so that an upper portion and a lower portion thereof in the second direction Y are symmetrical with each other with respect to the second center line CL2 parallel to the first direction X, at the first surface 100a (or the rear surface) or the second surface 100b (or the upper surface) of the vibration member 100.

The first vibration generator 201 and the second vibration generator 202 can be disposed to be spaced apart from each other by a first distance D1 with the first center line CL1 of the vibration member 100 therebetween, at the first surface 100a (or the rear surface) or the second surface 100b (or the front surface) of the vibration member 100. The first vibration generator 201 and the second vibration generator 202 can be disposed to be spaced apart from each other by the first distance D1 in the first direction X with the first center line CL1 of the vibration member 100 therebetween, at the first surface 100a (or the rear surface) or the second surface 100b (or the front surface) of the vibration member 100.

The first vibration generator 201 can be disposed in a left region with respect to the first center line CL1 of the vibration member 100, at the first surface 100a (or the rear surface) or the second surface 100b (or the front surface) of the vibration member 100. The center portion CP1 of the first vibration generator 201 can be disposed to overlap the first center line CL1 of the vibration member 100. For example, the first vibration generator 201 can be disposed in the left region with respect to the first center line CL1 of the vibration member 100 and can be configured so that an upper portion and a lower portion thereof in the second direction Y are symmetrical with each other with respect to the second center line CL2, at the first surface 100a (or the rear surface) or the second surface 100b (or the upper surface) of the vibration member 100.

The second vibration generator 202 can be disposed in a right region with respect to the first center line CL1 of the vibration member 100, at the first surface 100a (or the rear surface) or the second surface 100b (or the front surface) of the vibration member 100. The center portion CP2 of the second vibration generator 202 can be disposed to overlap the second center line CL2 of the vibration member 100. For example, the second vibration generator 202 can be disposed in the right region with respect to the second center line CL2 of the vibration member 100 and can be configured so that an upper portion and a lower portion thereof in the second direction Y are symmetrical with each other with respect to the second center line CL2.

According to an embodiment of the present disclosure, the first vibration generator 201 and the second vibration generator 202 can be provided as one or more and can be disposed to overlap each other at each of the first surface 100a (or the rear surface) and the second surface 100b (or the front surface) of the vibration member 100. For example, the first vibration generator 201 and the second vibration generator 202 disposed at the first surface 100a (or the rear surface) of the vibration member 100 can be disposed to overlap the first vibration generator 201 and the second vibration generator 202 disposed at the second surface 100b (or the front surface) of the vibration member 100 with the vibration member 100 therebetween. For example, the first vibration generator 201 and the second vibration generator 202 disposed at the first surface 100a (or the rear surface) of the vibration member 100 and the first vibration generator 201 and the second vibration generator 202 disposed at the second surface 100b (or the front surface) of the vibration member 100 can be disposed to be symmetrical with each other with the vibration member 100 therebetween.

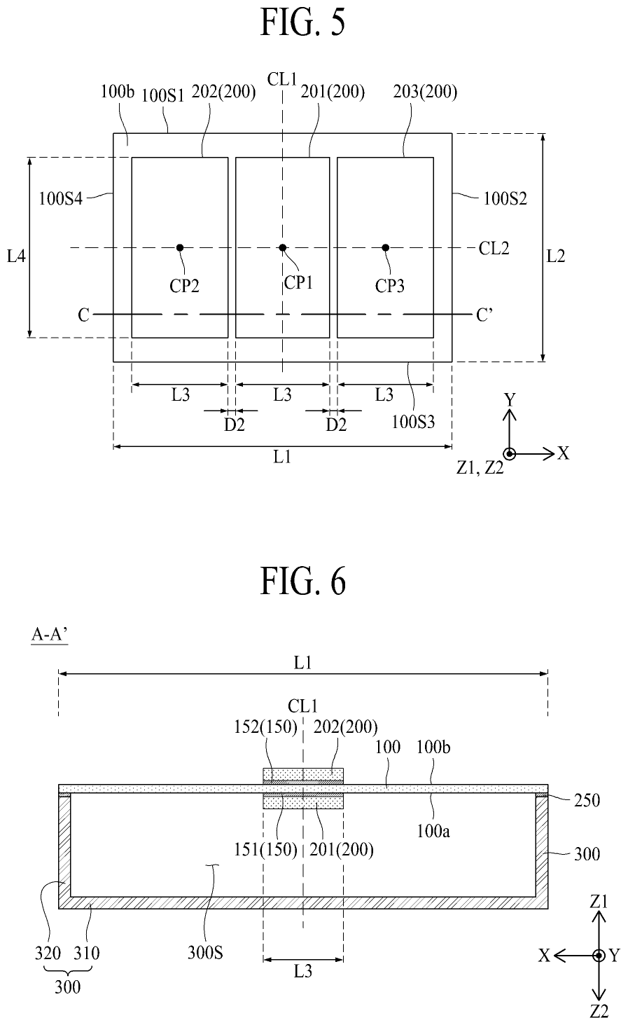

FIG. 5 illustrates an acoustic apparatus 10 according to another embodiment of the present disclosure. FIG. 5 illustrates an arrangement structure of a plurality of vibration apparatuses 200 provided at a first surface 100a (or a rear surface) of a vibration member 100 in the acoustic apparatus 10 according to another embodiment of the present disclosure. FIG. 5 illustrates an embodiment implemented by providing a plurality of vibration apparatuses 200 in the acoustic apparatus 10 described above with reference to FIG. 3 or 4. Therefore, in the following description, the same other elements except elements relevant to the arrangement of the plurality of vibration apparatuses 200 are referred to by like reference numerals, and repeated descriptions thereof are omitted or will be briefly given.

Referring to FIG. 5, the vibration member 100 or a second surface 100b of the vibration member 100 can have a tetragonal shape or a rectangular shape, where a first length L1 in a first direction X is longer than a second length L2 in a second direction Y, but embodiments of the present disclosure are not limited thereto. For example, the vibration member 100 or the second surface 100b of the vibration member 100 can include an oval shape or a round-polygonal shape, which has a long axis having the first length L1 in the first direction X and has a short axis having the second length L2 in the second direction Y.

According to an embodiment of the present disclosure, the vibration member 100 or the second surface 100b of the vibration member 100 can include a tetragonal shape or a rectangular shape, which includes a first side 100S1 (or an upper side) having the first length L1, a second side 100S2 (or a right side) having the second length L2, a third side 100S3 (or a lower side) which is parallel to the first side and has the first length L1, and a fourth side 100S4 (or a left side) which is parallel to the second side and has the second length L2, but embodiments of the present disclosure are not limited thereto.

In the vibration member 100 or the second surface 100b of the vibration member 100, a first center line CL1 can be parallel to the second direction Y and can be disposed at a center between the second side 100S2 and the fourth side 100S4 in the first direction X. In the vibration member 100 or the second surface 100b of the vibration member 100, a second center line CL2 can be parallel to the first direction X and can be disposed at a center between the first side 100S1 and the third side 100S3 in the second direction Y. For example, a center portion of the vibration member 100 or the second surface 100b of the vibration member 100 can be a portion or a point at which the first center line CL1 intersects with the second center line CL2.

The vibration apparatus 200 can include a plurality of vibration apparatuses 201 to 203. For example, the plurality of vibration apparatuses 201 to 203 disposed on at least one surface of the vibration member 100 can be provided as an odd number. For example, the plurality of vibration apparatuses 201 to 203 can include a first vibration generator 201, a second vibration generator 202, and a third vibration generator 203.

The first to third vibration generators 201 to 203 can be configured to vibrate the vibration member 100. Therefore, the vibration member 100 can vibrate based on vibrations of the first to third vibration generators 201 to 203 to generate or output one or more of a vibration and a sound. The first to third vibration generators 201 to 203 can be connected with at least one surface of the vibration member 100 by the connection member 150, but embodiments of the present disclosure are not limited thereto. For example, the first to third vibration generators 201 to 203 can be connected with or coupled to the first surface 100a (or the rear surface) of the vibration member 100 by the connection member 150. For example, the first to third vibration generators 201 to 203 can be connected with or coupled to the second surface 100b (or the front surface), which is opposite to the first surface 100a (or the rear surface), of the vibration member 100 by the connection member 150. For example, the first to third vibration generators 201 to 203 can be connected with or coupled to each of the first surface 100a (or the rear surface) and the second surface 100b (or the front surface) of the vibration member 100 by the connection member 150. For example, the first to third vibration generators 201 to 203 disposed at each of the first surface 100a and the second surface 100b of the vibration member 100 can be disposed to be symmetrical and overlap one another with the vibration member 100 therebetween.

Each of the first to third vibration generators 201 to 203 can have a third length L3 parallel to the first direction X and a fourth length L4 parallel to the second direction Y. The first to third vibration generators 201 to 203 can have the same size or shape. For example, each of the first to third vibration generators 201 to 203 can have a tetragonal shape or a rectangular shape, where the fourth length L4 parallel to the second direction Y is longer than the third length L3 parallel to the first direction X. For example, each of the first to third vibration generators 201 to 203 can have a tetragonal shape or a rectangular shape, which has a long side in the second direction Y intersecting with a long-side direction of the vibration member 100. For example, a first length L1 direction (or a long-side direction) of the vibration member 100 and a fourth length L4 direction (or a long-side direction) of each of the first to third vibration generators 201 to 203 can be configured to intersect with each other.

The first to third vibration generators 201 to 203 can be arranged to be spaced apart from one another in the first direction X parallel to the first length L1 direction (or the long-side direction) of the vibration member 100, on at least one surface of the vibration member 100. The first to third vibration generators 201 to 203 can be arranged in parallel to the second direction Y parallel to the second length L2 direction (or the short-side direction) of the vibration member 100. For example, the first to third vibration generators 201 to 203 can be disposed or configured to be spaced apart from one another in the first direction X in parallel to the second direction Y at the first surface 100a (or the rear surface) of the vibration member 100. For example, the first to third vibration generators 201 to 203 can be disposed or configured to be spaced apart from one another in the first direction X in parallel to the second direction Y at the second surface 100b (or the front surface) of the vibration member 100. For example, the first to third vibration generators 201 to 203 can be disposed to overlap one another at each of the first surface 100a and the second surface 100b of the vibration member 100, but embodiments of the present disclosure are not limited thereto.

The first to third vibration generators 201 to 203 can be disposed to be symmetrical with one another with respect to a center portion (or the first center line CL1 or the second center line CL2) of the vibration member 100, at the first surface 100a (or the rear surface) or the second surface 100b (or the front surface) of the vibration member 100.

The first to third vibration generators 201 to 203 can be disposed to be symmetrical with one another with respect to the first center line CL1 parallel to the second direction Y, at the first surface 100a (or the rear surface) or the second surface 100b (or the front surface) of the vibration member 100. For example, a center portion CP1 of the first vibration generator 201 of the first to third vibration generators 201 to 203 can be disposed to overlap the first center line CL1 of the vibration member 100, at the first surface 100a (or the rear surface) or the second surface 100b (or the front surface) of the vibration member 100. Center portions CP2 and CP3 of the second vibration generator 202 and the third vibration generator 203 of the first to third vibration generators 201 to 203 can be disposed to be symmetrical with each other with respect to the first center line CL1 of the vibration member 100. For example, the center portions CP2 and CP3 of the second vibration generator 202 and the third vibration generator 203 can be disposed to be symmetrical with each other with the first vibration generator 201 therebetween. For example, the center portions CP1 to CP3 of the first to third vibration generators 201 to 203 can be disposed to overlap the second center line CL2 of the vibration member 100, at the first surface 100a (or the rear surface) or the second surface 100b (or the front surface) of the vibration member 100. Each of the first to third vibration generators 201 to 203 can be configured so that an upper portion and a lower portion thereof in the second direction Y are symmetrical with each other with respect to the second center line CL2 parallel to the first direction X, at the first surface 100a (or the rear surface) or the second surface 100b (or the upper surface) of the vibration member 100.

The first to third vibration generators 201 to 203 can be disposed to be spaced apart from one another by a second distance D2, at the first surface 100a (or the rear surface) or the second surface 100b (or the front surface) of the vibration member 100. The first to third vibration generators 201 to 203 can be disposed to be spaced apart from one another by the second distance D2 in the first direction X, at the first surface 100a (or the rear surface) or the second surface 100b (or the front surface) of the vibration member 100. For example, the first vibration generator 201 of the first to third vibration generators 210 to 203 can be disposed to overlap the first center line CL1 of the vibration member 100, and each of the second vibration generator 202 and the third vibration generator 203 adjacent to the first vibration generator 201 can be disposed to be spaced apart from the first vibration generator 201 by the second distance D2. For example, the first vibration generator 201 and the second vibration generator 202 adjacent to a left side of the first vibration generator 201 can be disposed to be spaced apart from each other by the second distance D2. The first vibration generator 201 and the third vibration generator 203 adjacent to a right side of the first vibration generator 201 can be disposed to be spaced apart from each other by the second distance D2.

The first vibration generator 201 can be disposed or configured to overlap a center portion (or the first center line CL1 or the second center line CL2) of the vibration member 100, at the first surface 100a (or the rear surface) or the second surface 100b (or the front surface) of the vibration member 100. The first vibration generator 201 can be disposed or configured to overlap the first center line CL1 of the vibration member 100 and to be symmetrical with each other with respect to the first center line CL1 of the vibration member 100, at the first surface 100a (or the rear surface) or the second surface 100b (or the front surface) of the vibration member 100. For example, the center portion CP1 of the first vibration generator 201 can be disposed to overlap the first center line CL1 of the vibration member 100, at the first surface 100a (or the rear surface) or the second surface 100b (or the front surface) of the vibration member 100. The center portion CP1 of the first vibration generator 201 can be disposed to overlap the first center line CL1 and the second center line CL2 of the vibration member 100, at the first surface 100a (or the rear surface) or the second surface 100b (or the front surface) of the vibration member 100. For example, the first vibration generator 201 can be disposed in a center region overlapping the first center line CL1 of the vibration member 100 and can be configured so that a left portion and a right portion thereof in the first direction X are symmetrical with each other with respect to the first center line CL1 and an upper portion and a lower portion thereof in the second direction Y are symmetrical with each other with respect to the second center line CL2, at the first surface 100a (or the rear surface) or the second surface 100b (or the upper surface) of the vibration member 100.

The second vibration generator 202 can be disposed in a left region with respect to the first vibration generator 201 which is disposed to overlap the center portion (or the first center line CL1 or the second center line CL2) of the vibration member 100, at the first surface 100a (or the rear surface) or the second surface 100b (or the front surface) of the vibration member 100. The center portion CP2 of the second vibration generator 202 can be disposed to overlap the second center line CL2 of the vibration member 100. For example, the second vibration generator 202 can be disposed in a left region with respect to the first vibration generator 201 and can be configured so that an upper portion and a lower portion thereof in the second direction Y are symmetrical with each other with respect to the second center line CL2, at the first surface 100a (or the rear surface) or the second surface 100b (or the front surface) of the vibration member 100. The second vibration generator 202 can be parallel to the second direction Y and can be arranged to be spaced apart from the first vibration generator 201 by the second distance D2 to the left in the first direction X.

The third vibration generator 203 can be disposed in a right region with respect to the first vibration generator 201 which is disposed to overlap the center portion (or the first center line CL1 or the second center line CL2) of the vibration member 100, at the first surface 100a (or the rear surface) or the second surface 100b (or the front surface) of the vibration member 100. The center portion CP3 of the third vibration generator 203 can be disposed to overlap the second center line CL2 of the vibration member 100. For example, the third vibration generator 203 can be disposed in a right region with respect to the first vibration generator 201 and can be configured so that an upper portion and a lower portion thereof in the second direction Y are symmetrical with each other with respect to the second center line CL2, at the first surface 100a (or the rear surface) or the second surface 100b (or the front surface) of the vibration member 100. The third vibration generator 203 can be parallel to the second direction Y and can be arranged to be spaced apart from the first vibration generator 201 by the second distance D2 to the right in the first direction X. For example, the third vibration generator 203 can be disposed to be symmetrical with the second vibration generator 202 with the first vibration generator 201 therebetween.

According to an embodiment of the present disclosure, the first to third vibration generators 201 to 203 can be provided as one or more and can be disposed to overlap one another at each of the first surface 100a (or the rear surface) and the second surface 100b (or the front surface) of the vibration member 100. For example, the first to third vibration generators 201 to 203 disposed at the first surface 100a (or the rear surface) of the vibration member 100 can be disposed to overlap the first to third vibration generators 201 to 203 disposed at the second surface 100b (or the front surface) of the vibration member 100 with the vibration member 100 therebetween. For example, the first to third vibration generators 201 to 203 disposed at the first surface 100a (or the rear surface) of the vibration member 100 and the first to third vibration generators 201 to 203 disposed at the second surface 100b (or the front surface) of the vibration member 100 can be disposed to be symmetrical with one another with the vibration member 100 therebetween.

FIG. 6 is a cross-sectional view taken along line A-A′ illustrated in FIG. 3 according to another embodiment of the present disclosure. FIG. 6 illustrates an embodiment where a configuration of the vibration apparatus 200 is replaced with the arrangement of the vibration apparatuses 200 illustrated in FIG. 3, in the acoustic apparatus 10 described above with reference to FIGS. 1 and 2. Therefore, in the following description, the other elements except the modified arrangement of the vibration apparatus 200 and relevant elements are referred to by like reference numerals, and repeated descriptions thereof are omitted or will be briefly given.

Referring to FIGS. 3 and 6, in an acoustic apparatus 10 according to another embodiment of the present disclosure, a vibration apparatus 200 can include one or more vibration apparatuses 201 and 202.

The one or more vibration apparatuses 201 and 202 can be disposed or configured to overlap each other, at each of a first surface 100a (or a rear surface) and a second surface 100b (or a front surface) of a vibration member 100. For example, the one or more vibration apparatuses 201 and 202 can include a first vibration generator 201 and a second vibration generator 202.

The first vibration generator 201 and the second vibration generator 202 can be configured to vibrate the vibration member 100. For example, the first vibration generator 201 and the second vibration generator 202 can be disposed or configured to overlap each other at each of the first surface 100a (or the rear surface) and the second surface 100b (or the front surface) of the vibration member 100. Therefore, the vibration member 100 can vibrate based on vibrations of the first vibration generator 201 and the second vibration generator 202 to generate or output one or more of a vibration and a sound.

The first vibration generator 201 can be disposed at the first surface 100a (or the rear surface) of the vibration member 100. For example, the first vibration generator 201 can be connected with or coupled to the first surface 100a (or the rear surface) of the vibration member 100 by a first adhesive member 151. The first vibration generator 201 can be disposed in an internal space 300S between the vibration member 100 and a housing 300 and can be covered by the housing 300. For example, the first adhesive member 151 can be substantially the same as the connection member 150 described above with reference to FIGS. 1 and 2, and thus, repeated descriptions thereof are omitted.

The second vibration generator 202 can be disposed at the second surface 100b (or the front surface) of the vibration member 100. For example, the second vibration generator 202 can be connected with or coupled to the second surface 100b (or the front surface) of the vibration member 100 by a second adhesive member 152. The second vibration generator 202 can be exposed at the outside at the second surface 100b (or the front surface) of the vibration member 100. For example, the second adhesive member 152 can be substantially the same as the connection member 150 described above with reference to FIGS. 1 and 2, and thus, repeated descriptions thereof are omitted.

The first vibration generator 201 disposed at the first surface 100a (or the rear surface) of the vibration member 100 can be disposed to overlap the second vibration generator 202 disposed at the second surface 100b (or the front surface) of the vibration member 100 with the vibration member 100 therebetween. For example, the first vibration generator 201 disposed at the first surface 100a (or the rear surface) of the vibration member 100 and the second vibration generator 202 disposed at the second surface 100b (or the front surface) of the vibration member 100 can be disposed to be symmetrical with each other with the vibration member 100 therebetween.

The acoustic apparatus 10 according to another embodiment of the present disclosure can include the vibration apparatus 200 having a bimorph structure of the first vibration generator 201 and the second vibration generator 202, and thus, a sound characteristic and/or a sound pressure level characteristic of a sound can be more enhanced.

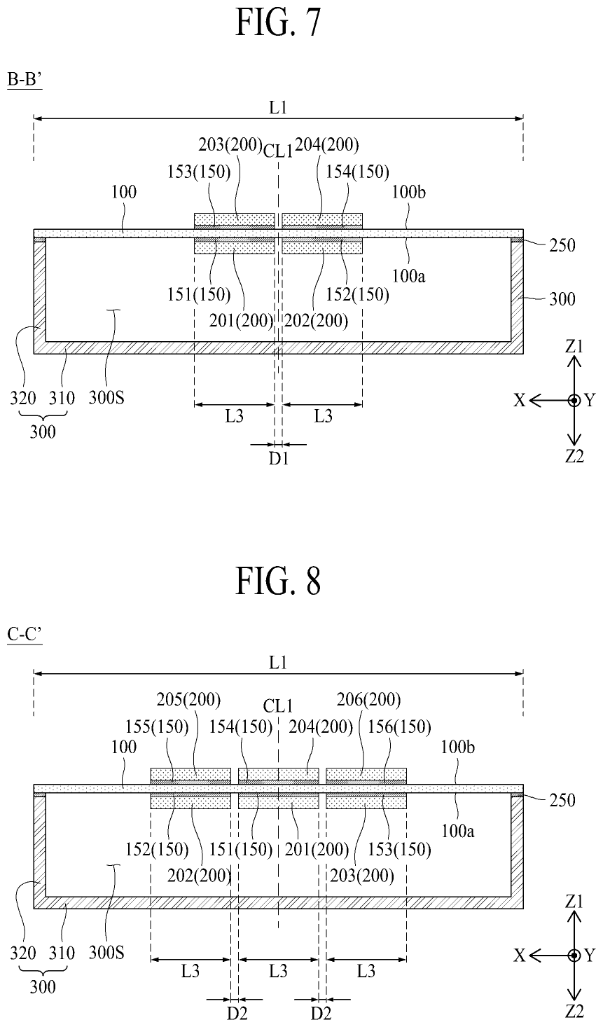

FIG. 7 is a cross-sectional view taken along line B-B′ illustrated in FIG. 4 according to another embodiment of the present disclosure. FIG. 7 illustrates an embodiment where a configuration of the vibration apparatus 200 is replaced with the arrangement of the vibration apparatuses 200 illustrated in FIG. 4, in the acoustic apparatus 10 described above with reference to FIGS. 1 and 2 or FIG. 6. Therefore, in the following description, the other elements except the modified arrangement of the vibration apparatus 200 and relevant elements are referred to by like reference numerals, and repeated descriptions thereof are omitted or will be briefly given.

Referring to FIGS. 4 and 7, in an acoustic apparatus 10 according to another embodiment of the present disclosure, a vibration apparatus 200 can include a plurality of vibration apparatuses 201 to 204.

The plurality of vibration apparatuses 201 to 204 can be disposed or configured to overlap one another, at each of a first surface 100a (or a rear surface) and a second surface 100b (or a front surface) of a vibration member 100. For example, the plurality of vibration apparatuses 201 to 204 can include a first vibration generator 201, a second vibration generator 202, a third vibration generator 203, and a fourth vibration generator 204.

The first to fourth vibration generators 201 to 204 can be configured to vibrate the vibration member 100. For example, the first to fourth vibration generators 201 to 204 can be disposed or configured to overlap one another at each of the first surface 100a (or the rear surface) and the second surface 100b (or the front surface) of the vibration member 100. Therefore, the vibration member 100 can vibrate based on vibrations of the first to fourth vibration generators 201 to 204 to generate or output one or more of a vibration and a sound.

The first vibration generator 201 and the second vibration generator 202 can be disposed at the first surface 100a (or the rear surface) of the vibration member 100. For example, the first vibration generator 201 can be connected with or coupled to the first surface 100a (or the rear surface) of the vibration member 100 by a first adhesive member 151. The second vibration generator 202 can be connected with or coupled to the first surface 100a (or the rear surface) of the vibration member 100 by a second adhesive member 152. The first vibration generator 201 and the second vibration generator 202 can be disposed in an internal space 300S between the vibration member 100 and a housing 300 and can be covered by the housing 300. For example, the first and second adhesive members 151 and 152 can be substantially the same as the connection member 150 described above with reference to FIGS. 1 and 2, and thus, repeated descriptions thereof are omitted.

The first vibration generator 201 and the second vibration generator 202 can be disposed to be spaced apart from each other a first direction X parallel to a first length L1 direction of the vibration member 100, at the first surface 100a (or the rear surface) of the vibration member 100. For example, the first vibration generator 201 and the second vibration generator 202 can be disposed to be symmetrical with each other with respect to a first center line CL1 of the vibration member 100, at the first surface 100a (or the rear surface) of the vibration member 100. For example, the first vibration generator 201 and the second vibration generator 202 can be disposed to be symmetrical with each other and not to overlap with respect to the first center line CL1 of the vibration member 100, at the first surface 100a (or the rear surface) of the vibration member 100.

The first vibration generator 201 can be disposed or configured in a left region with respect to the first center line CL1 of the vibration member 100, at the first surface 100a (or the rear surface) of the vibration member 100. The second vibration generator 202 can be disposed or configured in a right region with respect to the first center line CL1 of the vibration member 100, at the first surface 100a (or the rear surface) of the vibration member 100. The first vibration generator 201 and the second vibration generator 202 can be disposed to be spaced apart from each other by a first distance D1 with the first center line CL1 of the vibration member 100 therebetween, at the first surface 100a (or the rear surface) of the vibration member 100. The first vibration generator 201 and the second vibration generator 202 can be disposed to be spaced apart from each other by the first distance D1 in the first direction X with the first center line CL1 of the vibration member 100 therebetween, at the first surface 100a (or the rear surface) of the vibration member 100.

The third vibration generator 203 and the fourth vibration generator 204 can be disposed at the second surface 100b (or the front surface) of the vibration member 100. For example, the third vibration generator 203 can be connected with or coupled to the second surface 100b (or the front surface) of the vibration member 100 by a third adhesive member 153. The fourth vibration generator 204 can be connected with or coupled to the second surface 100b (or the front surface) of the vibration member 100 by a fourth adhesive member 154. The third vibration generator 203 and the fourth vibration generator 204 can be exposed at the outside at the second surface 100b (or the front surface) of the vibration member 100. For example, the third and fourth adhesive members 153 and 154 can be substantially the same as the connection member 150 described above with reference to FIGS. 1 and 2, and thus, repeated descriptions thereof are omitted.

The third vibration generator 203 and the fourth vibration generator 204 can be disposed to be spaced apart from each other in the first direction X parallel to the first length L1 direction of the vibration member 100, at the second surface 100b (or the front surface) of the vibration member 100. For example, the third vibration generator 203 and the fourth vibration generator 204 can be disposed to be symmetrical with each other with respect to the first center line CL1 of the vibration member 100, at the second surface 100b (or the front surface) of the vibration member 100. For example, the third vibration generator 203 and the fourth vibration generator 204 can be disposed to be symmetrical with each other and not to overlap with respect to the first center line CL1 of the vibration member 100, at the second surface 100b (or the front surface) of the vibration member 100.

The third vibration generator 203 can be disposed or configured in a left region with respect to the first center line CL1 of the vibration member 100, at the second surface 100b (or the front surface) of the vibration member 100. The fourth vibration generator 204 can be disposed or configured in a right region with respect to the first center line CL1 of the vibration member 100, at the second surface 100b (or the front surface) of the vibration member 100. The third vibration generator 203 and the fourth vibration generator 204 can be disposed to be spaced apart from each other by the first distance D1 with the first center line CL1 of the vibration member 100 therebetween, at the second surface 100b (or the front surface) of the vibration member 100. The third vibration generator 203 and the fourth vibration generator 204 can be disposed to be spaced apart from each other by the first distance D1 in the first direction X with the first center line CL1 of the vibration member 100 therebetween, at the second surface 100b (or the front surface) of the vibration member 100.

The first vibration generator 201 and the second vibration generator 202 disposed at the first surface 100a (or the rear surface) of the vibration member 100 can be disposed to overlap the third vibration generator 203 and the fourth vibration generator 204 disposed at the second surface 100b (or the front surface) of the vibration member 100 with the vibration member 100 therebetween. For example, the first vibration generator 201 and the second vibration generator 202 disposed at the first surface 100a (or the rear surface) of the vibration member 100 and the third vibration generator 203 and the fourth vibration generator 204 disposed at the second surface 100b (or the front surface) of the vibration member 100 can be disposed to be symmetrical with each other with the vibration member 100 therebetween.

The acoustic apparatus 10 according to another embodiment of the present disclosure can include the vibration apparatus 200 having a bimorph structure of the first to fourth vibration generators 201 to 204, and thus, a sound characteristic and/or a sound pressure level characteristic of a sound can be more enhanced.

In addition to the bimorph structure of the first to fourth vibration generators 201 to 204, where the first vibration generator 201 can overlap the third vibration generator 203, and the second vibration generator 202 can overlap the fourth vibration generator 204, the embodiments of the present disclosure are not limited thereto. For example, the first vibration generator 201 need not completely overlap the third vibration generator 203, and the second vibration generator 202 need not completely overlap the fourth vibration generator 204. That is, the first vibration generator 201 can partially overlap the third vibration generator 203, and the second vibration generator 202 can partially overlap the fourth vibration generator 204. When there is a partial overlap between the first and third vibration generators 201 and 203, and the second and fourth vibration generators 202 and 204, the distance D1 between the first and second vibration generators 201 and 202, and the distance D1 between the third and fourth vibration generators 203 and 204 can be different. Also, in other embodiments

FIG. 8 is a cross-sectional view taken along line C-C′ illustrated in FIG. 5 according to another embodiment of the present disclosure. FIG. 8 illustrates an embodiment where a configuration of the vibration apparatus 200 is replaced with the arrangement of the vibration apparatuses 200 illustrated in FIG. 5, in the acoustic apparatus 10 described above with reference to FIGS. 1 and 2 or FIG. 6 or 7. Therefore, in the following description, the other elements except the modified arrangement of the vibration apparatus 200 and relevant elements are referred to by like reference numerals, and repeated descriptions thereof are omitted or will be briefly given.

Referring to FIGS. 5 and 8, in an acoustic apparatus 10 according to another embodiment of the present disclosure, a vibration apparatus 200 can include a plurality of vibration apparatuses 201 to 206.

The plurality of vibration apparatuses 201 to 206 can be disposed or configured to overlap one another, at each of a first surface 100a (or a rear surface) and a second surface 100b (or a front surface) of a vibration member 100. For example, the plurality of vibration apparatuses 201 to 206 can include a first vibration generator 201, a second vibration generator 202, a third vibration generator 203, a fourth vibration generator 204, a fifth vibration generator 205, and a sixth vibration generator 206.

The first to sixth vibration generators 201 to 206 can be configured to vibrate the vibration member 100. For example, the first to sixth vibration generators 201 to 206 can be disposed or configured to overlap one another at each of the first surface 100a (or the rear surface) and the second surface 100b (or the front surface) of the vibration member 100. Therefore, the vibration member 100 can vibrate based on vibrations of the first to sixth vibration generators 201 to 206 to generate or output one or more of a vibration and a sound.

The first to third vibration generators 201 to 203 can be disposed at the first surface 100a (or the rear surface) of the vibration member 100. For example, the first vibration generator 201 can be connected with or coupled to the first surface 100a (or the rear surface) of the vibration member 100 by a first adhesive member 151. The second vibration generator 202 can be connected with or coupled to the first surface 100a (or the rear surface) of the vibration member 100 by a second adhesive member 152. The third vibration generator 203 can be connected with or coupled to the first surface 100a (or the rear surface) of the vibration member 100 by a third adhesive member 153. The first to third vibration generators 201 to 203 can be disposed in an internal space 300S between the vibration member 100 and a housing 300 and can be covered by a housing 300. For example, the first to third adhesive members 151 to 153 can be substantially the same as the connection member 150 described above with reference to FIGS. 1 and 2, and thus, repeated descriptions thereof are omitted.

The first to third vibration generators 201 to 203 can be disposed to be spaced apart from each other a first direction X parallel to a first length L1 direction of the vibration member 100, at the first surface 100a (or the rear surface) of the vibration member 100. For example, the first to third vibration generators 201 to 203 can be disposed to be symmetrical with one another with respect to a first center line CL1 of the vibration member 100, at the first surface 100a (or the rear surface) of the vibration member 100. For example, the first vibration generator 201 of the first to third vibration generators 201 to 203 can be disposed to overlap the first center line CL1 of the vibration member 100, at the first surface 100a (or the rear surface) of the vibration member 100. For example, the second vibration generator 202 and the third vibration generator 203 of the first to third vibration generators 201 to 203 can be disposed to be symmetrical with each other with respect to the first center line CL1 of the vibration member 100. For example, the second vibration generator 202 and the third vibration generator 203 can be disposed to be symmetrical with each other with the first vibration generator 201 therebetween.

The first vibration generator 201 can be disposed to overlap the first center line CL1 of the vibration member 100, at the first surface 100a (or the rear surface) of the vibration member 100. For example, the first vibration generator 201 can be disposed or configured in a center region overlapping the first center line CL1 of the vibration member 100, at the first surface 100a (or the rear surface) of the vibration member 100. The second vibration generator 202 can be disposed or configured in a left region with respect to the first vibration generator 201, at the first surface 100a (or the rear surface) of the vibration member 100. The second vibration generator 202 can be parallel to the first vibration generator 201 and can be arranged to be spaced apart from the first vibration generator 201 by a second distance D2 to the left in the first direction X. The third vibration generator 203 can be disposed or configured in a right region with respect to the first vibration generator 201, at the first surface 100a (or the rear surface) of the vibration member 100. The third vibration generator 203 can be parallel to the first vibration generator 201 and can be arranged to be spaced apart from the first vibration generator 201 by the second distance D2 to the right in the first direction X. For example, the third vibration generator 203 can be disposed to be symmetrical with the second vibration generator 202 with the first vibration generator 201 therebetween.

The fourth to sixth vibration generators 204 to 206 can be disposed at the second surface 100b (or the front surface) of the vibration member 100. For example, the fourth vibration generator 204 can be connected with or coupled to the second surface 100b (or the front surface) of the vibration member 100 by a fourth adhesive member 154. The fifth vibration generator 205 can be connected with or coupled to the second surface 100b (or the front surface) of the vibration member 100 by a fifth adhesive member 155. The sixth vibration generator 206 can be connected with or coupled to the second surface 100b (or the front surface) of the vibration member 100 by a sixth adhesive member 156. The fourth to sixth vibration generators 204 to 206 can be exposed at the outside at the second surface 100b (or the front surface) of the vibration member 100. For example, the fourth to sixth adhesive members 154 to 156 can be substantially the same as the connection member 150 described above with reference to FIGS. 1 and 2, and thus, repeated descriptions thereof are omitted.

The fourth to sixth vibration generators 204 to 206 can be disposed to be spaced apart from one another in the first direction X parallel to the first length L1 direction of the vibration member 100, at the second surface 100b (or the front surface) of the vibration member 100. For example, the fourth to sixth vibration generators 204 to 206 can be disposed to be symmetrical with one another with respect to the first center line CL1 of the vibration member 100, at the second surface 100b (or the front surface) of the vibration member 100. For example, the fourth vibration generator 204 of the fourth to sixth vibration generators 204 to 206 can be disposed to overlap the first center line CL1 of the vibration member 100, at the second surface 100b (or the front surface) of the vibration member 100. For example, the fifth vibration generator 205 and the sixth vibration generator 206 of the fourth to sixth vibration generators 204 to 206 can be disposed to be symmetrical with each other with respect to the first center line CL1 of the vibration member 100. For example, the fifth vibration generator 205 and the sixth vibration generator 206 can be disposed to be symmetrical with each other with the fourth vibration generator 204 therebetween.

The fourth vibration generator 204 can be disposed or configured to overlap the first center line CL1 of the vibration member 100, at the second surface 100b (or the front surface) of the vibration member 100. For example, the fourth vibration generator 204 can be disposed or configured in a center region overlapping the first center line CL1 of the vibration member 100, at the second surface 100b (or the front surface) of the vibration member 100. The fifth vibration generator 205 can be disposed or configured in a left region with respect to the fourth vibration generator 204, at the second surface 100b (or the front surface) of the vibration member 100. The fifth vibration generator 205 can be parallel to the fourth vibration generator 204 and can be arranged to be spaced apart from the fourth vibration generator 204 by a second distance D2 to the left in the first direction X. The sixth vibration generator 206 can be disposed or configured in a right region with respect to the fourth vibration generator 204, at the second surface 100b (or the front surface) of the vibration member 100. The sixth vibration generator 206 can be parallel to the fourth vibration generator 204 and can be arranged to be spaced apart from the fourth vibration generator 204 by the second distance D2 to the right in the first direction X. For example, the sixth vibration generator 206 can be disposed to be symmetrical with the fifth vibration generator 205 with the fourth vibration generator 204 therebetween.

The acoustic apparatus 10 according to another embodiment of the present disclosure can include the vibration apparatus 200 having a bimorph structure of the first to sixth vibration generators 201 to 206, and thus, a sound characteristic and/or a sound pressure level characteristic of a sound can be more enhanced.

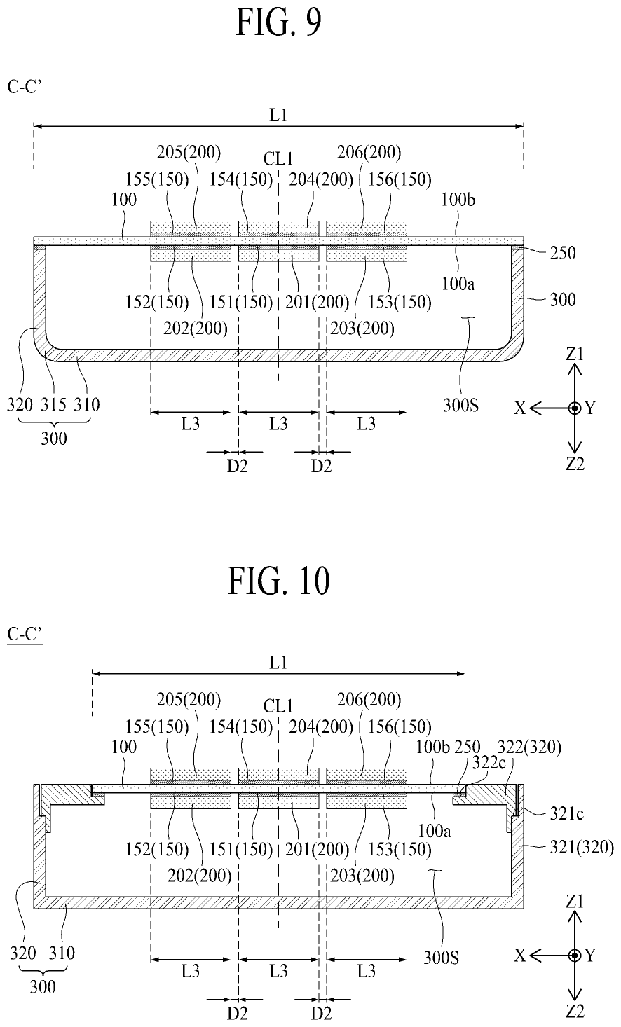

FIG. 9 is a cross-sectional view taken along line C-C′ illustrated in FIG. 5 according to another embodiment of the present disclosure. FIG. 9 illustrates an embodiment implemented by modifying a configuration of the housing 300 illustrated in FIG. 8. Therefore, in the following description, the other elements except a modified configuration of a housing 300 and relevant elements are referred to by like reference numerals, and repeated descriptions thereof are omitted or will be briefly given.

Referring to FIG. 9, a housing 300 according to another embodiment of the present disclosure can further include a curved portion 315 which is provided between a bottom portion 310 and a supporting portion 320. The curved portion 315 can be provided at a connection portion between the bottom portion 310 and the supporting portion 320. For example, the curved portion 315 can be configured in a curved structure which has a certain curvature radius at the connection portion between the bottom portion 310 and the supporting portion 320.

The curved portion 315 can be configured in a curved structure which has a certain curvature radius between the bottom portion 310 parallel to a horizontal direction (a first direction X and/or a second direction Y) and the supporting portion 320 parallel to a vertical direction (Z1, Z2).

The curved portion 315 can be provided as one body with the bottom portion 310 and the supporting portion 320. For example, an internal space 300S surrounded by the curved portion 315 and the supporting portion 320 can be provided on the bottom portion 310.

The acoustic apparatus 10 according to another embodiment of the present disclosure can include the curved portion 315 which is configured in the housing 300 in a curved structure having a certain curvature radius, and thus, can prevent or minimize a reduction in sound pressure level characteristic caused by a standing wave which occurs due to interference of a progressive wave and a reflected wave. For example, a sound wave (or a sound vibration) which is generated as a vibration member 100 is vibrated by the vibration apparatus 200 can travel while spreading radially from the vibration apparatus 200. The curved portion 315 of the housing 300 can disperse the reflection of a sound wave generated from the vibration apparatus 200 to minimize or prevent interference and/or overlapping of the progressive wave and the reflected wave, and thus, can reduce a peak or dip phenomenon of a sound characteristic caused by the standing wave, thereby enhancing a flatness characteristic of a sound pressure level. The peak can be a phenomenon where a sound pressure level bounces in a specific frequency, and the dip can be a phenomenon where a low sound pressure level is generated as the occurrence of a sound having a specific frequency is prevented. The flatness of a sound pressure level can be a difference between a highest sound pressure level and a lowest sound pressure level in a specific frequency.

The housing 300 described above with reference to FIG. 9 can be identically applied to FIGS. 2 and 6 to 8.

FIG. 10 is a cross-sectional view taken along line C-C′ illustrated in FIG. 5 according to another embodiment of the present disclosure. FIG. 10 illustrates an embodiment implemented by modifying a configuration of the housing 300 illustrated in FIG. 8 or 9. Therefore, in the following description, the other elements except a modified configuration of a housing 300 and relevant elements are referred to by like reference numerals, and repeated descriptions thereof are omitted or will be briefly given.

Referring to FIG. 10, a housing 300 according to another embodiment of the present disclosure can include a bottom portion 310 and a supporting portion 320. The supporting portion 320 can include a first supporting portion 321 and a second supporting portion 322.

The first supporting portion 321 can be connected with a periphery portion of the bottom portion 310. For example, the first supporting portion 321 can be connected with the bottom portion 310 and can be configured to protrude vertically from the bottom portion 310. The first supporting portion 321 can include a structure which is bent from the periphery portion of the bottom portion 310. For example, the first supporting portion 321 can be parallel to a vertical direction (Z1, Z2) perpendicular to the ground. The first supporting portion 321 can include a coupling portion 321c coupled to the second supporting portion 322.

The second supporting portion 322 can be configured to support a periphery portion of a vibration member 100. The second supporting portion 322 can connect the first supporting portion 321 with the vibration member 100. For example, the second supporting portion 322 can be connected with the first supporting portion 321 in parallel to the bottom portion 310 and can be connected with the periphery portion of the vibration member 100. The second supporting portion 322 can be coupled or fastened to a coupling portion 321c of the first supporting portion 321. The second supporting portion 322 can be connected with the first supporting portion 321 and can be configured to protrude in a first direction X from the first supporting portion 321. The second supporting portion 322 can include a groove portion 322c coupled to the vibration member 100. The second supporting portion 322 can include a tetragonal band or tetragonal ring shape surrounded by the first supporting portion 321, but embodiments of the present disclosure are not limited thereto. For example, the second supporting portion 322 can have a shape corresponding to a shape of the vibration member 100. The groove portion 322c of the second supporting portion 322 can accommodate at least a portion of a first surface 100a (or a rear surface) of the periphery portion of the vibration member 100. The groove portion 322c of the second supporting portion 322 can accommodate at least a portion of a lateral surface and the first surface 100a (or the rear surface) of the periphery portion of the vibration member 100 and can support the periphery portion of the vibration member 100.

The second supporting portion 322 of the housing 300 can be connected with or coupled to the vibration member 100 by a coupling member 250. The vibration member 100 can be connected with or coupled to the second supporting portion 322 by the coupling member 250. The coupling member 250 can be disposed between the groove portion 322c of the second supporting portion 322 and a periphery (or an edge) of the first surface 100a (or the rear surface) of the vibration member 100.

The acoustic apparatus 10 according to another embodiment of the present disclosure can be configured in a fastening structure where the first supporting portion 321 and the second supporting portion 322 are not provided as one body, and thus, can minimize or prevent the transfer of a vibration of the vibration member 100 to the housing 300.

The housing 300 described above with reference to FIG. 10 can be identically applied to FIGS. 2, 6, and 7.

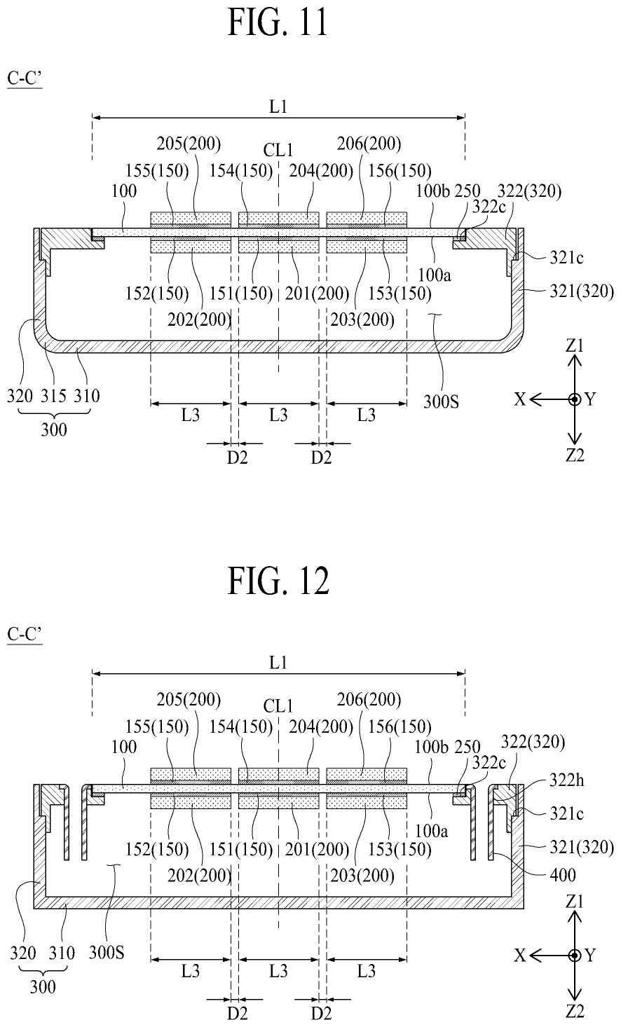

FIG. 11 is a cross-sectional view taken along line C-C′ illustrated in FIG. 5 according to another embodiment of the present disclosure. FIG. 11 illustrates an embodiment implemented by modifying a configuration of the housing 300 illustrated in FIGS. 8 to 10. Therefore, in the following description, the other elements except a modified configuration of a housing 300 and relevant elements are referred to by like reference numerals, and repeated descriptions thereof are omitted or will be briefly given.

Referring to FIG. 11, a housing 300 according to another embodiment of the present disclosure can include a bottom portion 310 and a supporting portion 320. The supporting portion 320 can include a first supporting portion 321 and a second supporting portion 322. The housing 300 can further include a curved portion 315 provided between the bottom portion 310 and the first supporting portion 321. The curved portion 315 can be provided at a connection portion between the bottom portion 310 and the first supporting portion 321. For example, the curved portion 315 can be configured in a curved structure which has a certain curvature radius at the connection portion between the bottom portion 310 and the first supporting portion 321.

The curved portion 315 can be configured in a curved structure which has a certain curvature radius between the bottom portion 310 parallel to a horizontal direction (a first direction X and/or a second direction Y) and the first supporting portion 321 parallel to a vertical direction (Z1, Z2).

The curved portion 315 can be provided as one body with the bottom portion 310 and the first supporting portion 321. For example, an internal space 300S surrounded by the curved portion 315 and the first supporting portion 321 can be provided on the bottom portion 310.

The acoustic apparatus 10 according to another embodiment of the present disclosure can be configured in a fastening structure where the first supporting portion 321 and the second supporting portion 322 are not provided as one body and can include the curved portion 315 provided in a curved structure having a certain curvature radius between the first supporting portion 321 and the bottom portion 310, and thus, can prevent or minimize a reduction in sound pressure level characteristic caused by a standing wave which occurs due to interference of a progressive wave and a reflected wave and can prevent the transfer of a vibration of the vibration member 100 to the housing 300.

The housing 300 described above with reference to FIG. 11 can be identically applied to FIGS. 2, 6, and 7.

FIG. 12 is a cross-sectional view taken along line C-C′ illustrated in FIG. 5 according to another embodiment of the present disclosure. FIG. 12 illustrates an embodiment implemented by modifying a configuration of the housing 300 illustrated in FIGS. 8 to 11. Therefore, in the following description, the other elements except a modified configuration of a housing 300 and relevant elements are referred to by like reference numerals, and repeated descriptions thereof are omitted or will be briefly given.

Referring to FIG. 12, a housing 300 according to another embodiment of the present disclosure can include a bottom portion 310, a supporting portion 320, and a duct portion 400. The supporting portion 320 can include a first supporting portion 321 and a second supporting portion 322. The housing 300 can further include the duct portion 400 in the second supporting portion 322. The duct portion 400 can be configured to connect an internal space 300S of the housing 300 with the outside.

The duct portion 400 can be disposed in a hole 322h which is provided in the second supporting portion 322. The duct portion 400 can be configured in a circular or oval pipe structure which protrudes from the second supporting portion 322 in a direction (or a vertical direction of a lower portion Z2) facing the bottom portion 310. But embodiments of the present disclosure are not limited thereto. For example, the duct portion 400 can have different pipe structure from those of circular or oval, such as a polygonal or rectangular. Also, the size of the duct portion 400 need not be constant along a longitudinal direction so that a top portion (at the outside of the acoustic apparatus 10) of the duct portion 400 can have a different size from a bottom portion (at the internal space 300S) of the duct portion 400. For example, the duct portion 400 can become wider in going from the bottom portion to the top portion. Also, a length of the duct portion 400 can vary so that the length of the duct portion 400 can be equal to or greater than a length of the hole 322h through the second supporting portion 322.

The duct portion 400 can be configured to adjust a flow of air in the internal space 300S of the housing 300. For example, the duct portion 400 can be configured to invert a phase of a sound wave, which is generated from a vibration apparatus 200 and is radiated into the internal space 300S of the housing 300, and output a phase-inverted sound wave in a forward direction (or a vertical direction of an upper portion Z1) of a vibration member 100. For example, the duct portion 400 can invert a phase of a sound wave radiated in the vertical direction of the lower portion Z2 from the vibration apparatus 200 to generate a sound wave having a 180-degree phase and can output the sound wave having a 180-degree phase in the vertical direction of the upper portion Z1.

The duct portion 400 can be provided as one or more, and the one or more duct portions 400 can be disposed or configured at peripheries of both edges of the vibration member 100 in a first direction X parallel to a first length L1 direction of the vibration member 100. For example, the duct portion 400 can be configured to be spaced apart from the vibration member 100 without overlapping the vibration member 100. The duct portion 400 can be disposed or configured in the second supporting portion 322 at peripheries of the both edges of the vibration member 100 in the first direction X parallel to the first length L1 direction of the vibration member 100.

The acoustic apparatus 10 according to another embodiment of the present disclosure can be configured in a fastening structure where the first supporting portion 321 and the second supporting portion 322 are not provided as one body and can include the duct portion 400 disposed in the second supporting portion 322 at peripheries of the both edges of the vibration member 100 in the first length L1 direction of the vibration member 100, and thus, can invert a phase of a sound wave radiated into the internal space 300S of the housing 300 to output a phase-inverted sound wave to the outside through the duct portion 400. Accordingly, a band of a low-pitched sound band can extend, and thus, a sound characteristic and/or a sound pressure level characteristic of the low-pitched sound band can be improved and the transfer of a vibration of the vibration member 100 to the housing 300 can be minimized or prevented.

The housing 300 described above with reference to FIG. 12 can be identically applied to FIGS. 2, 6, and 7.

FIG. 13 is a cross-sectional view taken along line C-C′ illustrated in FIG. 5 according to another embodiment of the present disclosure. FIG. 13 illustrates an embodiment implemented by modifying a configuration of the housing 300 illustrated in FIGS. 8 to 12. Therefore, in the following description, the other elements except a modified configuration of a housing 300 and relevant elements are referred to by like reference numerals, and repeated descriptions thereof are omitted or will be briefly given.

Referring to FIG. 13, a housing 300 according to another embodiment of the present disclosure can include a bottom portion 310, a supporting portion 320, and a duct portion 400. The supporting portion 320 can include a first supporting portion 321 and a second supporting portion 322. The housing 300 can further include a curved portion 315 provided between the bottom portion 310 and the first supporting portion 321. The housing 300 can further include the duct portion 400 in the second supporting portion 322. The curved portion 315 can be provided at a connection portion between the bottom portion 310 and the first supporting portion 321. For example, the curved portion 315 can be configured in a curved structure which has a certain curvature radius at the connection portion between the bottom portion 310 and the first supporting portion 321. The duct portion 400 can be configured to connect an internal space 300S of the housing 300 with the outside.

The curved portion 315 can be configured in a curved structure which has a certain curvature radius between the bottom portion 310 parallel to a horizontal direction (a first direction X and/or a second direction Y) and the first supporting portion 321 parallel to a vertical direction (Z1, Z2).

The curved portion 315 can be provided as one body with the bottom portion 310 and the first supporting portion 321. For example, the bottom portion 310, the curved portion 315, and the first supporting portion 321 can be provided as one body. Therefore, an internal space 300S surrounded by the curved portion 315 and the first supporting portion 321 can be provided on the bottom portion 310.

The duct portion 400 can be disposed in a hole 322h which is provided in the second supporting portion 322. The duct portion 400 can be configured in a circular or oval pipe structure which protrudes from the second supporting portion 322 in a direction (or a vertical direction of a lower portion Z2) facing the bottom portion 310.

The duct portion 400 can be provided as one or more, and the one or more duct portions 400 can be disposed or configured at peripheries of both edges of the vibration member 100 in a first direction X parallel to a first length L1 direction of the vibration member 100. For example, the duct portion 400 can be configured to be spaced apart from the vibration member 100 without overlapping the vibration member 100. The duct portion 400 can be disposed or configured in the second supporting portion 322 at peripheries of the both edges of the vibration member 100 in the first direction X parallel to the first length L1 direction of the vibration member 100.

The acoustic apparatus 10 according to another embodiment of the present disclosure can be configured in a fastening structure where the first supporting portion 321 and the second supporting portion 322 are not provided as one body, and moreover, can include the curved portion 315 provided in a curved structure having a certain curvature radius between the first supporting portion 321 and the bottom portion 310 and can include the duct portion 400 disposed in the second supporting portion 322 at peripheries of the both edges of the vibration member 100 in the first length L1 direction of the vibration member 100. Accordingly, the acoustic apparatus 10 can prevent or minimize a reduction in sound pressure level characteristic caused by a standing wave which occurs due to interference of a progressive wave and a reflected wave and can invert a phase of a sound wave radiated into the internal space 300S of the housing 300 to output a phase-inverted sound wave to the outside through the duct portion 400. Therefore, a band of a low-pitched sound band can extend, and thus, a sound characteristic and/or a sound pressure level characteristic of the low-pitched sound band can be improved and the transfer of a vibration of the vibration member 100 to the housing 300 can be minimized or prevented.

The housing 300 described above with reference to FIG. 13 can be identically applied to FIGS. 2, 6, and 7.

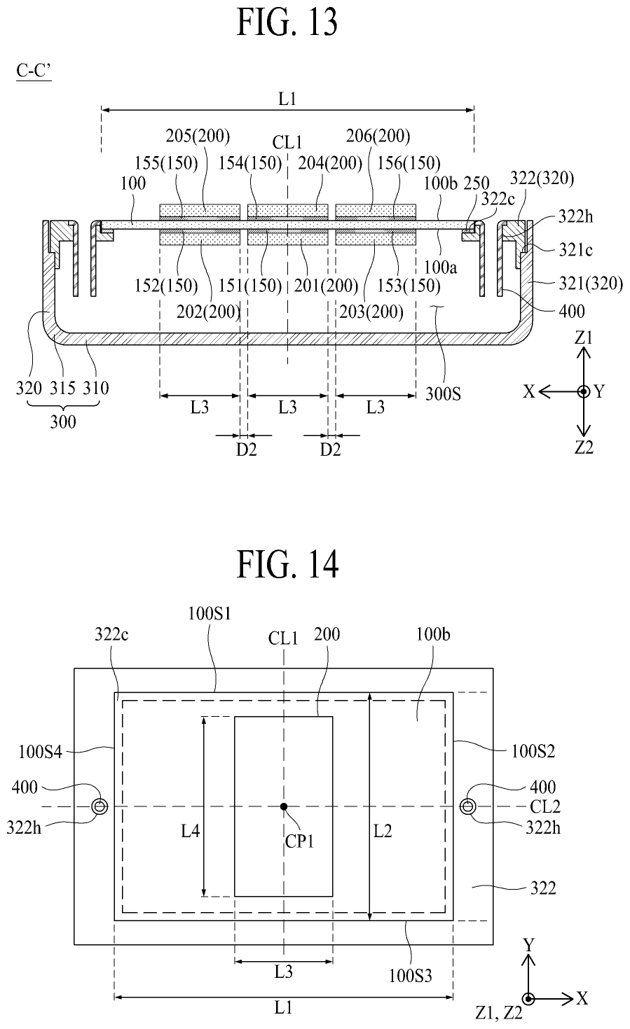

FIG. 14 illustrates an acoustic apparatus according to another embodiment of the present disclosure. FIG. 14 illustrates an embodiment where a duct portion 400 is added to the vibration member 100 and the vibration apparatus 200 illustrated in FIG. 3. Therefore, in the following description, the other elements except a duct portion 400 and relevant elements are referred to by like reference numerals, and repeated descriptions thereof are omitted or will be briefly given.

Referring to FIG. 14, a vibration member 100 can be configured to be supported by a second supporting portion 322 of a housing 300. The second supporting portion 322 can include a tetragonal band or tetragonal ring shape, which surrounds an edge portion (or a periphery portion) of the vibration member 100, but embodiments of the present disclosure are not limited thereto. The vibration member 100 can be accommodated into and supported by a groove portion 322c of the second supporting portion 322. At least a portion of a first surface 100a (or a rear surface) of the vibration member 100 can be accommodated into the groove portion 322c of the second supporting portion 322. The groove portion 322c of the second supporting portion 322 can accommodate and support an edge portion (or a periphery portion) of the first surface 100a (or the rear surface) of the vibration member 100.

The vibration member 100 or a second surface 100b of the vibration member 100 can include a tetragonal shape or a rectangular shape, where a first length L1 in a first direction X is longer than a second length L2 in a second direction Y, but embodiments of the present disclosure are not limited thereto. For example, the vibration member 100 or the second surface 100b of the vibration member 100 can include an oval shape or a round-polygonal shape, which has a long axis having the first length L1 in the first direction X and has a short axis having the second length L2 in the second direction Y.

The vibration member 100 or the second surface 100b of the vibration member 100 can include a tetragonal shape or a rectangular shape, which includes a first side 100S1 (or an upper side) having the first length L1, a second side 100S2 (or a right side) having the second length L2, a third side 100S3 (or a lower side) which is parallel to the first side and has the first length L1, and a fourth side 100S4 (or a left side) which is parallel to the second side and has the second length L2, but embodiments of the present disclosure are not limited thereto.

In the vibration member 100 or the second surface 100b of the vibration member 100, a first center line CL1 can be parallel to the second direction Y and can be disposed at a center between the second side 100S2 and the fourth side 100S4 in the first direction X. In the vibration member 100 or the second surface 100b of the vibration member 100, a second center line CL2 can be parallel to the first direction X and can be disposed at a center between the first side 100S1 and the third side 100S3 in the second direction Y. For example, a center portion of the vibration member 100 or the second surface 100b of the vibration member 100 can be a portion or a point at which the first center line CL1 intersects with the second center line CL2.

The vibration apparatus 200 can be configured to vibrate the vibration member 100. Therefore, the vibration member 100 can vibrate based on a vibration of the vibration apparatus 200 to generate or output one or more of a vibration and a sound. The vibration apparatus 200 can be connected with at least one surface of the vibration member 100 by the connection member 150, but embodiments of the present disclosure are not limited thereto. For example, the vibration apparatus 200 can be connected with or coupled to the first surface 100a (or the rear surface) of the vibration member 100 by the connection member 150. For example, the vibration apparatus 200 can be connected with or coupled to the second surface 100b (or the front surface), which is opposite to the first surface 100a, of the vibration member 100 by the connection member 150. For example, the vibration apparatus 200 can be connected with or coupled to each of the first surface 100a (or the rear surface) and the second surface 100b (or the front surface) of the vibration member 100 by the connection member 150. For example, the vibration apparatuses 200 disposed at each of the first surface 100a and the second surface 100b of the vibration member 100 can be disposed to be symmetrical and overlap each other with the vibration member 100 therebetween.

The vibration apparatus 200 can have a third length L3 parallel to the first direction X and a fourth length L4 parallel to the second direction Y. For example, the vibration apparatus 200 can have a tetragonal shape or a rectangular shape, where the fourth length L4 parallel to the second direction Y is longer than the third length L3 parallel to the first direction X. For example, the vibration apparatus 200 can have a tetragonal shape or a rectangular shape, which has a long side in the second direction Y intersecting with a long-side direction of the vibration member 100. For example, a first length L1 direction (or a long-side direction) of the vibration member 100 and a fourth length L4 direction (or a long-side direction) of the vibration apparatus 200 can be configured to intersect with each other.

The vibration apparatus 200 can be disposed to overlap a center portion (or the first center line CL1 or the second center line CL2) of the vibration member 100, on at least one surface of the vibration member 100. For example, the vibration apparatus 200 can be disposed to overlap the center portion (or the first center line CL1 or the second center line CL2) of the vibration member 100, at the first surface 100a (or the rear surface) and the second surface 100b (or the front surface) of the vibration member 100.

According to an embodiment of the present disclosure, the vibration apparatus 200 can be provided as one or more, and the one or more vibration apparatuses 200 can be disposed to overlap each other at each of the first surface 100a (or the rear surface) and the second surface 100b (or the front surface) of the vibration member 100. For example, the vibration apparatus 200 disposed at the first surface 100a (or the rear surface) of the vibration member 100 can be disposed to overlap the vibration apparatus 200 disposed at the second surface 100b (or the front surface) of the vibration member 100 with the vibration member 100 therebetween. For example, the vibration apparatus 200 disposed at the first surface 100a (or the rear surface) of the vibration member 100 and the vibration apparatus disposed at the second surface 100b (or the front surface) of the vibration member 100 can be disposed to be symmetrical with each other with the vibration member 100 therebetween.

The duct portion 400 can be disposed in a hole 322h which is provided in the second supporting portion 322. The duct portion 400 can be disposed at peripheries of both edges of the vibration member 100 in a first direction X parallel to a first length L1 direction of the vibration member 100. For example, the duct portion 400 can be disposed in the hole 322h provided at peripheries of the both edges of the vibration member 100 in the first direction X. For example, the duct portion 400 can be disposed to overlap the second center line CL2 of the vibration member 100. But embodiments of the present disclosure are not limited thereto.

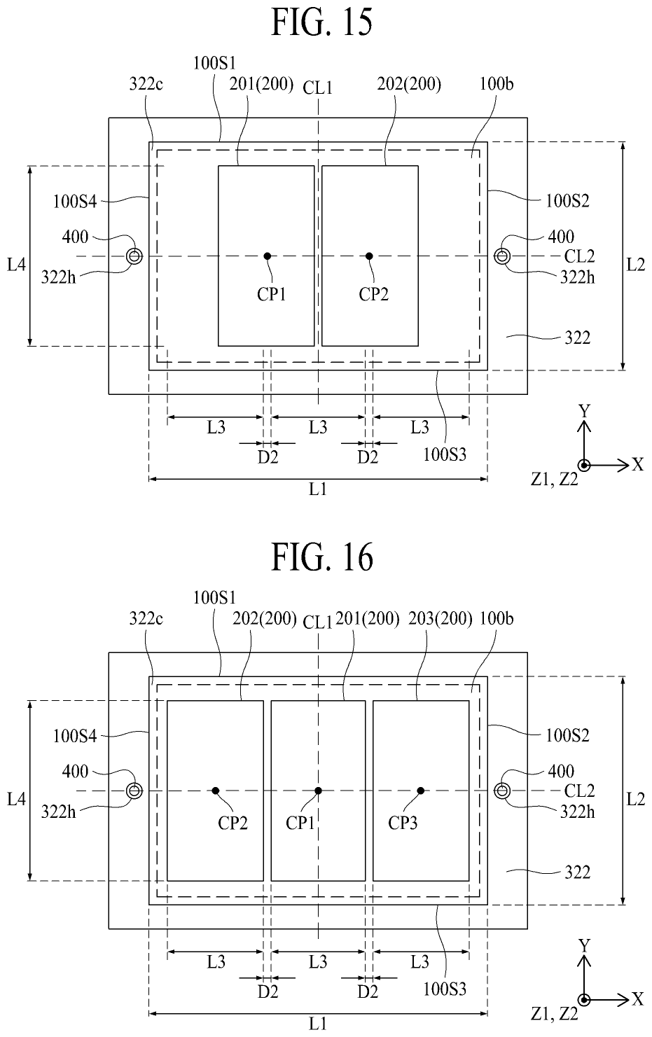

FIG. 15 illustrates an acoustic apparatus according to another embodiment of the present disclosure. FIG. 15 illustrates an embodiment where a duct portion 400 is added to the vibration member 100 and the one or more vibration apparatuses 200 illustrated in FIG. 4. Therefore, in the following description, the other elements except a duct portion 400 and relevant elements are referred to by like reference numerals, and repeated descriptions thereof are omitted or will be briefly given.

Referring to FIG. 15, a vibration member 100 can be configured to be supported by a second supporting portion 322 of a housing 300. The second supporting portion 322 can include a tetragonal band or tetragonal ring shape, which surrounds an edge portion (or a periphery portion) of the vibration member 100, but embodiments of the present disclosure are not limited thereto. The vibration member 100 can be accommodated into and supported by a groove portion 322c of the second supporting portion 322.

The vibration member 100 or a second surface 100b of the vibration member 100 can include a tetragonal shape or a rectangular shape, where a first length L1 in a first direction X is longer than a second length L2 in a second direction Y, but embodiments of the present disclosure are not limited thereto. For example, the vibration member 100 or the second surface 100b of the vibration member 100 can include an oval shape or a round-polygonal shape, which has a long axis having the first length L1 in the first direction X and has a short axis having the second length L2 in the second direction Y.

The vibration apparatus 200 can include one or more vibration apparatuses 201 and 202. For example, the one or more vibration apparatuses 201 and 202 disposed on at least one surface of the vibration member 100 can be provided as an even number. For example, the one or more vibration apparatuses 201 and 202 can include a first vibration generator 201 and a second vibration generator 202.

The first vibration generator 201 and the second vibration generator 202 can be disposed to be symmetrical with each other with respect to a center portion (or a first center line CL1 or a second center line CL2) of the vibration member 100, at the first surface 100a (or the rear surface) or the second surface 100b (or the front surface) of the vibration member 100.

The duct portion 400 can be disposed in a hole 322h which is provided in the second supporting portion 322. The duct portion 400 can be disposed at peripheries of both edges of the vibration member 100 in a first direction X parallel to a first length L1 direction of the vibration member 100. For example, the duct portion 400 can be disposed in the hole 322h provided at peripheries of the both edges of the vibration member 100 in the first direction X. For example, the duct portion 400 can be disposed to overlap the second center line CL2 of the vibration member 100.

FIG. 16 illustrates an acoustic apparatus according to another embodiment of the present disclosure. FIG. 16 illustrates an embodiment where a duct portion 400 is added to the vibration member 100 and the plurality of vibration apparatuses 200 illustrated in FIG. 5. Therefore, in the following description, the other elements except a duct portion 400 and relevant elements are referred to by like reference numerals, and repeated descriptions thereof are omitted or will be briefly given.

Referring to FIG. 16, a vibration member 100 can be configured to be supported by a second supporting portion 322 of a housing 300. The second supporting portion 322 can include a tetragonal band or tetragonal ring shape, which surrounds an edge portion (or a periphery portion) of the vibration member 100, but embodiments of the present disclosure are not limited thereto. The vibration member 100 can be accommodated into and supported by a groove portion 322c of the second supporting portion 322.

The vibration member 100 or a second surface 100b of the vibration member 100 can include a tetragonal shape or a rectangular shape, where a first length L1 in a first direction X is longer than a second length L2 in a second direction Y, but embodiments of the present disclosure are not limited thereto. For example, the vibration member 100 or the second surface 100b of the vibration member 100 can include an oval shape or a round-polygonal shape, which has a long axis having the first length L1 in the first direction X and has a short axis having the second length L2 in the second direction Y.

The vibration apparatus 200 can include a plurality of vibration apparatuses 201 to 203. For example, the plurality of vibration apparatuses 201 to 203 disposed on at least one surface of the vibration member 100 can be provided as an odd number. For example, the plurality of vibration apparatuses 201 to 203 can include a first vibration generator 201, a second vibration generator 202, and a third vibration generator 203.

The first to third vibration generators 201 to 203 can be disposed to be symmetrical with each other with respect to a center portion (or a first center line CL1 or a second center line CL2) of the vibration member 100, at a first surface 100a (or a rear surface) or the second surface 100b (or a front surface) of the vibration member 100.

The duct portion 400 can be disposed in a hole 322h which is provided in the second supporting portion 322. The duct portion 400 can be disposed at peripheries of both edges of the vibration member 100 in a first direction X parallel to a first length L1 direction of the vibration member 100. For example, the duct portion 400 can be disposed in the hole 322h provided at peripheries of the both edges of the vibration member 100 in the first direction X. For example, the duct portion 400 can be disposed to overlap the second center line CL2 of the vibration member 100.

In various embodiments of the present disclosure, when a plurality of vibration apparatuses 200 are provided on the vibration member 100, long lengths of the plurality of vibration apparatuses 200 need not be the same. For example, FIG. 16 shows the long lengths of the first, second and third vibration apparatuses 201, 202 and 203 being the same. But embodiments of the present disclosure are not limited thereto, and the long lengths of the first, second and third vibration apparatuses 201, 202 and 203 can be different. For example, the long lengths of the second and third vibration apparatuses 202 and 203 can be the same, but be different from that of the first vibration apparatus 201. When different, the long length of the first vibration apparatus 201 can be greater than or less than the long lengths of the second and third vibration apparatuses 202 and 203. The long lengths of the first, second and third vibration apparatuses 201, 202 and 203 being different can maintain the symmetrical arrangement of the first, second and third vibration apparatuses 201, 202 and 203 with respect to the center portion CP1.

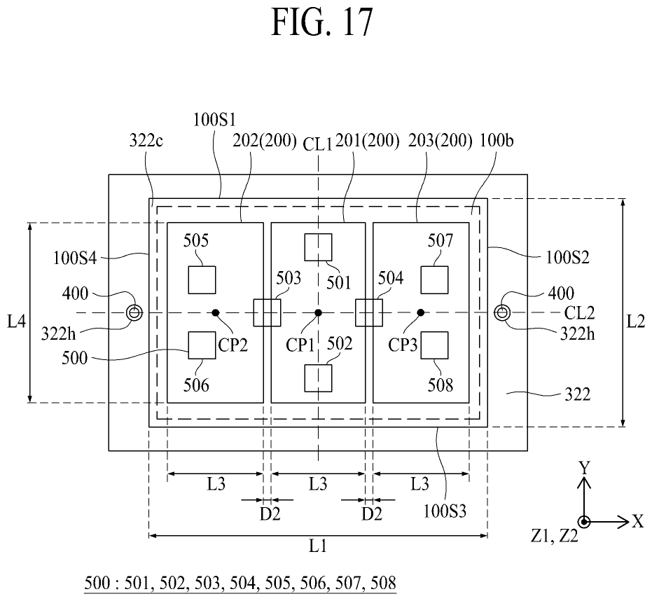

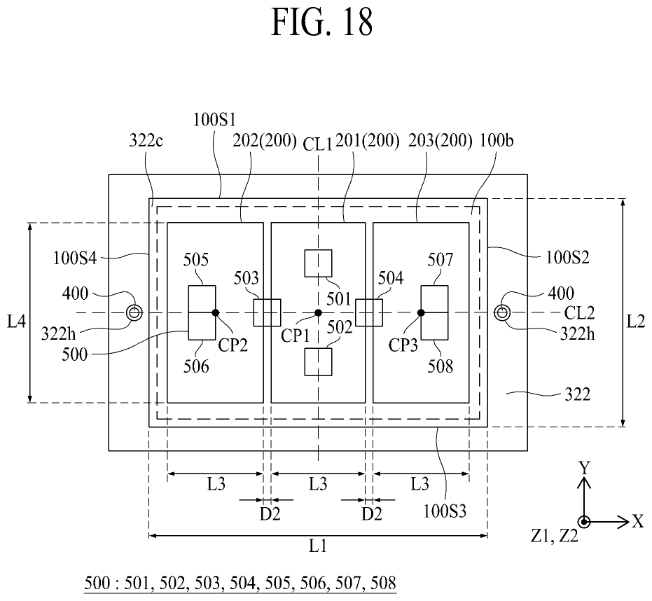

FIGS. 17 and 18 illustrate an acoustic apparatus according to another embodiment of the present disclosure. FIGS. 17 and 18 illustrate an embodiment where at least one weight member 500 is added to the vibration member 100 and the plurality of vibration apparatuses 200 illustrated in FIG. 16. Therefore, in the following description, the other elements except at least one weight member 500 and relevant elements are referred to by like reference numerals, and repeated descriptions thereof are omitted or will be briefly given.

Referring to FIGS. 17 and 18, an acoustic apparatus 10 according to another embodiment of the present disclosure can further include at least one weight member 500.

The at least one weight member 500 can be configured to increase a weight of a plurality of vibration apparatuses 200. For example, each of the plurality of vibration apparatuses 200 can include a contact surface contacting a vibration member 100 and an exposure surface opposite to the contact surface. The at least one weight member 500 can be disposed or configured at the exposure surface of each of the plurality of vibration apparatuses 200. The at least one weight member 500 can be disposed on the exposure surface of each of the plurality of vibration apparatuses 200, or can be disposed between adjacent vibration apparatuses 200 of the plurality of vibration apparatuses 200. The at least one weight member 500 can be disposed to be symmetrical with each other on the exposure surface of each of the plurality of vibration apparatuses 200 with respect to a center portion (or a first center line CL1 or a second center line CL2) of the vibration member 100.

The at least one weight member 500 can include a weight material having a weight, but embodiments of the present disclosure are not limited thereto. For example, the at least one weight member 500 can include one or more materials of stainless steel, Al, an Al alloy, titanium (Ti), or a Ti alloy, but embodiments of the present disclosure are not limited thereto. Other metals or materials other than metal can be used.

The at least one weight member 500 can increase a weight of the plurality of vibration apparatuses 200 to decrease a lowest resonance frequency (or a lowest natural frequency) of the vibration member 100. Therefore, as the lowest resonance frequency (or the lowest natural frequency) decreases due to an increase in weight caused by the at least one weight member 500, the plurality of vibration apparatuses 200 can vibrate at a relatively low frequency. Accordingly, a sound characteristic and/or a sound pressure level characteristic of a low-pitched sound band generated by a vibration of the vibration member 100 based on a vibration of each of the plurality of vibration apparatuses 200 can be enhanced. For example, the at least one weight member 500 can be a local mass, a point mass, a resonance pad, a weight pendulum, or a mass member, but embodiments of the present disclosure are not limited thereto.

The at least one weight member 500 can be disposed to be symmetrical with each other with respect to the first center line CL1 of the vibration member 100. The at least one weight member 500 can be disposed to overlap the second center line CL2 of the vibration member 100 or be symmetrical with each other with the second center line CL2 therebetween.

Referring to FIG. 17, at least one weight member 500 can include a plurality of weight members 501 to 508. For example, the plurality of weight members 501 to 508 can include a first weight member 501, a second weight member 502, a third weight member 503, a fourth weight member 504, a fifth weight member 505, a sixth weight member 506, a seventh weight member 507, and an eighth weight member 508.

The first and second weight members 501 and 502 can be disposed to be symmetrical with each other at an upper edge portion and a lower edge portion of a first vibration generator 201 with respect to a second center line CL2 of a vibration member 100.

The third and fourth weight members 503 and 504 can overlap the second center line CL2, or can be disposed between the first vibration generator 201 and a second vibration generator 202 or between the first vibration generator 201 and a third vibration generator 203. For example, the third weight member 503 can overlap the second center line CL2, or can be disposed between the first vibration generator 201 and the second vibration generator 202. For example, the fourth weight member 504 can overlap the second center line CL2, or can be disposed between the first vibration generator 201 and the third vibration generator 203.

The fifth to eighth weight members 505 to 508 can be disposed to be symmetrical with one another at an upper portion and a lower portion of each of the second vibration generator 202 and the third vibration generator 203 with respect to the second center line CL2 of the vibration member 100. For example, the fifth and sixth weight members 505 and 506 can be disposed to be symmetrical with each other at the upper portion and the lower portion of the second vibration generator 202 with respect to the second center line CL2 of the vibration member 100. For example, the seventh and eighth weight members 507 and 508 can be disposed to be symmetrical with each other at the upper portion and the lower portion of the third vibration generator 203 with respect to the second center line CL2 of the vibration member 100.

Referring to FIG. 18, at least one weight member 500 can include a plurality of weight members 501 to 508. For example, the plurality of weight members 501 to 508 can include a first weight member 501, a second weight member 502, a third weight member 503, a fourth weight member 504, a fifth weight member 505, a sixth weight member 506, a seventh weight member 507, and an eighth weight member 508.

The first and second weight members 501 and 502 can be disposed to be symmetrical with each other at an upper edge portion and a lower edge portion of a first vibration generator 201 with respect to a second center line CL2 of a vibration member 100.

The third and fourth weight members 503 and 504 can overlap the second center line CL2, or can be disposed between the first vibration generator 201 and a second vibration generator 202 or between the first vibration generator 201 and a third vibration generator 203. For example, the third weight member 503 can overlap the second center line CL2, or can be disposed between the first vibration generator 201 and the second vibration generator 202. For example, the fourth weight member 504 can overlap the second center line CL2, or can be disposed between the first vibration generator 201 and the third vibration generator 203.

The fifth to eighth weight members 505 to 508 can be disposed to be symmetrical with one another at an upper portion and a lower portion of a periphery of each of center portions C2 and CP3 of the second vibration generator 202 and the third vibration generator 203 with respect to the second center line CL2 of the vibration member 100. For example, the fifth and sixth weight members 505 and 506 can be disposed to be symmetrical with each other at the upper portion and the lower portion of the periphery of the center portion CP2 of the second vibration generator 202 with respect to the second center line CL2 of the vibration member 100. For example, the seventh and eighth weight members 507 and 508 can be disposed to be symmetrical with each other at the upper portion and the lower portion of the periphery of the center portion CP2 of the third vibration generator 203 with respect to the second center line CL2 of the vibration member 100. The at least one weight member 500 including the plurality of weight members 501 to 508 can have the same shape, different shapes or a combination of same and different shapes. If different, the shapes of the plurality of weight members 501 to 508 can be arranged to be symmetrical with one another with respect to the center point CP1, but embodiments of the present disclosure are not limited thereto. The shapes of the plurality of weight members 501 to 508 can include a square, rectangular, circle, oval, hemispherical, or polygonal shapes. But embodiments of the present disclosure are not limited thereto. the plurality of weight members 501 to 508

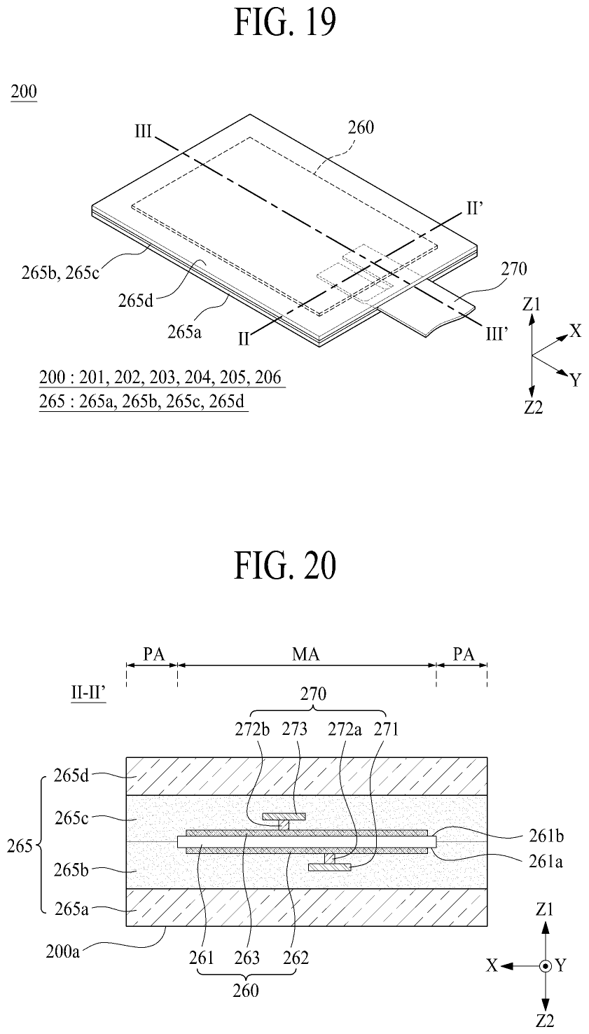

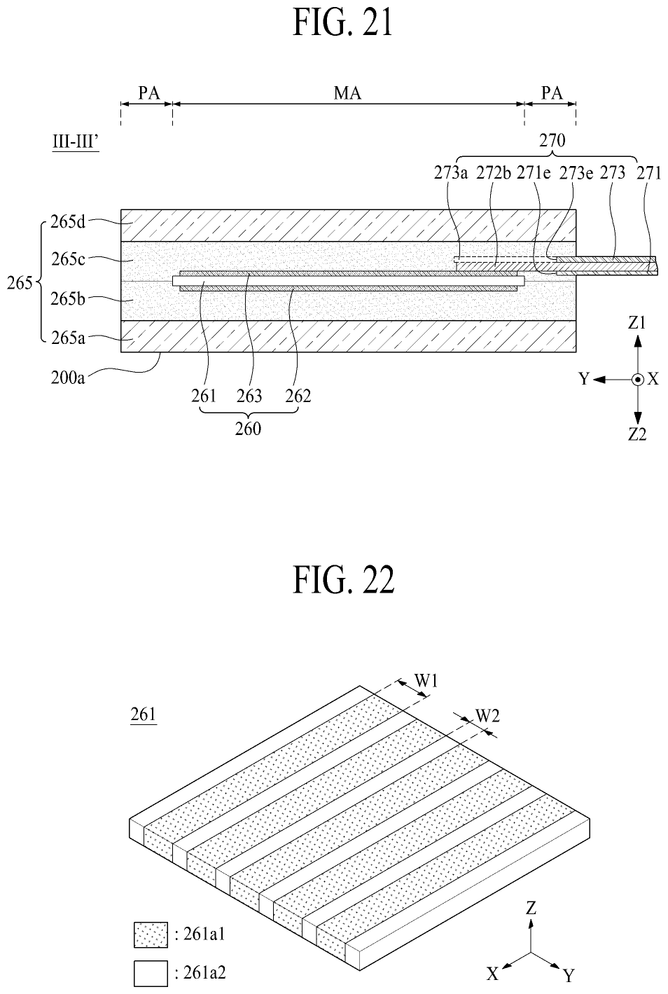

FIG. 19 illustrates a vibration apparatus 200 according to an embodiment of the present disclosure. FIG. 20 is a cross-sectional view taken along line II-II′ illustrated in FIG. 19 according to an embodiment of the present disclosure. FIG. 21 is a cross-sectional view taken along line III-III′ illustrated in FIG. 19 according to an embodiment of the present disclosure. FIGS. 19 to 21 illustrate the vibration apparatus described above with reference to FIGS. 1 to 18.

Referring to FIGS. 19 to 21, the vibration apparatus 200 can include a vibration portion 260. The vibration apparatus 200 can include first to sixth vibration generators 201 to 206. The first to sixth vibration generators 201 to 206 can each include the vibration portion 260.

The vibration portion 260 can be configured to vibrate with a piezoelectric effect based on a driving signal. The vibration portion 260 can include at least one of a piezoelectric inorganic material and a piezoelectric organic material. For example, the vibration portion 260 can be a vibration device, a piezoelectric device, a piezoelectric device portion, a piezoelectric device layer, a piezoelectric structure material, a piezoelectric vibration portion, or a piezoelectric vibration layer, but embodiments of the present disclosure are not limited thereto.

The vibration portion 260 according to an embodiment of the present disclosure can include a vibration layer 261, a first electrode layer 262, and a second electrode layer 263.

The vibration layer 261 can include a piezoelectric material or an electro active material having a piezoelectric effect. For example, the piezoelectric material can have a characteristic where pressure or twisting is applied to a crystalline structure by an external force, a potential difference occurs due to dielectric polarization caused by a relative position change of a positive (+) ion and a negative (−) ion, and a vibration is generated by an electric field based on a voltage applied thereto. For example, the vibration layer 261 can be referred to as a piezoelectric layer, a piezoelectric material layer, an electro active layer, a piezoelectric composite layer, a piezoelectric composite, or a piezoelectric ceramic composite, but embodiments of the present disclosure are not limited thereto.

The vibration layer 261 can include a ceramic-based material for implementing a relatively high vibration, or can include a piezoelectric ceramic having a perovskite-based crystalline structure. The perovskite crystalline structure can have a piezoelectric effect and an inverse piezoelectric effect, and can be a plate-shaped structure having orientation.

The piezoelectric ceramic can include single crystalline ceramic having a single crystalline structure, or can include polycrystalline ceramic or a ceramic material having a polycrystalline structure. A piezoelectric material of a single crystalline ceramic can include α-AlPO₄, α-SiO₂, LiNbO₃, Tb₂(MoO₄)₃, Li₂B₄O₇, or ZnO, but embodiments of the present disclosure are not limited thereto. A piezoelectric material of a polycrystalline ceramic can include a lead zirconate titanate (PZT)-based material including lead (Pb), zirconium (Zr), and titanium (Ti) or can include a lead zirconate nickel niobate (PZNN)-based material including lead (Pb), zinc (Zn), nickel (Ni), and niobium (Nb), but embodiments of the present disclosure are not limited thereto. For example, the vibration layer 261 can include at least one of CaTiO₃, BaTiO₃, and SrTiO₃ including no Pb, but embodiments of the present disclosure are not limited thereto.

The first electrode layer 262 can be disposed at a first surface (or a lower surface or a rear surface) 261a of the vibration layer 261. The first electrode layer 262 can have the same size as that of the vibration layer 261, or can have a size which is less than that of the vibration layer 261. At least one of the first electrode layer 262 and the second electrode layer 263 can have a shape different from that of the vibration layer 261, but embodiments of the present disclosure are not limited thereto.

The second electrode layer 263 can be disposed at a second surface (or an upper surface or a front surface) 261b which is different from or opposite to the first surface 261a of the vibration layer 261. The second electrode layer 263 can have substantially the same size as that of the vibration layer 261, or can have a size which is less than that of the vibration layer 261. For example, the second electrode layer 263 can have substantially the same size as that of the vibration layer 261, but embodiments of the present disclosure are not limited thereto.

According to an embodiment of the present disclosure, in order to prevent an electrical connection (or short circuit) between the first electrode layer 262 and the second electrode layer 263, each of the first electrode layer 262 and the second electrode layer 263 can be formed at the other portion, except an edge portion, of the vibration layer 261. For example, the first electrode layer 262 can be entirely formed at the other portion, except an edge portion, of the first surface 261a of the vibration layer 261. For example, the second electrode layer 263 can be entirely formed at the other portion, except an edge portion, of the second surface 261b of the vibration layer 261. For example, a distance between a lateral surface (or an outer sidewall) of each of the first electrode layer 262 and the second electrode layer 263 and a lateral surface (or an outer sidewall) of the vibration layer 261 can be at least 0.5 mm or more. For example, a distance between the lateral surface of each of the first electrode layer 262 and the second electrode layer 263 and the lateral surface of the vibration layer 261 can be at least 1 mm or more, but embodiments of the present disclosure are not limited thereto.

One or more of the first electrode layer 262 and the second electrode layer 263 according to an embodiment of the present disclosure can include a transparent conductive material, a semitransparent conductive material, or an opaque conductive material. For example, the transparent or semitransparent conductive material can include indium tin oxide (ITO) or indium zinc oxide (IZO), but embodiments of the present disclosure are not limited thereto. The opaque conductive material can include gold (Au), silver (Ag), platinum (Pt), palladium (Pd), molybdenum (Mo), magnesium (Mg), carbon, or Ag containing a glass frit, or can include an alloy thereof, but embodiments of the present disclosure are not limited thereto. For example, each of the first electrode layer 262 and the second electrode layer 263 can include Ag having a low resistivity, so as to enhance an electrical characteristic and/or a vibration characteristic of the vibration layer 261. For example, carbon can be a carbon material including graphite, carbon black, ketjen black, and carbon nanotube, but embodiments of the present disclosure are not limited thereto.

The vibration layer 261 can be polarized (or poling) by a certain voltage applied to the first electrode layer 262 and the second electrode layer 263 in a certain temperature atmosphere or a temperature atmosphere which is changed from a high temperature to a room temperature, but embodiments of the present disclosure are not limited thereto. For example, a polarization direction (or a poling direction) formed in the vibration layer 261 can be formed or aligned (or arranged) from the first electrode layer 262 to the second electrode layer 263, but is not limited thereto and can be formed or aligned (or arranged) from the second electrode layer 263 to the first electrode layer 262.

The vibration layer 261 can alternately and repeatedly contract or expand based on an inverse piezoelectric effect based on a driving signal applied from the outside to the first electrode layer 262 and the second electrode layer 263 by a driving circuit to vibrate. For example, the vibration layer 261 can vibrate in a vertical direction (or a thickness direction) and a plane direction, based on a signal applied to the first electrode layer 262 and the second electrode layer 263 by the driving circuit. The vibration layer 261 can be displaced (or vibrated or driven) based on plane-direction contraction and/or expansion, thereby enhancing a vibration characteristic including a sound characteristic and/or a sound pressure level characteristic of the vibration apparatus 200.

The vibration apparatus 200 according to an embodiment of the present disclosure can further include a cover member 265.

The cover member 265 can be configured to cover one or more of a first surface and a second surface of the vibration portion 260. The second surface of the vibration portion 260 can be a surface which is different from or opposite to the first surface of the vibration portion 260. The cover member 265 can be configured to protect one or more of the first surface and the second surface of the vibration portion 260. For example, the first surface of the vibration portion 260 can be a rear surface, a backside, or a lower surface. For example, the second surface of the vibration portion 260 can be a front surface or an upper surface, which is opposite to the first surface.

The cover member 265 according to an embodiment of the present disclosure can include a first cover member 265a.

The first cover member 265a can be disposed at the first surface of the vibration portion 260. For example, the first cover member 265a can be configured to cover the first electrode layer 262 of the vibration portion 260. For example, the first cover member 265a can be configured to have a size which is greater than that of the vibration portion 260. The first cover member 265a can be configured to protect the first surface of the vibration portion 260 and the first electrode layer 262.

The first cover member 265a according to an embodiment of the present disclosure can include an adhesive layer. For example, the first cover member 265a can include a base film and an adhesive layer which is on the base film and is connected with or coupled to the first surface of the vibration portion 260. For example, the adhesive layer can include an electrical insulating material which has adhesive properties and is capable of compression and decompression.

According to another embodiment of the present disclosure, the first cover member 265a can be connected with or coupled to the first surface of the vibration portion 260 by a first adhesive layer 265b. For example, the first cover member 265a can be connected with or coupled to the first surface of the vibration portion 260 or the first electrode layer 262 by the first adhesive layer 265b. For example, the first cover member 265a can be connected with or coupled to the first surface of the vibration portion 260 or the first electrode layer 262 by a film laminating process using the first adhesive layer 265b. The first adhesive layer 265b can be configured to surround all of the first surface of the vibration portion 260 and a portion of a lateral surface of the vibration portion 260.

The cover member 265 according to an embodiment of the present disclosure can include a second adhesive layer 265c.

The second cover member 265c can be disposed at the second surface of the vibration portion 260. For example, the second cover member 265c can be configured to cover the second electrode layer 263 of the vibration portion 260. The second cover member 265c can be configured to protect the second surface of the vibration portion 260 and the second electrode layer 263. The second adhesive layer 265c can be configured to surround all of the second surface of the vibration portion 260 and a portion of the lateral surface of the vibration portion 260. For example, the second adhesive layer 265c can be a protection layer or a protection member.

The second adhesive layer 265c can be connected with or coupled to the first adhesive layer 265b at the lateral surface of the vibration portion 260 or an edge portion of the first cover member 265a. Therefore, the first adhesive layer 265b and the second adhesive layer 265c can be configured to surround or fully surround the vibration portion 260. The first adhesive layer 265b and the second adhesive layer 265c can be configured to cover or surround all surfaces of the vibration portion 260. For example, the vibration portion 260 can be inserted (or accommodated) or buried (or embedded) into the adhesive layer including the first adhesive layer 265b and the second adhesive layer 265c.

The cover member 265 according to an embodiment of the present disclosure can include a second cover member 265d.

The second cover member 265d can be disposed at the second surface of the vibration portion 260. For example, the second cover member 265d can be configured to cover the second electrode layer 263 of the vibration portion 260. For example, the second cover member 265d can be configured to have a size which is greater than that of the vibration portion 260. The second cover member 265d can be configured to protect the second surface of the vibration portion 260 and the second electrode layer 263.

The cover member 265 according to an embodiment of the present disclosure can be connected with or coupled to the vibration member 100 by the connection member 150 illustrated in FIGS. 2 and 6 to 13. For example, one of the first cover member 265a, the first adhesive layer 265b, the second cover member 265d, and the second adhesive layer 265c can be connected with or coupled to the vibration member 100 by the connection member 150 illustrated in FIGS. 2 and 6 to 13. In the cover member 265 according to an embodiment of the present disclosure, the first cover member 265a and the second cover member 265d can be omitted, but embodiments of the present disclosure are not limited thereto.

The first cover member 265a and the second cover member 265d according to an embodiment of the present disclosure can include the same material or different materials. For example, each of the first cover member 265a and the second cover member 265d can be a polyimide film, a polyethylene terephthalate film, or a polyethylene naphthalate film, but embodiments of the present disclosure are not limited thereto.

The second cover member 265d can be connected with or coupled to the second surface of the vibration portion 260 or the second electrode layer 263 by the second adhesive layer 265c. For example, the second cover member 265d can be connected with or coupled to the second surface of the vibration portion 260 or the second electrode layer 263 by a film laminating process using the second adhesive layer 265c.

The vibration portion 260 can be disposed or inserted (or accommodated) between the first cover member 265a and the second cover member 265d. For example, the vibration portion 260 can be inserted (or accommodated) or buried (or embedded) into the adhesive layer including the first adhesive layer 265b and the second adhesive layer 265c.

The first adhesive layer 265b and the second adhesive layer 265c according to an embodiment of the present disclosure can include an electrical insulating material which has adhesive properties and is capable of compression and decompression. For example, the first adhesive layer 265b and the second adhesive layer 265c can include the same material or different materials. For example, each of the first adhesive layer 265b and the second adhesive layer 265c can include a thermos-plastic adhesive, a thermos-curable adhesive, epoxy resin, acrylic resin, silicone resin, urethane resin, a PSA, an OCA, or an OCR, but embodiments of the present disclosure are not limited thereto. For example, the first adhesive layer 265b and the second adhesive layer 265c can include the same material or different materials.

The first adhesive layer 265b and the second adhesive layer 265c can be provided between the first cover member 265a and the second cover member 265d to surround the vibration portion 260. For example, one or more of the first adhesive layer 265b and the second adhesive layer 265c can be configured to surround the vibration portion 260. For example, the second adhesive layer 265c can be provided as one body with the second cover member 265d and can thus be configured as one layer.

One of the first cover member 265a and the second cover member 265d can be connected with or coupled to the vibration member 100 by the connection member 150 illustrated in FIGS. 2 and 6 to 13.

The cover member 265 can include a center portion MA and a periphery portion (or an edge portion) PA. The center portion MA of the cover member 265 can cover the vibration portion 260. The periphery portion PA of the cover member 265 can surround the center portion MA. The center portion MA of the cover member 265 can be between adjacent periphery portions PA.

Referring to FIGS. 20 and 21, the vibration apparatus 200 can include the cover member 265. The cover member 265 can be configured to cover one or more of a first surface and a second surface of the vibration portion 260 of the vibration apparatus 200. The vibration apparatus 200 according to an embodiment of the present disclosure can further include a signal supply member 270.

The signal supply member 270 can be configured to supply a driving signal, supplied from the driving circuit, to the vibration portion 260. The signal supply member 270 can be electrically connected with the vibration portion 260. The signal supply member 270 can be electrically connected with the first electrode layer 262 and the second electrode layer 263.

A portion of the signal supply member 270 can be accommodated (or inserted) between the cover member 265 and the vibration portion 260. For example, a portion of the signal supply member 270 can be accommodated (or inserted) between the first cover member 265a and the first surface of the vibration portion 260. For example, a portion of the signal supply member 270 can be accommodated (or inserted) between the first cover member 265a and the second cover member 265d.

According to an embodiment of the present disclosure, an end portion (or a distal end portion or one side) of the signal supply member 270 can be disposed or inserted (or accommodated) between one edge portion (or one periphery portion) of the cover member 265 and the vibration portion 260. For example, the end portion (or the distal end portion or the one side) of the signal supply member 270 can be disposed or inserted (or accommodated) between one edge portion (or one periphery portion) of the first cover member 265a and the first surface of the vibration portion 260.

According to another embodiment of the present disclosure, the end portion (or the distal end portion or the one side) of the signal supply member 270 can be disposed or inserted (or accommodated) between one edge portion (or one periphery portion) of the first cover member 265a and one edge portion (or one periphery portion) of the second cover member 265d. For example, the one edge portion (or the one periphery portion) of the first cover member 265a and the one edge portion (or the one periphery portion) of the second cover member 265d can accommodate or vertically cover the end portion (or the distal end portion or the one side) of the signal supply member 270. Therefore, the signal supply member 270 can be provided as one body with the vibration apparatus 200. For example, the signal supply member 270 can be configured with a signal cable, a flexible cable, a flexible printed circuit cable, a flexible flat cable, a single-sided flexible printed circuit, a single-sided flexible printed circuit board (PCB), a flexible multi-layer printed circuit, or a flexible multi-layer PCB, but embodiments of the present disclosure are not limited thereto.

The signal supply member 270 according to an embodiment of the present disclosure can include a base member 271 and a plurality of signal lines 272a and 272b. For example, the signal supply member 270 can include the base member 271, a first signal line 272a, and a second signal line 272b.

The base member 271 can include a transparent or opaque plastic material, but embodiments of the present disclosure are not limited thereto. The base member 271 can have a certain width in a first direction X and can extend long in a second direction Y intersecting with the first direction X.

The first and second signal lines 272a and 272b can be disposed at a second surface of the base member 271 in parallel to the second direction Y and can be spaced apart from or electrically disconnected from each other in the first direction X. The first and second signal lines 272a and 272b can be disposed at the second surface of the base member 271 in parallel. For example, the first and second signal lines 272a and 272b can be implemented in a line shape, based on patterning of a metal layer (or a conductive layer) which is formed or deposited on the second surface of the base member 271.

End portions (or distal end portions or one sides) of the first and second signal lines 272a and 272b can be spaced apart from each other, and thus, can be individually curved or bent.

The end portion (or the distal end portion or the one side) of the first signal line 272a can be electrically connected with the first electrode layer 262 of the vibration portion 260. For example, the end portion of the first signal line 272a can be electrically connected with at least a portion of the first electrode layer 262 of the vibration portion 260 at one edge portion (or one periphery portion) of the first cover member 265a. For example, the end portion (or the distal end portion or the one side) of the first signal line 272a can be electrically and directly connected with at least a portion of the first electrode layer 262 of the vibration portion 260. For example, the end portion (or the distal end portion or the one side) of the first signal line 272a can be directly connected with or directly contact the first electrode layer 262 of the vibration portion 260. For example, the end portion of the first signal line 272a can be electrically connected with the first electrode layer 262 by a conductive double-sided tape. Accordingly, the first signal line 272a can supply a first driving signal, supplied from a vibration driver, to the first electrode layer 262 of the vibration portion 260.

The end portion (or the distal end portion or the one side) of the second signal line 272b can be electrically connected with the second electrode layer 263 of the vibration portion 260. For example, the end portion of the second signal line 272b can be electrically connected with at least a portion of the second electrode layer 263 of the vibration portion 260 at one edge portion (or one periphery portion) of the second cover member 265b. For example, the end portion (or the distal end portion or the one side) of the second signal line 272b can be electrically and directly connected with at least a portion of the second electrode layer 263 of the vibration portion 260. For example, the end portion (or the distal end portion or the one side) of the second signal line 272b can be directly connected with or directly contact the second electrode layer 263 of the vibration portion 260. For example, the end portion of the second signal line 272b can be electrically connected with the second electrode layer 263 by a conductive double-sided tape. Accordingly, the second signal line 272b can supply a first driving signal, supplied from a vibration driver, to the second electrode layer 263 of the vibration portion 260.

The signal supply member 270 according to an embodiment of the present disclosure can further include an insulation layer 273.

The insulation layer 253 can be disposed at the second surface of the base member 271 to cover each of the first signal line 272a and the second signal line 272b except the end portion (or the one side) of the signal supply member 270.

According to an embodiment of the present disclosure, an end portion (or one side) 273a of the insulation layer 273 and the end portion (or the one side) of the signal supply member 270 including the end portion (or the one side) of the base member 271 can be inserted (or accommodated) between the cover member 265 and the vibration portion 260 and can be fixed between the cover member 265d and the vibration portion 260 by the first adhesive layer 265b and the second adhesive layer 265c.

According to another embodiment of the present disclosure, the end portion (or the one side) 273a of the insulation layer 273 and the end portion (or the one side) of the signal supply member 270 including the end portion (or the one side) of the base member 271 can be inserted (or accommodated) between the first cover member 265a and the second cover member 265b and can be fixed between the first cover member 265a and the second cover member 265b by the first adhesive layer 265b and the second adhesive layer 265c. Therefore, an end portion (or one side) of the first signal line 272a can be maintained with being electrically connected with the first electrode layer 262 of the vibration portion 260, and an end portion (or one side) of the second signal line 272b can be maintained with being electrically connected with the second electrode layer 263 of the vibration portion 260. Further, the end portion (or the one side) of the signal supply member 270 can be inserted (or accommodated) between the first cover member 265a and the vibration portion 260, and thus, can prevent the occurrence of a connection defect between the vibration apparatus 200 and the signal supply member 270 caused by the movement of the signal supply member 270 in a process of inserting (or accommodating) the signal supply member 270 into a region between adjacent vibration apparatuses 200.

In the signal supply member 270 according to an embodiment of the present disclosure, each of the end portion (or the one side) of the base member 271 and the end portion (or the one side) 273a of the insulation layer 273 can be removed. For example, each of the end portion of the first signal line 272a and the end portion of the second signal line 272b may not be supported or covered by each of the end portion (or the one side) of the base member 271 and the end portion (or the one side) 273a of the insulation layer 273 and can be exposed at the outside. For example, the end portion of each of the first and second signal lines 272a and 272b can protrude (or extend) to have a certain length from an end 271e of the base member 271 or an end 273e of the insulation layer 273. Accordingly, each of the end portion (or the distal end portion or the one side) of each of the first and second signal lines 272a and 272b can be individually or independently bent.

The end portion (or the one side) of the first signal line 272a, which is not supported by each of the end portion (or the one side) of the base member 271 and the end portion (or the one side) 273a of the insulation layer 273, can be directly connected with or directly contact the first electrode layer 262 of the vibration portion 260. The end portion (or the one side) of the second signal line 272b, which is not supported by each of the end portion (or the one side) of the base member 271 and the end portion (or the one side) 273a of the insulation layer 273, can be directly connected with or directly contact the second electrode layer 263 of the vibration portion 260.

According to an embodiment of the present disclosure, a portion of the signal supply member 270 or a portion of the base member 271 can be disposed or inserted (or accommodated) between the cover member 265 and the vibration portion 260, and thus, the signal supply member 270 can be provided as one body with the vibration apparatus 200. For example, a portion of the signal supply member 270 or a portion of the base member 271 can be disposed or inserted (or accommodated) between the first cover member 265a and the second cover member 265d, and thus, the signal supply member 270 can be provided as one body with the vibration apparatus 200. Accordingly, the vibration apparatus 200 and the signal supply member 270 can be configured as one part, and thus, an effect of uni-materialization can be realized.

According to an embodiment of the present disclosure, because the first signal line 272a and the second signal line 272b of the signal supply member 270 are provided as one body with the vibration apparatus 200, a soldering process for an electrical connection between the vibration apparatus 200 and the signal supply member 270 may not be needed, and thus, a manufacturing process and a structure of the vibration apparatus 200 can be simplified, thereby decreasing a harmful process.

FIG. 22 illustrates a vibration portion according to another embodiment of the present disclosure. FIG. 22 illustrates another embodiment of the vibration portion described above with reference to FIGS. 19 to 21. Therefore, in the following description, repeated descriptions of the other elements except a vibration portion are omitted or will be briefly given.

Referring to FIGS. 20 and 22, a vibration portion 261 according to another embodiment of the present disclosure can include a plurality of first portions 261a1 and a plurality of second portions 261a2. For example, the plurality of first portions 261a1 and the plurality of second portions 261a2 can be alternately and repeatedly arranged in a first direction X (or a second direction Y).

Each of the plurality of first portions 261a1 can include an inorganic material having a piezoelectric effect (or a piezoelectric characteristic). For example, each of the plurality of first portions 261a1 can include one or more of a piezoelectric inorganic material and a piezoelectric organic material. For example, each of the plurality of first portions 261a1 can be an inorganic portion, an inorganic material portion, a piezoelectric portion, a piezoelectric material portion, or an electro active portion, but embodiments of the present disclosure are not limited thereto.

According to an embodiment of the present disclosure, each of the plurality of first portions 261a1 can have a first width W1 parallel to the first direction X (or the second direction Y) and can extend in the first direction X (or the second direction Y). Each of the plurality of first portions 261a1 can be substantially the same as the vibration layer 261 described above with reference to FIGS. 19 to 21, and thus, repeated descriptions thereof are omitted or will be briefly given.

Each of the plurality of second portions 261a2 can be disposed between the plurality of first portions 261a1. For example, each of the plurality of first portions 261a1 can be disposed between two adjacent second portions 261a2 of the plurality of second portions 261a2. Each of the plurality of second portions 261a2 can have a second width W2 parallel to the first direction X (or the second direction Y) and can extend in the second direction Y (or the first direction X). The first width W1 can be equal to or different from the second width W2. For example, the first width W1 can be greater than the second width W2. For example, the first portion 261a1 and the second portion 261a2 can include a line shape or a stripe shape, which has the same size or different sizes.

Each of the plurality of second portions 261a2 can be configured to fill a gap between two adjacent first portions 261a1. Each of the plurality of second portions 261a2 can be configured to fill a gap between two adjacent first portions 261a1, and thus, can be connected with or contact a lateral surface of an adjacent first portion 261a1.

According to an embodiment of the present disclosure, each of the plurality of first portions 261a1 and the plurality of second portions 261a2 can be disposed (or arranged) in parallel on the same plane (or the same layer). Accordingly, the vibration layer 261a can extend to have a desired size or length, based on lateral coupling (or connection) between the first portion 261a1 and the second portion 261a2.

According to an embodiment of the present disclosure, each of the plurality of second portions 261a2 can absorb an impact applied to the first portion 261a1 from the outside, and thus, the durability of the first portion 261a1 can be enhanced and flexibility can be provided to the vibration layer 261. Each of the plurality of second portions 261a2 can include an organic material having a ductile characteristic. For example, the plurality of second portions 261a2 can include one or more of an epoxy-based polymer, an acrylic polymer, and a silicone-based polymer, but embodiments of the present disclosure are not limited thereto. For example, each of the plurality of second portions 261a2 can be an organic portion, an organic material portion, an adhesive portion, a stretching portion, a bending portion, a damping portion, or a ductile portion, but embodiments of the present disclosure are not limited thereto.

A first surface of each of the plurality of first portions 261a1 and the plurality of second portions 261a2 can be connected with the first electrode portion 262 in common. A second surface of each of the plurality of first portions 261a1 and the plurality of second portions 261a2 can be connected with the second electrode portion 263 in common. As another example, one or all of the first electrode portion 262 and the second electrode portion 263 can be formed as a pattern-shaped electrode to correspond to only the plurality of first portions 261a1.

According to another embodiment of the present disclosure, the plurality of first portions 261a1 and the plurality of second portions 261a2 can be disposed (or connected) on the same plane, and thus, the vibration layer 261 can have a single thin film form. Accordingly, the vibration portion 260 (or the vibration apparatus 200) including the vibration layer 261 according to another embodiment of the present disclosure can be vibrated by the first portion 261a1 having a vibration characteristic and can be bent in a curved shape by the second portion 261a2 having flexibility.

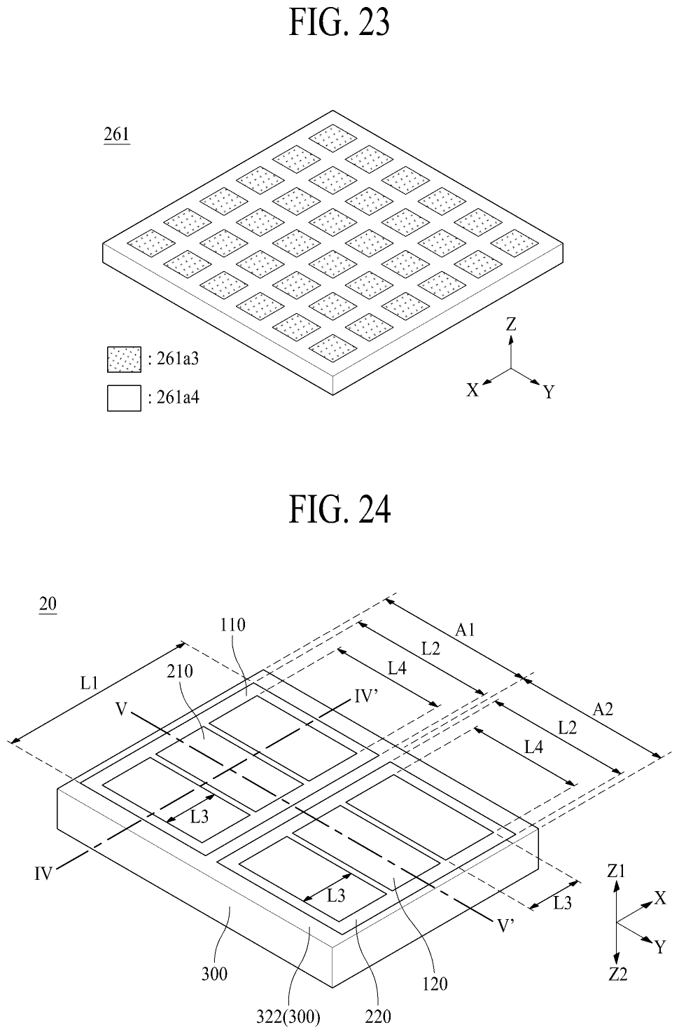

FIG. 23 illustrates a vibration portion 261 according to another embodiment of the present disclosure. FIG. 23 illustrates another embodiment of the vibration layer described above with reference to FIGS. 19 to 21.

Referring to FIGS. 20 and 23, the vibration portion 261 according to another embodiment of the present disclosure can include a plurality of first portions 261a3 and a second portion 261a4 disposed between the plurality of first portions 261a3.

The plurality of first portions 261a3 can be arranged to be spaced apart from one another in each of a first direction X and a second direction Y. For example, the plurality of first portions 261a3 can have a hexahedral shape having the same size and can be arranged in a lattice shape, but embodiments of the present disclosure are not limited thereto. For example, each of the plurality of first portions 261a3 can have a circular plate shape, an oval plate shape, or a polygonal plate shape, but embodiments of the present disclosure are not limited thereto.

Each of the plurality of first portions 261a3 can be substantially the same as the vibration layer 261 described above with reference to FIG. 22, and thus, repeated descriptions thereof are omitted.

The second portion 261a4 can be disposed between the plurality of first portions 261a3 in each of the first direction X and the second direction Y. The second portion 261a4 can be configured to fill a gap between two adjacent first portions 261a3 or surround each of the plurality of first portions 261a3, and thus, can be connected with or contact an adjacent first portion 261a3. The second portion 261a4 can be substantially the same as the second portion 261a2 described above with reference to FIG. 22, and thus, repeated descriptions thereof are omitted.

A first surface of each of the plurality of first portions 261a3 and the second portion 261a4 can be connected with the first electrode layer 261b in common. A second surface of each of the plurality of first portions 261a3 and the second portion 261a4 can be connected with the second electrode layer 261c in common.

According to another embodiment of the present disclosure, the plurality of first portions 261a3 and the second portion 261a4 can be disposed (or connected) on the same plane, and thus, the vibration layer 261 can have a single thin film form. Accordingly, the vibration portion 260 (or the vibration apparatus 200) including the vibration layer 261 according to another embodiment of the present disclosure can be vibrated by the first portion 261a3 having a vibration characteristic and can be bent in a curved shape by the second portion 261a4 having flexibility.

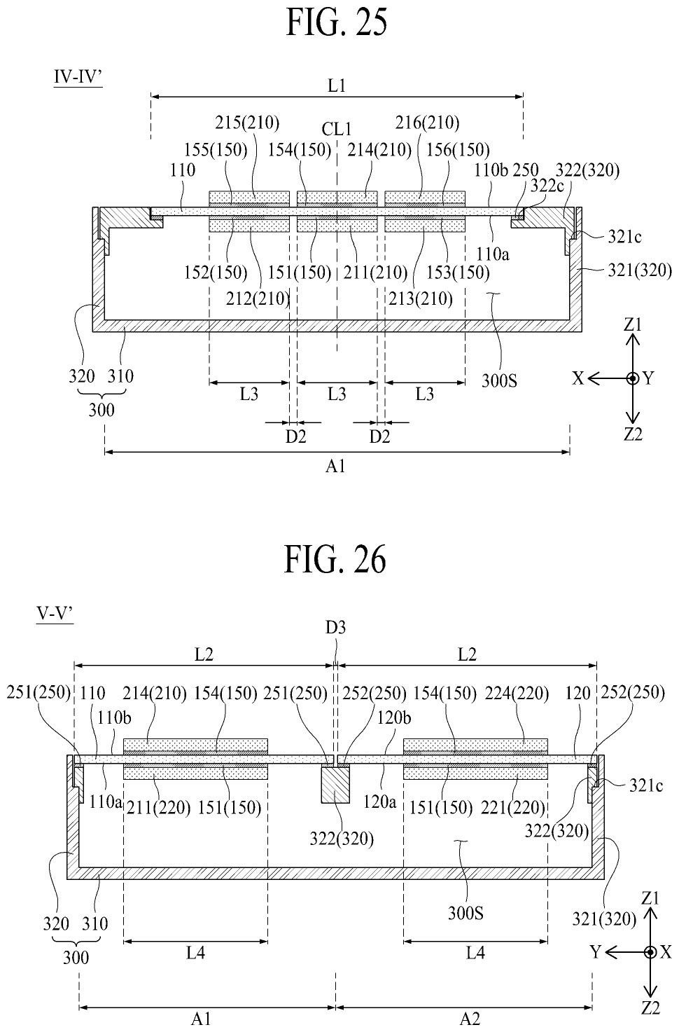

FIG. 24 illustrates an acoustic apparatus 20 according to another embodiment of the present disclosure. FIG. 25 is a cross-sectional view taken along line IV-IV′ illustrated in FIG. 24 according to another embodiment of the present disclosure. FIG. 26 is a cross-sectional view taken along line V-V′ illustrated in FIG. 24 according to another embodiment of the present disclosure.

Referring to FIGS. 24 to 26, the acoustic apparatus 20 according to another embodiment of the present disclosure can implement or configure a sound output apparatus, a sound generating apparatus, a sound bar, an acoustic system, an acoustic apparatus for electronic devices, an acoustic apparatus for displays, an acoustic apparatus for vehicular apparatuses, or a sound bar for vehicular apparatuses. For example, the vehicular apparatus can include a vehicle, a train, a ship, or an aircraft, but embodiments of the present disclosure are not limited thereto. The acoustic apparatus 10 according to an embodiment of the present disclosure can be configured to be transparent, semitransparent, or opaque.

The acoustic apparatus 20 according to another embodiment of the present disclosure can include a first vibration member 110, a second vibration member 120, a first vibration apparatus 210, a second vibration apparatus 220, and a housing 300.

Each of the first vibration member 110 and the second vibration member 120 can generate a vibration or can output a sound (or a sound wave), based on displacements (or driving) of the first vibration apparatus 210 and the second vibration apparatus 220. Each of the first vibration member 110 and the second vibration member 120 can be a vibration object, a passive vibration plate, a vibration panel, a sound plate, a sound panel, a passive vibration panel, a sound output plate, or a sound vibration plate, but embodiments of the present disclosure are not limited thereto. For example, the first vibration member 110 and the second vibration member 120 can be substantially the same as the vibration member 100 described above with reference to FIGS. 1 and 2, and thus, repeated descriptions thereof are omitted.

The first vibration member 110 and the second vibration member 120 can be parallel to a first direction X parallel to a first length L1 direction of each of the first vibration member 110 and the second vibration member 120 and can be arranged to be spaced apart from each other in a second direction Y parallel to a second length L2 direction of each of the first vibration member 110 and the second vibration member 120. For example, the first vibration member 110 and the second vibration member 120 can be disposed to be spaced apart from each other by a third distance D3. The first vibration member 110 and the second vibration member 120 can be disposed to be spaced apart from each other by a third distance D3 in the second direction Y. For example, the first vibration member 110 and the second vibration member 120 can be configured to be spaced apart from each other without overlapping each other, but embodiments of the present disclosure are not limited thereto.

The first vibration apparatus 210 and the second vibration apparatus 220 can be configured to respectively vibrate the first vibration member 110 and the second vibration member 120. The first vibration apparatus 210 and the second vibration apparatus 220 can be respectively disposed or configured in the first vibration member 110 and the second vibration member 120. For example, the first vibration apparatus 210 can be disposed or configured in the first vibration member 110. The second vibration apparatus 220 can be disposed or configured in the second vibration member 120.

Each of the first vibration apparatus 210 and the second vibration apparatus 220 can be disposed or configured on at least one surface of each of the first vibration member 110 and the second vibration member 120. For example, the first vibration apparatus 210 and the second vibration apparatus 220 can be respectively disposed or configured at first surfaces 110a and 120a (or rear surfaces) of the first vibration member 110 and the second vibration member 120. Alternatively, the first vibration apparatus 210 and the second vibration apparatus 220 can be respectively disposed or configured at second surfaces 110b and 120b (or front surfaces) of the first vibration member 110 and the second vibration member 120. Alternatively, each of the first vibration apparatus 210 and the second vibration apparatus 220 can be provided as one or more, and the one or more first vibration apparatus 210 and the one or more second vibration apparatus 220 can be respectively disposed or configured at the first surfaces 110a and 120a (or the rear surfaces) and the second surfaces 110b and 120b (or the front surfaces) of the first vibration member 110 and the second vibration member 120. The first vibration apparatus 210 and the second vibration apparatus 220 can vibrate based on a driving signal (or a vibration driving signal or a voice signal) applied from a driving circuit to vibrate (or displace or drive) the first vibration member 110 and the second vibration member 120. For example, each of the first vibration apparatus 210 and the second vibration apparatus 220 can be an active vibration member, a vibration generator, a vibration structure material, a vibrator, a vibration generating device, a sound generator, a sound device, a sound generating structure material, or a sound generating device, but embodiments of the present disclosure are not limited thereto. For example, the first vibration apparatus 210 and the second vibration apparatus 220 can be substantially the same as the vibration apparatus 200 described above with reference to FIGS. 1 and 2, and thus, repeated descriptions thereof are omitted.

Referring to FIG. 25, in the acoustic apparatus 20 according to another embodiment of the present disclosure, each of the first vibration apparatus 210 and the second vibration apparatus 220 can include a plurality of vibration apparatuses. FIG. 25 illustrates only a configuration of the first vibration apparatus 210 of the first vibration apparatus 210 and the second vibration apparatus 220 but can be substantially the same as a configuration of the second vibration apparatus 220, and thus, the drawing and description of a configuration of the second vibration apparatus 220 are omitted.

The first vibration apparatus 210 of the first vibration apparatus 210 and the second vibration apparatus 220 can include a plurality of first vibration apparatuses 211 to 216.

The plurality of first vibration apparatuses 211 to 216 can be disposed or configured to overlap one another at each of the first surface 110a (or the rear surface) and the second surface 110b (or the front surface) of the first vibration member 110. For example, the plurality of first vibration apparatuses 211 to 216 can include a first vibration generator 211, a second vibration generator 212, a third vibration generator 213, a fourth vibration generator 214, a fifth vibration generator 215, and a sixth vibration generator 216. For example, the plurality of first vibration apparatuses 211 to 216 can be substantially the same as the plurality of first vibration apparatuses 201 to 206 described above with reference to FIGS. 5 and 8, and thus, repeated descriptions thereof are omitted.

Referring to FIGS. 24 to 26, the acoustic apparatus 20 according to another embodiment of the present disclosure can further include the housing 300 disposed at a rear surface of each of the first vibration member 110 and the second vibration member 120.

The housing 300 according to another embodiment of the present disclosure can include a first area A1 and a second area A2. For example, the housing 300 can include the first area A1 and the second area A2, which are parallel to the first direction X and are adjacent to each other in the second direction Y.

The first vibration member 110 and the second vibration member 120 can be respectively disposed or configured in the first area A1 and the second area A2 of the housing 300. For example, the first vibration member 110 can be disposed or configured in the first area A1 of the housing 300. The second vibration member 120 can be disposed or configured in the second area A2 of the housing 300.

The housing 300 can be configured or disposed at the first surface 110a (or the rear surface) of the first vibration member 110 and the first surface 120a (or the rear surface) of the second vibration member 120. For example, the first area A1 of the housing 300 can be configured or disposed at the first surface 110a (or the rear surface) of the first vibration member 110. The second area A2 of the housing 300 can be configured or disposed at the first surface 120a (or the rear surface) of the second vibration member 120. The housing 300 can be configured or disposed to cover the first surface 110a (or the rear surface) of the first vibration member 110 and the first surface 120a (or the rear surface) of the second vibration member 120. For example, the first area A1 of the housing 300 can be configured or disposed to cover the first surface 110a (or the rear surface) of the first vibration member 110. The second area A2 of the housing 300 can be configured or disposed to cover the first surface 120a (or the rear surface) of the second vibration member 120. The housing 300 can be configured to support an edge portion (or a periphery portion) of each of the first surface 110a (or the rear surface) of the first vibration member 110 and the first surface 120a (or the rear surface) of the second vibration member 120.

The housing 300 according to an embodiment of the present disclosure can include an internal space 300S which surrounds the first surface 110a (or the rear surface) of the first vibration member 110 and the first surface 120a (or the rear surface) of the second vibration member 120. For example, the housing 300 can include the internal space 300S which surrounds the first surface 110a (or the rear surface) of the first vibration member 110 and the first surface 120a (or the rear surface) of the second vibration member 120 in common. For example, the housing 300 can be configured to include the internal space 300S and can be connected with (or coupled to) the first surface 110a of the first vibration member 110 and the first surface 120a of the second vibration member 120. For example, the acoustic apparatus 20 according to one or more embodiments of the present disclosure can include the internal space 300S which is provided in a region between the housing 300 and the first and second vibration members 110 and 120. For example, the acoustic apparatus 20 according to one or more embodiments of the present disclosure can include the internal space 300S which is provided in a region between the housing 300 and the first surfaces 110a and 120a of the first and second vibration members 110 and 120. For example, the housing 300 can include a box shape where one side (or an upper side) is opened, so as to provide the internal space 300S. For example, the housing 300 can be an enclosure, a case, an outer case, a case member, a housing member, a cabinet, a sealing member, a sealing cap, a sealing box, or a sound box, but embodiments of the present disclosure are not limited thereto. For example, the acoustic apparatus 20 or the internal space 300S of the housing 300 can be an accommodating space, a receiving space, a gap space, an air space, a vibration space, a sound space, a sounding cylinder, or a sealing space, but embodiments of the present disclosure are not limited thereto. For example, the housing 300 can be substantially the same as the housing 300 described above with reference to FIGS. 1 and 2, and thus, repeated descriptions thereof are omitted.

The housing 300 according to an embodiment of the present disclosure can include a bottom portion 310 and a supporting portion 320. The supporting portion 320 can include a first supporting portion 321 and a second supporting portion 322.

The bottom portion 310 can be configured (or disposed) in parallel to the first vibration member 110 and the second vibration member 120. The bottom portion 310 can be configured (or disposed) in parallel to the first vibration member 110 and the second vibration member 120 with the first vibration apparatus 210 and the second vibration apparatus 220 therebetween. The bottom portion 310 can be disposed to face the first surfaces 110a and 120a (or the rear surfaces) of the first vibration member 110 and the second vibration member 120. The bottom portion 310 can be disposed to cover the first surfaces 110a and 120a (or the rear surfaces) of the first and second vibration members 110 and 120 and the first and second vibration apparatuses 210 and 220. The bottom portion 310 can be spaced apart from the first surfaces 110a and 120a of the first and second vibration members 110 and 120. The bottom portion 310 can be configured (or disposed) in parallel to the first and second vibration members 110 and 120 with the internal space 300S therebetween. The bottom portion 310 can be disposed to face the first surfaces 110a and 120a of the first and second vibration members 110 and 120 with the internal space 300S therebetween. For example, the bottom portion 310 can be spaced apart from the first surfaces 110a and 120a of the first and second vibration members 110 and 120 with the internal space 300S therebetween. For example, the bottom portion 310 can be a bottom plate, a supporting plate, a housing plate, a housing bottom portion, an enclosure plate, or an enclosure bottom portion, but embodiments of the present disclosure are not limited thereto.

The supporting portion 320 can be configured to support the edge portions (or the periphery portions) of the first vibration member 110 and the second vibration member 120. The supporting portion 320 can be configured or disposed at the edge portions (or the periphery portions) of the first vibration member 110 and the second vibration member 120. The supporting portion 320 can include the first supporting portion 321 and the second supporting portion 322.

The first supporting portion 321 can be connected with an edge portion (or a periphery portion) of the bottom portion 310. For example, the first supporting portion 321 can be connected with the bottom portion 310 and can protrude vertically from the bottom portion 310 to surround the first area A1 and the second area A2 of the housing 300. The first supporting portion 321 can include a structure which is bent from the edge portion (or the periphery portion) of the bottom portion 310. For example, the first supporting portion 321 can be parallel with the vertical direction (Z1, Z2) perpendicular to the ground. For example, the first supporting portion 321 can be connected with the edge portion (or the periphery portion) of the bottom portion 310 and can protrude vertically from the bottom portion 310 to surround the first vibration member 110 and the second vibration member 120. For example, the first supporting portion 321 can include a coupling portion 321c coupled to the second supporting portion 322. For example, the housing 300 can include four first supporting portions 321 connected with one another. For example, the first supporting portion 321 can be a lateral portion, a sidewall, a supporting sidewall, a housing lateral surface, a housing sidewall, an enclosure lateral surface, or an enclosure sidewall, but embodiments of the present disclosure are not limited thereto. For example, the first supporting portion 321 can have a tetragonal frame or tetragonal band shape.

The second supporting portion 322 can be configured to support edge portions (or periphery portions) of the first vibration member 110 and the second vibration member 120. The second supporting portion 322 can connect the first supporting portion 321 with the first vibration member 110 and the second vibration member 120. For example, the second supporting portion 322 can be connected with the first supporting portion 321 in parallel to the bottom portion 310 and can be configured to support the edge portion (or the periphery portion) of each of the first vibration member 110 and the second vibration member 120. The second supporting portion 322 can be connected with the first supporting portion 321 in parallel to the bottom portion 310 and can be configured to support the edge portion (or the periphery portion) of each of the first vibration member 110 and the second vibration member 120. For example, the second supporting portion 322 can be configured to support the edge portion (or the periphery portion) of each of the first vibration member 110 and the second vibration member 120 adjacent to each other. The second supporting portion 322 can be configured to surround the first vibration member 110 and the second vibration member 120 and support the edge portions (or the periphery portions) of the first vibration member 110 and the second vibration member 120.

The second supporting portion 322 can be coupled or fastened to the coupling portion 321c of the first supporting portion 321. The second supporting portion 322 can be connected with the first supporting portion 321 and can be configured to protrude from the first supporting portion 321 in a horizontal direction (the first direction X and/or the second direction Y) toward the first vibration member 110 and the second vibration member 120. For example, the second supporting portion 322 can be connected with the first supporting portion 321 and can be configured to protrude from the first supporting portion 321 in the first direction X parallel to a first length L1 direction of the first vibration member 110 and the second vibration member 120. The second supporting portion 322 can be connected with the first supporting portion 321 and can be configured to protrude from the first supporting portion 321 in the second direction Y parallel to a second length L2 direction of the first vibration member 110 and the second vibration member 120. For example, the second supporting portion 322 can be configured so that a portion thereof protruding in the first direction X is longer than a portion thereof protruding in the second direction Y, but embodiments of the present disclosure are not limited thereto.

The second supporting portion 322 can include a groove portion 322c coupled to the first vibration member 110 and the second vibration member 120. The second supporting portion 322 can surround the first vibration member 110 and the second vibration member 120 and can include a 8-shaped double tetragonal band or 8-shaped double tetragonal ring shape surrounded by the first supporting portion 321, but embodiments of the present disclosure are not limited thereto. For example, the second supporting portion 322 can have a shape corresponding to a shape of the first vibration member 110 and the second vibration member 120. At least a portion of each of the first surfaces 110a and 120b (the rear surfaces) of the edges (or the peripheries) of the first vibration member 110 and the second vibration member 120 can be accommodated into the groove 322c of the second supporting portion 322. For example, the groove 322c of the second supporting portion 322 can accommodate at least a portion of each of the first surfaces 110a and 120b (the rear surfaces) of the edges (or the peripheries) and lateral surfaces of the first vibration member 110 and the second vibration member 120 and can support the edges (or the peripheries) of the first vibration member 110 and the second vibration member 120.

The second supporting portion 322 of the housing 300 can be connected with or coupled to the first vibration member 110 and the second vibration member 120 by a coupling member 250. The coupling member 250 can include a first coupling member 251 and a second coupling member 252. The first vibration member 110 can be connected with or coupled to the second supporting portion 322 by the first coupling member 251. The first coupling member 251 can be disposed between the groove portion 322c of the second supporting portion 322 and an edge (or a periphery) of the first surface 110a (or the rear surface) of the first vibration member 110. The second vibration member 120 can be connected with or coupled to the second supporting portion 322 by the second coupling member 252. The second coupling member 252 can be disposed between the groove portion 322c of the second supporting portion 322 and an edge (or a periphery) of the first surface 120a (or the rear surface) of the second vibration member 120.

In the acoustic apparatus 20 according to another embodiment of the present disclosure, the first vibration member 110 and the first vibration apparatus 210 provided in the first vibration member 110 and the second vibration member 120 and the second vibration apparatus 220 provided in the second vibration member 120 can be disposed adjacent to each other in parallel and can generate (or output) sounds, based on vibrations of the first vibration member 110 and the second vibration member 120, and thus, a sound characteristic and/or a sound pressure level characteristic of a low-pitched sound band can be enhanced. The acoustic apparatus 20 according to another embodiment of the present disclosure can be configured in a fastening structure where the first supporting portion 321 and the second supporting portion 322 are not provided as one body, and moreover, the transfer of vibrations of the first and second vibration members 110 and 120 to the housing 300 can be minimized or prevented.

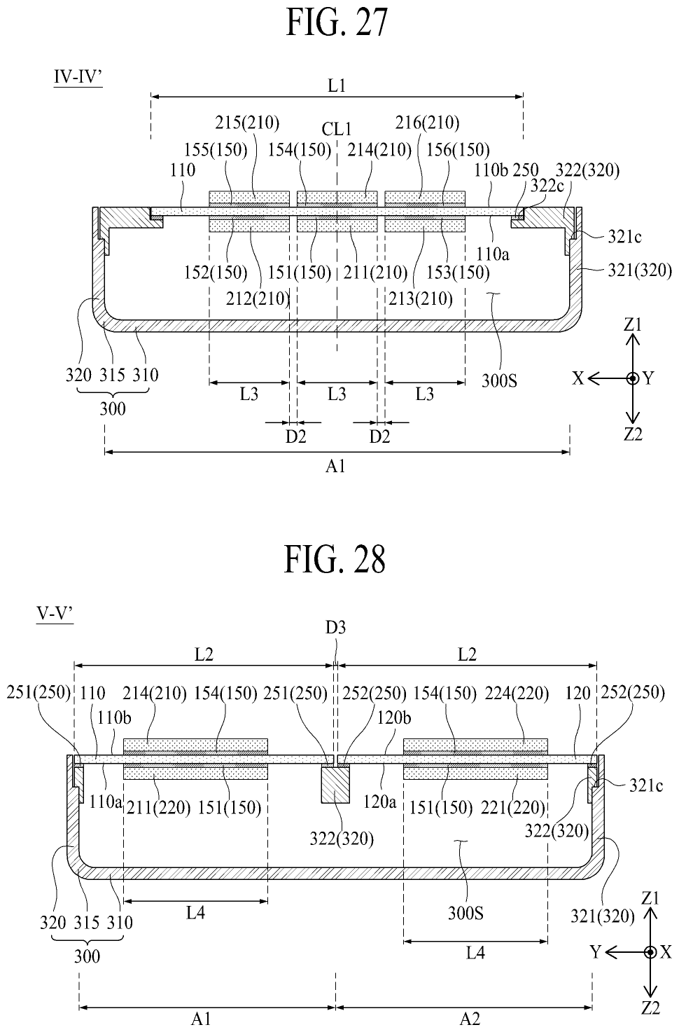

FIG. 27 is a cross-sectional view taken along line IV-IV′ illustrated in FIG. 24 according to another embodiment of the present disclosure. FIG. 28 is a cross-sectional view taken along line V-V′ illustrated in FIG. 24 according to another embodiment of the present disclosure. FIGS. 27 and 28 illustrate an embodiment implemented by modifying a configuration of the housing 300 in the acoustic apparatus 20 described above with reference to FIGS. 24 to 26. Therefore, in the following description, the other elements except a modified configuration of a housing 300 and relevant elements are referred to by like reference numerals, and repeated descriptions thereof are omitted or will be briefly given.

Referring to FIGS. 27 and 28, the housing 300 according to another embodiment of the present disclosure can include a first area A1 and a second area A2. For example, the housing 300 can include the first area A1 and the second area A2, which are parallel to the first direction X and are adjacent to each other in the second direction Y. A first vibration member 110 can be configured in the first area A1 of the housing 300, and a second vibration member 110 can be configured in the second area A2 of the housing 300.

The housing 300 can include a bottom portion 310 and a supporting portion 320. The supporting portion 320 can include a first supporting portion 321 and a second supporting portion 322. The housing 300 can further include a curved portion 315 provided between the bottom portion 310 and the first supporting portion 321. The curved portion 315 can be provided at a connection portion between the bottom portion 310 and the first supporting portion 321. For example, the curved portion 315 can be configured in a curved structure which has a certain curvature radius between the bottom portion 310 and the first supporting portion 321. For example, the curved portion 315 can be substantially the same as the curved portion 315 described above with reference to FIG. 15, and thus, repeated descriptions thereof are omitted.

The acoustic apparatus 20 according to another embodiment of the present disclosure can be configured in a fastening structure where the first vibration member 110 and the first vibration apparatus 210 provided in the first vibration member 110 and the second vibration member 120 and the second vibration apparatus 220 provided in the second vibration member 120 are disposed adjacent to each other in parallel, and the first supporting portion 321 and the second supporting portion 322 are not provided as one body, and can include the curved portion 315 configured in a curved structure which has a certain curvature radius between the first supporting portion 321 and the second supporting portion 322, and thus, can generate (or output) sounds, based on vibrations of the first vibration member 110 and the second vibration member 120. Accordingly, a sound characteristic and/or a sound pressure level characteristic of a low-pitched sound band can be enhanced, a reduction in sound pressure level characteristic caused by a standing wave which occurs due to interference of a progressive wave and a reflected wave can be minimized or prevented, and the transfer of vibrations of the first and second vibration members 110 and 120 to the housing 300 can be minimized or prevented.

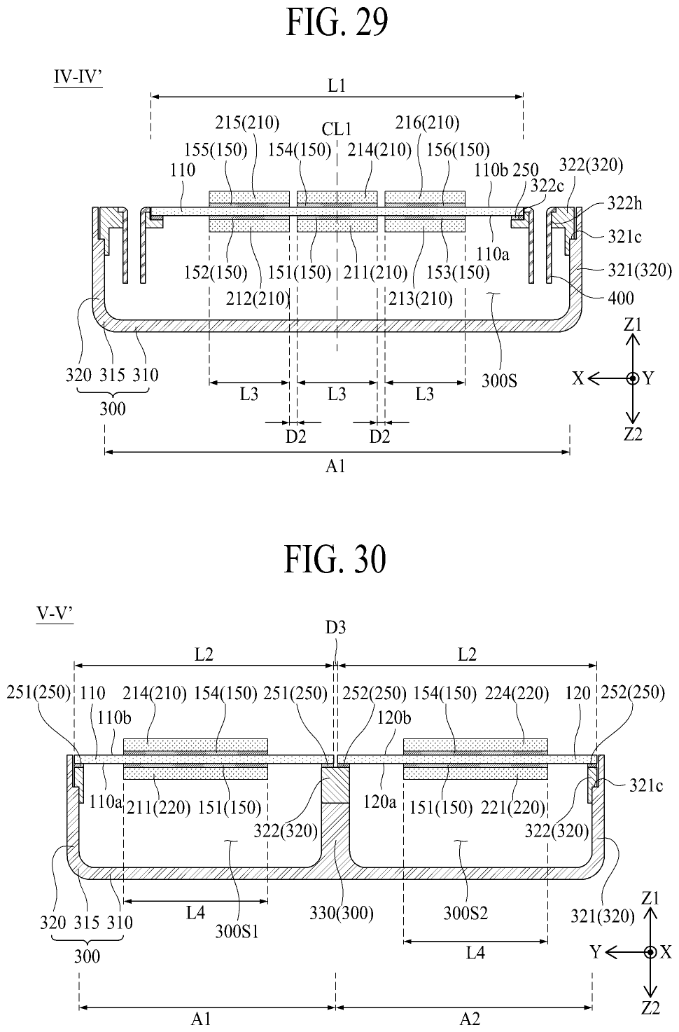

FIG. 29 is a cross-sectional view taken along line IV-IV′ illustrated in FIG. 24 according to another embodiment of the present disclosure. FIG. 29 illustrates an embodiment where a duct portion 400 is added to the housing 300 in the acoustic apparatus 20 described above with reference to FIGS. 24 to 28. Therefore, in the following description, the other elements except a duct portion 400 and relevant elements are referred to by like reference numerals, and repeated descriptions thereof are omitted or will be briefly given.

Referring to FIG. 29, the housing 300 according to another embodiment of the present disclosure can include a first area A1 and a second area A2. For example, the housing 300 can include the first area A1 and the second area A2, which are parallel to the first direction X and are adjacent to each other in the second direction Y. A first vibration member 110 can be configured in the first area A1 of the housing 300, and a second vibration member 110 can be configured in the second area A2 of the housing 300.

The housing 300 can include a bottom portion 310, a supporting portion 320, and a duct portion 400. The supporting portion 320 can include a first supporting portion 321 and a second supporting portion 322. The housing 300 can further include the duct portion 400 in the second supporting portion 322. The duct portion 400 can be configured to connect an internal space 300S of the housing 300 with the outside. For example, the duct portion 400 can be substantially the same as the duct portion 400 described above with reference to FIG. 12, and thus, repeated descriptions thereof are omitted.

The acoustic apparatus 20 according to another embodiment of the present disclosure can be configured in a fastening structure where the first vibration member 110 and the first vibration apparatus 210 provided in the first vibration member 110 and the second vibration member 120 and the second vibration apparatus 220 provided in the second vibration member 120 are disposed adjacent to each other in parallel, and the first supporting portion 321 and the second supporting portion 322 are not provided as one body, and can include the duct portion 400 in the second supporting portion 322 at peripheries of both edges of each of the first and second vibration members 110 and 120 in a first length L1 direction of the first and second vibration members 110 and 120, and thus, can generate (or output) sounds, based on vibrations of the first vibration member 110 and the second vibration member 120. Therefore, the acoustic apparatus 20 can enhance a sound characteristic and/or a sound pressure level characteristic of a low-pitched sound band and can invert a phase of a sound wave radiated into the internal space 300S of the housing 300 to output a phase-inverted sound wave to the outside through the duct portion 400. Accordingly, a band of the low-pitched sound band can extend, and thus, a sound characteristic and/or a sound pressure level characteristic of the low-pitched sound band can be improved and the transfer of vibrations of the first and second vibration members 110 and 120 to the housing 300 can be minimized or prevented.

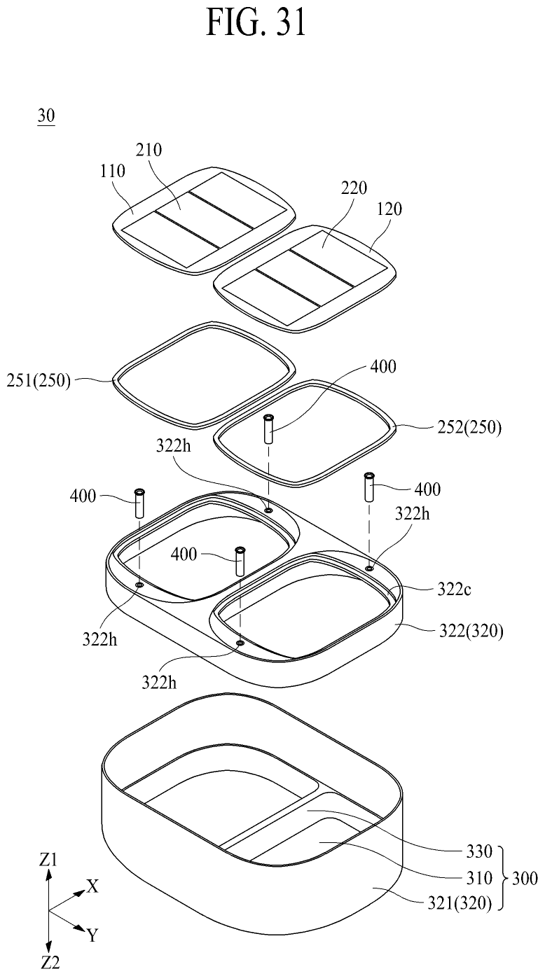

FIG. 30 is a cross-sectional view taken along line V-V′ illustrated in FIG. 24 according to another embodiment of the present disclosure. FIG. 30 illustrates an embodiment where a third supporting portion 330 is added to the housing 300 in the acoustic apparatus 20 described above with reference to FIGS. 24 to 29. Therefore, in the following description, the other elements except a third supporting portion 330 and relevant elements are referred to by like reference numerals, and repeated descriptions thereof are omitted or will be briefly given.

Referring to FIG. 30, the housing 300 according to another embodiment of the present disclosure can include a first area A1 and a second area A2. For example, the housing 300 can include the first area A1 and the second area A2, which are parallel to the first direction X and are adjacent to each other in the second direction Y. A first vibration member 110 can be configured in the first area A1 of the housing 300, and a second vibration member 110 can be configured in the second area A2 of the housing 300.

The housing 300 can include a bottom portion 310 and a supporting portion 320. The supporting portion 320 can include a first supporting portion 321 and a second supporting portion 322. The housing 300 can further include a third supporting portion 330 provided between the first area A1 and the second area A2 of the housing 300. The third supporting portion 330 can be disposed or configured between the bottom portion 310 and the second supporting portion 322. For example, the third supporting portion 330 can be divided into the first area A1 and the second area A2 of the housing 300. For example, the third supporting portion 330 can be configured in a partition wall structure where the first area A1 and the second area A2 of the housing 300 are spatially separated from each other.

The third supporting portion 330 can be configured in the partition wall structure where the third supporting portion 330 protrudes vertically from the bottom portion 310 and separates or spatially separates the first area A1 and the second area A2. For example, the third supporting portion 330 can divide the internal space 300S, provided between the first and second vibration members 110 and 120 and the housing 300, into the first area A1 and the second area A2. The third supporting portion 330 can provide a first internal space 300S1 in the first area A1 of the housing 300 and can provide a second internal space 300S2 in the second area A2 of the housing 300. For example, the third supporting portion 330 can divide the internal space 300S1 of the first area A1 and the internal space 300S2 of the second area A2.

The third supporting portion 330 can be disposed or configured in parallel to a first direction X parallel to a first length L1 direction of the first and second vibration members 110 and 120. The third supporting portion 330 can be disposed or configured between adjacent first supporting portions 321 arranged in a second direction Y parallel to a second length L2 direction of the first and second vibration members 110 and 120. For example, the third supporting portion 330 can be disposed at a center between adjacent first supporting portions 321 disposed at both sides in the second direction Y and can connect adjacent first supporting portions 321 disposed at both sides in the first direction X, with each other.

The acoustic apparatus 20 according to another embodiment of the present disclosure can be configured in a fastening structure where the first vibration member 110 and the first vibration apparatus 210 provided in the first vibration member 110 and the second vibration member 120 and the second vibration apparatus 220 provided in the second vibration member 120 are disposed adjacent to each other in parallel, and the first supporting portion 321 and the second supporting portion 322 are not provided as one body, can include the duct portion 400 in the second supporting portion 322 at peripheries of both edges of each of the first and second vibration members 110 and 120 in a first length L1 direction of the first and second vibration members 110 and 120, and can include the third supporting portions 330 which separates or spatially separates the first area A1 and the second area A2 of the housing 300, and thus, can generate (or output) sounds, based on vibrations of the first vibration member 110 and the second vibration member 120. Therefore, the acoustic apparatus 20 can enhance a sound characteristic and/or a sound pressure level characteristic of a low-pitched sound band and can invert a phase of a sound wave radiated into the internal space 300S of the housing 300 to output a phase-inverted sound wave to the outside through the duct portion 400. Accordingly, a band of the low-pitched sound band can extend, and thus, a sound characteristic and/or a sound pressure level characteristic of the low-pitched sound band can be improved and the transfer of vibrations of the first and second vibration members 110 and 120 to the housing 300 can be minimized or prevented. Further, the acoustic apparatus 20 can separate vibrations (or sounds) respectively generated in the first and second vibration members 110 and 120, or can minimize or prevent mutual interference therebetween.

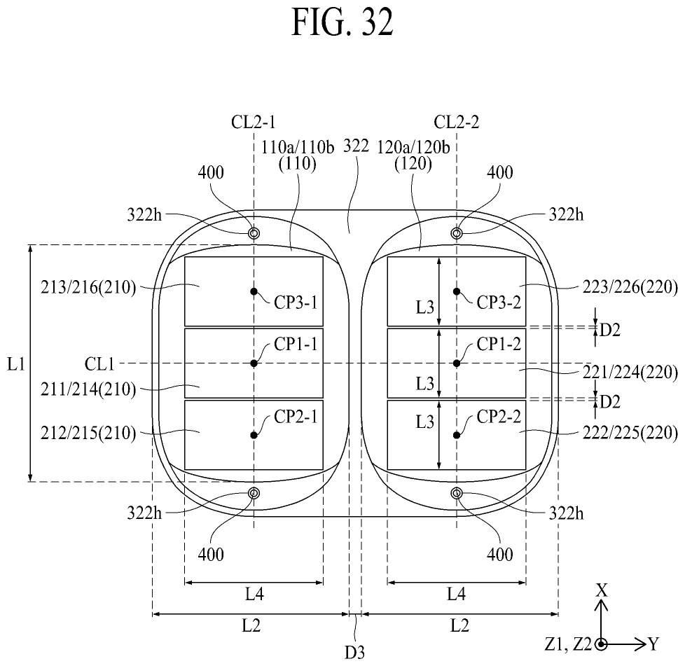

FIG. 31 is an exploded perspective view illustrating an acoustic apparatus according to another embodiment of the present disclosure. FIG. 32 illustrates an acoustic apparatus according to another embodiment of the present disclosure.

Referring to FIGS. 31 and 32, an acoustic apparatus 30 according to another embodiment of the present disclosure can include a first vibration member 110, a second vibration member 120, a first vibration apparatus 210 configured in the first vibration member 110, a second vibration apparatus 220 configured in the second vibration member 120, and a housing 300,

Each of the first vibration member 110 and the second vibration member 120 can include a round-polygonal shape which has a long axis (or a long side) in a first direction X and has a short axis (or a short side) in a second direction Y. For example, each of the first vibration member 110 and the second vibration member 120 can have a curved shape (or a round shape) where at least a pair of sides facing each other have a certain curvature radius, or can have a shape having a curved shape (or a round shape) where at least a pair of corner portions with one side therebetween have a certain curvature radius, but embodiments of the present disclosure are not limited thereto. For example, the first vibration member 110 and the second vibration member 120 can be substantially the same as the first vibration member 110 and the second vibration member 120 described above with reference to FIGS. 24 to 30, and thus, repeated descriptions thereof are omitted.

The first vibration apparatus 210 and the second vibration apparatus 220 can be configured to respectively vibrate the first vibration member 110 and the second vibration member 120. The first vibration apparatus 210 and the second vibration apparatus 220 can be respectively disposed or configured in the first vibration member 110 and the second vibration member 120. The first vibration apparatus 210 and the second vibration apparatus 220 can be respectively disposed or configured on at least one surface of the first vibration member 110 and at least one surface of the second vibration member 120. For example, the first vibration apparatus 210 and the second vibration apparatus 220 can be respectively disposed at a front surface or a rear surface of the first vibration member 110 and a front surface or a rear surface of the second vibration member 120, or can be disposed or configured at the front surface and the rear surface. Each of the first vibration apparatus 210 and the second vibration apparatus 220 can include a plurality of vibration apparatuses. For example, the first vibration apparatus 210 and the second vibration apparatus 220 can be substantially the same as the first vibration apparatus 210 and the second vibration apparatus 220 described above with reference to FIGS. 24 to 30, and thus, repeated descriptions thereof are omitted.

The housing 300 can be configured to disposed to cover rear surfaces of the first vibration member 110 and the second vibration member 120. The housing 300 can include a bottom portion 310, a supporting portion 320, and a duct portion 400. The supporting portion 320 of the housing 300 can include a first supporting portion 321 and a second supporting portion 322. The housing 300 can further include a third supporting portion 330 provided between the first area A1 and the second area A2 of the housing 300. The first supporting portion 321 and the second supporting portion 322 of the housing 300 can have a shape corresponding to a shape of the first and second vibration members 110 and 120. The second supporting portion 322 of the housing 300 can include a groove portion 322c into which the first and second vibration members 110 and 120 are accommodated. The second supporting portion 322 of the housing 300 can include a hole 322h into which the duct portion 400 is inserted (or fixed to). The duct portion 400 can be disposed in the hole 322h of the second supporting portion 322. For example, the housing 300 can be substantially the same as the housing 300 described above with reference to FIGS. 24 to 30, and thus, repeated descriptions thereof are omitted.

A first coupling member 251 and a second coupling member 252 can be configured to connect or couple the first vibration member 110 and the second vibration member 120 with the housing 300. The first vibration member 110 can be connected with or coupled to the second supporting portion 322 by the first coupling member 251. The first coupling member 251 can be disposed between the groove portion 322c of the second supporting portion 322 and an edge (or a periphery) of a first surface 110a (or a rear surface) of the first vibration member 110. The second vibration member 120 can be connected with or coupled to the second supporting portion 322 by the second coupling member 252. The second coupling member 252 can be disposed between the groove portion 322c of the second supporting portion 322 and an edge (or a periphery) of a first surface 120a (or a rear surface) of the second vibration member 120. For example, the first and second coupling members 251 and 252 can be substantially the same as the coupling member 250 described above with reference to FIGS. 1 and 2, and thus, repeated descriptions thereof are omitted.

Referring to FIG. 32, each of the first vibration member 110 and the second vibration member 120 can be configured to be supported by the second supporting portion 322 of the housing 300. The second supporting portion 322 can surround the first vibration member 110 and the second vibration member 120 and can include a 8-shaped double round-tetragonal band or 8-shaped double round-tetragonal ring shape surrounded by the first supporting portion 321, but embodiments of the present disclosure are not limited thereto. Each of the first vibration member 110 and the second vibration member 120 can be accommodated into and supported by the groove portion 322c of the second supporting portion 322.

Each of the first vibration member 110 and the second vibration member 120 can include a round-polygonal shape which has a long axis (or a long side) in the first direction X and has a short axis (or a short side) in the second direction Y. For example, each of the first vibration member 110 and the second vibration member 120 can have a curved shape (or a round shape) where at least a pair of sides facing each other have a certain curvature radius, or can have a shape having a curved shape (or a round shape) where at least a pair of corner portions with one side therebetween have a certain curvature radius, but embodiments of the present disclosure are not limited thereto.

The first vibration member 110 and the second vibration member 120 can be parallel to the first direction X parallel to a first length L1 direction of each of the first vibration member 110 and the second vibration member 120 and can be arranged to be spaced apart from each other in the second direction Y parallel to a second length L2 direction of each of the first vibration member 110 and the second vibration member 120. For example, the first vibration member 110 and the second vibration member 120 can be disposed to be spaced apart from each other by a third distance D3. The first vibration member 110 and the second vibration member 120 can be disposed to be spaced apart from each other by a third distance D3 in the second direction Y.

In first surfaces 110a and 120a or second surfaces 110b and 120b of the first vibration member 110 and the second vibration member 120, a first center line CL1 can be parallel to the second direction Y and can be disposed at a center between both edge ends of the first and second vibration members 110 and 120 in the first direction X. In the first surfaces 110a or the second surfaces 110b of the first vibration member 110, a second center line CL2-1 can be parallel to the first direction X and can be disposed at a center between both edge ends of the first vibration member 110 in the second direction Y. For example, a center portion of the first vibration member 110 can be a portion or a point at which the first center line CL1 intersects with the second center line CL2-1. In the first surfaces 120a or the second surfaces 120b of the second vibration member 120, a second center line CL2-2 can be parallel to the first direction X and can be disposed at a center between both edge ends of the second vibration member 120 in the second direction Y. For example, a center portion of the second vibration member 120 can be a portion or a point at which the first center line CL1 intersects with the second center line CL2-2.

The first vibration apparatus 210 and the second vibration apparatus 220 can be respectively disposed or configured on at least one surface of the first vibration member 110 and at least one surface of the second vibration member 120. For example, the first vibration apparatus 210 and the second vibration apparatus 220 can be respectively disposed at the second surfaces (or the front surfaces) 110b and 120b or the first surfaces (or the rear surfaces) 110a and 120a of the first vibration member 110 and the second vibration member 120, or can be disposed or configured at the second surfaces (or the front surfaces) 110b and 120b or the first surfaces (or the rear surfaces) 110a and 120a.

Each of the first vibration apparatus 210 and the second vibration apparatus 220 can include a plurality of vibration apparatuses. The first vibration apparatus 210 can include a plurality of first vibration apparatuses 211 to 216. For example, the plurality of first vibration apparatuses 211 to 216 can include a first vibration generator 211, a second vibration generator 212, a third vibration generator 213, a fourth vibration generator 214, a fifth vibration generator 215, and a sixth vibration generator 216. The second vibration apparatus 220 can include a plurality of second vibration apparatuses 221 to 226. For example, the plurality of second vibration apparatuses 221 to 226 can include a first vibration generator 221, a second vibration generator 222, a third vibration generator 223, a fourth vibration generator 224, a fifth vibration generator 225, and a sixth vibration generator 226.

The plurality of first vibration apparatuses 211 to 216 can be configured to vibrate the first vibration member 110. For example, the plurality of first vibration apparatuses 211 to 216 can be disposed or configured to overlap one another at the first surface 110a (or the rear surface) and the second surface 110b (or the rear surface) of the first vibration member 110.

Each of the plurality of first vibration apparatuses 211 to 216 can include a tetragonal shape or a rectangular shape, which has a third length L3 parallel to the first direction X and a fourth length L4 parallel to the second direction Y. For example, each of the plurality of first vibration apparatuses 211 to 216 can include a tetragonal shape or a rectangular shape, where the fourth length L4 parallel to the second direction Y is longer than the third length L3 parallel to the first direction X.

First to third vibration generators 211 to 213 among the plurality of first vibration apparatuses 211 to 216 can be disposed at the first surface 110a of the first vibration member 110.

The first to third vibration generators 211 to 213 can be arranged to be spaced apart from one another in the first direction X parallel to a first length L1 direction of the first vibration member 110, at the first surface 110a of the first vibration member 110. For example, the first to third vibration generators 211 to 213 can be arranged to be spaced apart from one another by a second distance D2 in the first direction X, at the first surface 110a of the first vibration member 110.

The first to third vibration generators 211 to 213 can be disposed to be symmetrical with one another with respect to the first center line CL1, at the first surface 110a of the first vibration member 110. For example, the first to third vibration generators 211 to 213 can overlap the second center line CL2-1 and can be disposed to be symmetrical with one another with respect to the first center line CL1, at the first surface 110a of the first vibration member 110. For example, the first vibration generator 211 can overlap the first center line CL1. A center portion CP1-1 of the first vibration generator 211 can be a portion or a point at which the first center line CL1 intersects with the second center line CL2. For example, the second and third vibration generators 212 and 213 can be disposed to be symmetrical with each other with the first vibration generator 211 therebetween. For example, in the second vibration generator 212, a center portion CP2-1 of the second vibration generator 212 can overlap the second center line CL2-1 and can be disposed in a left region with respect to the first vibration generator 211. For example, in the third vibration generator 213, a center portion CP3-1 of the third vibration generator 213 can overlap the second center line CL2-1 and can be disposed in a right region with respect to the first vibration generator 211.

Fourth to sixth vibration generators 214 to 216 among the plurality of first vibration apparatuses 211 to 216 can be disposed at the first surface 110a of the first vibration member 110.

The fourth to sixth vibration generators 214 to 216 can be arranged to be spaced apart from one another in the first direction X parallel to the first length L1 direction of the first vibration member 110, at the second surface 110b of the first vibration member 110. For example, the fourth to sixth vibration generators 214 to 216 can be arranged to be spaced apart from one another by the second distance D2 in the first direction X, at the second surface 110b of the first vibration member 110.

The fourth to sixth vibration generators 214 to 216 can be disposed to be symmetrical with one another with respect to the first center line CL1, at the first surface 110a of the first vibration member 110. For example, the fourth to sixth vibration generators 214 to 216 can overlap the second center line CL2-1 and can be disposed to be symmetrical with one another with respect to the first center line CL1, at the second surface 110b of the first vibration member 110. For example, the fourth vibration generator 214 can overlap the first center line CL1. A center portion CP1-1 of the fourth vibration generator 214 can be a portion or a point at which the first center line CL1 intersects with the second center line CL2. For example, the fifth and sixth vibration generators 215 and 216 can be disposed to be symmetrical with each other with the fourth vibration generator 214 therebetween. For example, in the fifth vibration generator 215, a center portion CP2-1 of the fifth vibration generator 215 can overlap the second center line CL2-1 and can be disposed in a left region with respect to the fourth vibration generator 214. For example, in the sixth vibration generator 216, a center portion CP3-1 of the sixth vibration generator 216 can overlap the second center line CL2-1 and can be disposed in a right region with respect to the fourth vibration generator 214.

The plurality of second vibration apparatuses 221 to 226 can be configured to vibrate the first vibration member 110. For example, the plurality of first vibration apparatuses 221 to 226 can be disposed or configured to overlap one another at the first surface 120a (or the rear surface) and the second surface 120b (or the rear surface) of the second vibration member 120.

Each of the plurality of second vibration apparatuses 221 to 226 can include a tetragonal shape or a rectangular shape, which has the third length L3 parallel to the first direction X and the fourth length L4 parallel to the second direction Y. For example, each of the plurality of second vibration apparatuses 221 to 226 can include a tetragonal shape or a rectangular shape, where the fourth length L4 parallel to the second direction Y is longer than the third length L3 parallel to the first direction X.

First to third vibration generators 221 to 223 among the plurality of second vibration apparatuses 221 to 226 can be disposed at the first surface 120a of the second vibration member 120.

The first to third vibration generators 221 to 223 can be arranged to be spaced apart from one another in the first direction X parallel to a first length L1 direction of the second vibration member 120, at the first surface 120a of the second vibration member 120. For example, the first to third vibration generators 221 to 223 can be arranged to be spaced apart from one another by the second distance D2 in the first direction X, at the first surface 120a of the second vibration member 120.

The first to third vibration generators 221 to 223 can be disposed to be symmetrical with one another with respect to the first center line CL1, at the first surface 120a of the second vibration member 120. For example, the first to third vibration generators 221 to 223 can overlap a second center line CL2-2 and can be disposed to be symmetrical with one another with respect to the first center line CL1, at the first surface 120a of the second vibration member 120. For example, the first vibration generator 221 can overlap the first center line CL1. A center portion CP1-2 of the first vibration generator 221 can be a portion or a point at which the first center line CL1 intersects with the second center line CL2-2. For example, the second and third vibration generators 222 and 223 can be disposed to be symmetrical with each other with the first vibration generator 221 therebetween. For example, in the second vibration generator 222, a center portion CP2-2 of the second vibration generator 222 can overlap the second center line CL2-2 and can be disposed in a left region with respect to the first vibration generator 221. For example, in the third vibration generator 223, a center portion CP3-2 of the third vibration generator 223 can overlap the second center line CL2-2 and can be disposed in a right region with respect to the first vibration generator 221.

Fourth to sixth vibration generators 224 to 226 among the plurality of second vibration apparatuses 221 to 226 can be disposed at the first surface 120a of the second vibration member 120.

The fourth to sixth vibration generators 224 to 226 can be arranged to be spaced apart from one another in the first direction X parallel to the first length L1 direction of the second vibration member 120, at the second surface 120b of the second vibration member 120. For example, the fourth to sixth vibration generators 224 to 226 can be arranged to be spaced apart from one another by the second distance D2 in the first direction X, at the second surface 120b of the second vibration member 120.

The fourth to sixth vibration generators 224 to 226 can be disposed to be symmetrical with one another with respect to the first center line CL1, at the second surface 120b of the second vibration member 120. For example, the fourth to sixth vibration generators 224 to 226 can overlap the second center line CL2-2 and can be disposed to be symmetrical with one another with respect to the first center line CL1, at the second surface 120b of the second vibration member 120. For example, the fourth vibration generator 224 can overlap the first center line CL1. A center portion CP1-2 of the fourth vibration generator 224 can be a portion or a point at which the first center line CL1 intersects with the second center line CL2-2. For example, the fifth and sixth vibration generators 225 and 226 can be disposed to be symmetrical with each other with the fourth vibration generator 224 therebetween. For example, in the fifth vibration generator 225, a center portion CP2-2 of the fifth vibration generator 225 can overlap the second center line CL2-2 and can be disposed in a left region with respect to the fourth vibration generator 224. For example, in the sixth vibration generator 226, a center portion CP3-2 of the sixth vibration generator 226 can overlap the second center line CL2-2 and can be disposed in a right region with respect to the fourth vibration generator 224.

The duct portion 400 can be disposed in a hole 322h which is provided in the second supporting portion 322. The duct portion 400 can be disposed at a periphery of each of the first vibration member 110 and the second vibration member 120. The duct portion 400 can be disposed at peripheries of both edges of the first vibration member 110 in the first direction X parallel to the first length L1 direction of the first vibration member 110. For example, the duct portion 400 can be disposed in the hole 322h provided at peripheries of the both edges of the first vibration member 110 in the first direction X. For example, the duct portion 400 can be disposed to overlap the second center line CL2-1 of the first vibration member 110. The duct portion 400 can be disposed at peripheries of both edges of the first vibration member 110 in the first direction X parallel to the first length L1 direction of the second vibration member 120. For example, the duct portion 400 can be disposed in the hole 322h provided at peripheries of the both edges of the second vibration member 120 in the first direction X. For example, the duct portion 400 can be disposed to overlap the second center line CL2-2 of the second vibration member 120.

The acoustic apparatus 30 according to another embodiment of the present disclosure can have substantially the same effect as the acoustic apparatuses 10 and 20 described above with reference to FIGS. 1 to 30. Because the first and second vibration members 110 and 120 and the housing 300 include a curved shape (or a round shape) or a curve shape, the acoustic apparatus 30 according to another embodiment of the present disclosure can disperse the reflection of a sound wave generated from the first and second vibration apparatuses 210 and 220, and thus, can minimize or prevent interference and/or overlapping of a progressive wave and a reflected wave and can reduce a peak or dip phenomenon of a sound characteristic caused by a standing wave, thereby enhancing a flatness characteristic of a sound pressure level. The peak can be a phenomenon where a sound pressure level bounces in a specific frequency, and the dip can be a phenomenon where a low sound pressure level is generated as the occurrence of a sound having a specific frequency is prevented. The flatness of a sound pressure level can be a difference between a highest sound pressure level and a lowest sound pressure level in a specific frequency.

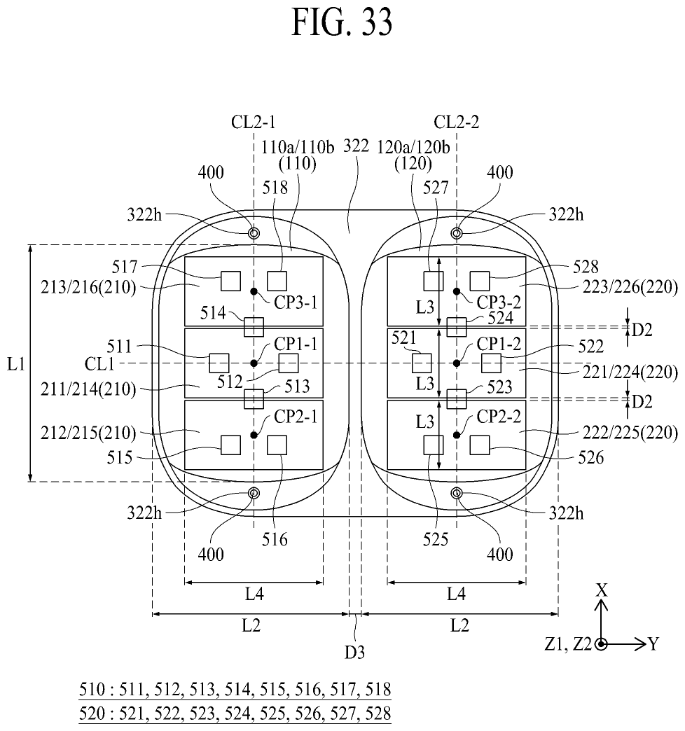

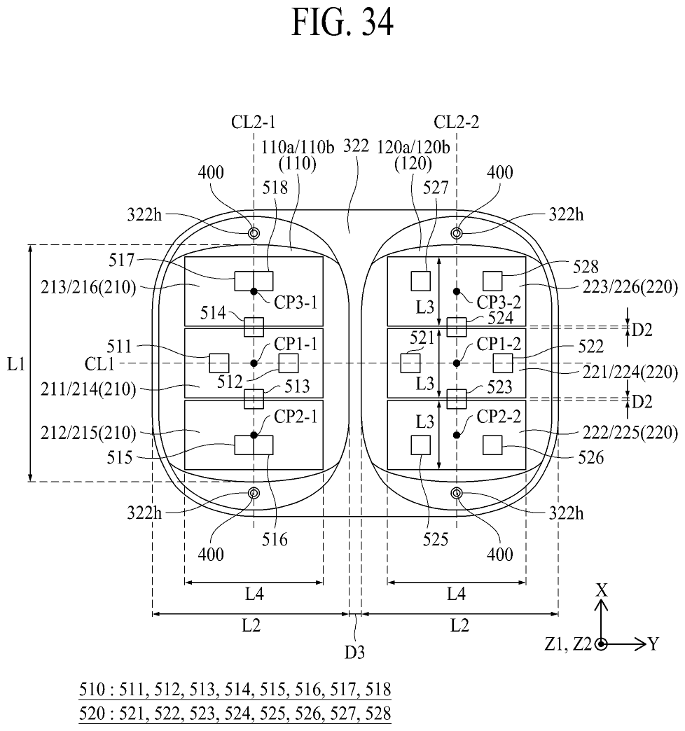

FIGS. 33 and 34 illustrate an acoustic apparatus according to another embodiment of the present disclosure. FIGS. 33 and 34 illustrate an embodiment where at least one first and second weight members 510 and 520 are added to the acoustic apparatus 30 described above with reference to FIGS. 31 and 32. Therefore, in the following description, the other elements except at least one first and second weight members 510 and 520 and relevant elements are referred to by like reference numerals, and repeated descriptions thereof are omitted or will be briefly given.

Referring to FIGS. 33 and 34, an acoustic apparatus 30 according to another embodiment of the present disclosure can further include at least one first weight member 510 and at least one second weight member 520.

The at least one first and second weight members 510 and 520 can be configured to increase a weight of a first vibration apparatus 210 and a second vibration apparatus 220. For example, each of the first vibration apparatus 210 and the second vibration apparatus 220 can include a contact surface contacting each of a first vibration member 110 and a second vibration member 120 and an exposure surface opposite to the contact surface. The at least one first and second weight members 510 and 520 can be disposed or configured at the exposure surface of each of the first vibration member 110 and the second vibration member 120. The at least one first and second weight members 510 and 520 can be disposed on the exposure surface of each of the first vibration member 110 and the second vibration member 120, or can be disposed between adjacent vibration apparatuses 200 of the plurality of vibration apparatuses 200. The at least one first and second weight members 510 and 520 can be substantially the same as the at least one weight member 500 described above with reference to FIGS. 17 and 18, and thus, repeated descriptions thereof are omitted.

Each of the first vibration apparatus 210 and the second vibration apparatus 220 can include a plurality of vibration apparatuses. For example, the first vibration apparatus 210 can include a plurality of first vibration apparatuses 211 to 216. For example, the second vibration apparatus 220 can include a plurality of second vibration apparatuses 221 to 226.

The at least one first weight member 510 can be disposed on exposure surfaces of the plurality of first vibration apparatuses 211 to 216, or can be between adjacent first vibration apparatuses 211 to 216. For example, the at least one first weight member 510 can be disposed to be symmetrical with one another on the exposure surfaces of the plurality of first vibration apparatuses 211 to 216 with respect to a center portion (or a first center line CL1 or a second center line CL2-1) of the first vibration member 110. For example, the at least one first weight member 510 can be disposed to be symmetrical with one another with respect to the first center line CL1 of the first vibration member 110. The at least one first weight member 510 can overlap the second center line CL2-1 of the first vibration member 110, or can be disposed to be symmetrical with one another with respect to the second center line CL2-1.

The at least one second weight member 520 can be disposed on exposure surfaces of the plurality of second vibration apparatuses 221 to 226, or can be between adjacent first vibration apparatuses 221 to 226. For example, the at least one second weight member 520 can be disposed to be symmetrical with one another on the exposure surfaces of the plurality of second vibration apparatuses 221 to 226 with respect to a center portion (or a first center line CL1 or a second center line CL2-2) of the second vibration member 120. For example, the at least one second weight member 520 can be disposed to be symmetrical with one another with respect to the first center line CL1 of the second vibration member 120. The at least one second weight member 520 can overlap the second center line CL2-2 of the second vibration member 120, or can be disposed to be symmetrical with one another with respect to the second center line CL2-2.

Referring to FIG. 33, at least one first weight member 510 disposed on exposure surfaces of a plurality of first vibration apparatuses 211 to 216 configured in a first vibration member 110 and at least one second weight member 520 disposed on exposure surfaces of a plurality of second vibration apparatuses 221 to 226 configured in a second vibration member 120 can be disposed to be symmetrical with one another. For example, the at least one first weight member 510 and the at least one second weight member 520 can be disposed to be symmetrical with each other on exposure surfaces of each of at least one first vibration apparatus 210 and at least one second vibration apparatus 220.

The at least one first weight member 510 disposed in the plurality of first vibration apparatuses 211 to 216 can include a plurality of first weight members 511 to 518. For example, the plurality of first weight members 511 to 518 can include a first-1 weight member 511, a first-2 weight member 512, a first-3 weight member 513, a first-4 weight member 514, a first-5 weight member 515, a first-6 weight member 516, a first-7 weight member 517, and a first-8 weight member 518.

The first-1 to first-8 weight members 511 to 518 can be disposed to be symmetrical with one another with respect to a center portion (or a first center line CL1 or a second center line CL2-1) of the first vibration member 110.

The first-1 weight member 511 and the first-2 weight member 512 can be disposed to be symmetrical with each other at one side or the other side in a second direction Y with respect to a center portion CP1-1 of the first vibration generator 211 or the fourth vibration generator 214 among the plurality of first vibration apparatuses 211 to 216.

The first-3 weight member 513 can overlap the second center line CL2-1 of the first vibration member 110 and can be disposed between the first vibration generator 211 and the second vibration generator 212 or between the fourth vibration generator 214 and the fifth vibration generator 215 among the plurality of first vibration apparatuses 211 to 216.

The first-4 weight member 514 can overlap the second center line CL2-1 of the first vibration member 110 and can be disposed between the first vibration generator 211 and the third vibration generator 213 or between the fourth vibration generator 214 and the sixth vibration generator 216 among the plurality of first vibration apparatuses 211 to 216.

The first-5 weight member 515 and the first-6 weight member 516 can be disposed to be symmetrical with each other at one side or the other side of the second vibration generator 212 or the fifth vibration generator 215 in the second direction Y among the plurality of first vibration apparatuses 211 to 216 with respect to the second center line CL2-1 of the first vibration member 110.

The first-7 weight member 517 and the first-8 weight member 518 can be disposed to be symmetrical with each other at one side or the other side of the third vibration generator 213 or the sixth vibration generator 216 in the second direction Y among the plurality of first vibration apparatuses 211 to 216 with respect to the second center line CL2-1 of the first vibration member 110.

At least one second weight member 520 disposed in the plurality of second vibration apparatuses 221 to 226 can include a plurality of second weight members 521 to 528. For example, the plurality of second weight members 521 to 528 can include a second-1 weight member 521, a second-2 weight member 522, a second-3 weight member 523, a second-4 weight member 524, a second-5 weight member 525, a second-6 weight member 526, a second-7 weight member 527, and a second-8 weight member 528.

The second-1 to second-8 weight members 521 to 528 can be disposed to be symmetrical with one another with respect to a center portion (or a first center line CL1 or a second center line CL2-2) of the second vibration member 120.

The second-1 weight member 521 and the second-2 weight member 522 can be disposed to be symmetrical with each other at one side or the other side in the second direction Y with respect to a center portion CP1-2 of the first vibration generator 221 or the fourth vibration generator 224 among the plurality of second vibration apparatuses 221 to 226.

The second-3 weight member 523 can overlap the second center line CL2-2 of the second vibration member 120 and can be disposed between the first vibration generator 221 and the second vibration generator 222 or between the fourth vibration generator 224 and the fifth vibration generator 225 among the plurality of second vibration apparatuses 221 to 226.

The second-4 weight member 524 can overlap the second center line CL2-2 of the second vibration member 120 and can be disposed between the first vibration generator 221 and the third vibration generator 223 or between the fourth vibration generator 224 and the sixth vibration generator 226 among the plurality of second vibration apparatuses 221 to 226.

The second-5 weight member 525 and the second-6 weight member 526 can be disposed to be symmetrical with each other at one side or the other side of the second vibration generator 222 or the fifth vibration generator 225 in the second direction Y among the plurality of second vibration apparatuses 221 to 226 with respect to the second center line CL2-2 of the second vibration member 120.

The second-7 weight member 527 and the second-8 weight member 528 can be disposed to be symmetrical with each other at one side or the other side of the third vibration generator 223 or the sixth vibration generator 226 in the second direction Y among the plurality of second vibration apparatuses 221 to 226 with respect to the second center line CL2-2 of the second vibration member 120.

Referring to FIG. 34, at least one first weight member 510 disposed on exposure surfaces of a plurality of first vibration apparatuses 211 to 216 configured in a first vibration member 110 and at least one second weight member 520 disposed on exposure surfaces of a plurality of second vibration apparatuses 221 to 226 configured in a second vibration member 120 can be disposed to be asymmetrical with one another. For example, the at least one first weight member 510 and the at least one second weight member 520 can be disposed to be asymmetrical with each other on exposure surfaces of each of at least one first vibration apparatus 210 and at least one second vibration apparatus 220.

The at least one first weight member 510 disposed in the plurality of first vibration apparatuses 211 to 216 can include a plurality of first weight members 511 to 518. For example, the plurality of first weight members 511 to 518 can include a first-1 weight member 511, a first-2 weight member 512, a first-3 weight member 513, a first-4 weight member 514, a first-5 weight member 515, a first-6 weight member 516, a first-7 weight member 517, and a first-8 weight member 518.

The first-1 to first-8 weight members 511 to 518 can be disposed to be symmetrical with one another with respect to a center portion (or a first center line CL1 or a second center line CL2-1) of the first vibration member 110.

The first-1 weight member 511 and the first-2 weight member 512 can be disposed to be symmetrical with each other at one side or the other side in the second direction Y with respect to a center portion CP1-1 of the first vibration generator 211 or the fourth vibration generator 214 among the plurality of first vibration apparatuses 211 to 216.

The first-3 weight member 513 can overlap the second center line CL2-1 of the first vibration member 110 and can be disposed between the first vibration generator 211 and the second vibration generator 212 or between the fourth vibration generator 214 and the fifth vibration generator 215 among the plurality of first vibration apparatuses 211 to 216.

The first-4 weight member 514 can overlap the second center line CL2-1 of the first vibration member 110 and can be disposed between the first vibration generator 211 and the third vibration generator 213 or between the fourth vibration generator 214 and the sixth vibration generator 216 among the plurality of first vibration apparatuses 211 to 216.

The first-5 weight member 515 and the first-6 weight member 516 can be disposed to be symmetrical with each other and adjacent to the center portion CP2-1 of the second vibration generator 212 or the fifth vibration generator 215 among the plurality of first vibration apparatuses 211 to 216 with respect to the second center line CL2-1 of the first vibration member 110.

The first-7 weight member 517 and the first-8 weight member 518 can be disposed to be symmetrical with each other and adjacent to the third vibration generator 213 or the sixth vibration generator 216 among the plurality of first vibration apparatuses 211 to 216 with respect to the second center line CL2-1 of the first vibration member 110.

At least one second weight member 520 disposed in the plurality of second vibration apparatuses 221 to 226 can include a plurality of second weight members 521 to 528. For example, the plurality of second weight members 521 to 528 can include a second-1 weight member 521, a second-2 weight member 522, a second-3 weight member 523, a second-4 weight member 524, a second-5 weight member 525, a second-6 weight member 526, a second-7 weight member 527, and a second-8 weight member 528.

The second-1 to second-8 weight members 521 to 528 can be disposed to be symmetrical with one another with respect to a center portion (or a first center line CL1 or a second center line CL2-2) of the second vibration member 120. The second-1 to second-8 weight members 521 to 528 can be disposed to be asymmetrical with at least some of the at least one first weight members 511 to 518 disposed in the plurality of first vibration apparatuses 211 to 216. For example, the plurality of second weight members 521 to 528 disposed in the plurality of second vibration apparatuses 221 to 226 can be disposed or configured at positions which differ from the plurality of first weight members 511 to 518 disposed in the plurality of first vibration apparatuses 211 to 216.

The second-1 weight member 521 and the second-2 weight member 522 can be disposed to be symmetrical with each other at one side or the other side in the second direction Y with respect to a center portion CP1-2 of the first vibration generator 221 or the fourth vibration generator 224 among the plurality of second vibration apparatuses 221 to 226 and can be disposed adjacent to both edge portions of the first vibration generator 221 or the fourth vibration generator 224 in the second direction Y.

The second-3 weight member 523 can overlap the second center line CL2-2 of the second vibration member 120 and can be disposed between the first vibration generator 221 and the second vibration generator 222 or between the fourth vibration generator 224 and the fifth vibration generator 225 among the plurality of second vibration apparatuses 221 to 226.

The second-4 weight member 524 can overlap the second center line CL2-2 of the second vibration member 120 and can be disposed between the first vibration generator 221 and the third vibration generator 223 or between the fourth vibration generator 224 and the sixth vibration generator 226 among the plurality of second vibration apparatuses 221 to 226.

The second-5 weight member 525 and the second-6 weight member 526 can be disposed to be symmetrical with each other at one side or the other side of the second vibration generator 222 or the fifth vibration generator 225 in the second direction Y among the plurality of second vibration apparatuses 221 to 226 with respect to the second center line CL2-2 of the second vibration member 120.

The second-7 weight member 527 and the second-8 weight member 528 can be disposed to be symmetrical with each other at one side or the other side of the third vibration generator 223 or the sixth vibration generator 226 in the second direction Y among the plurality of second vibration apparatuses 221 to 226 with respect to the second center line CL2-2 of the second vibration member 120.

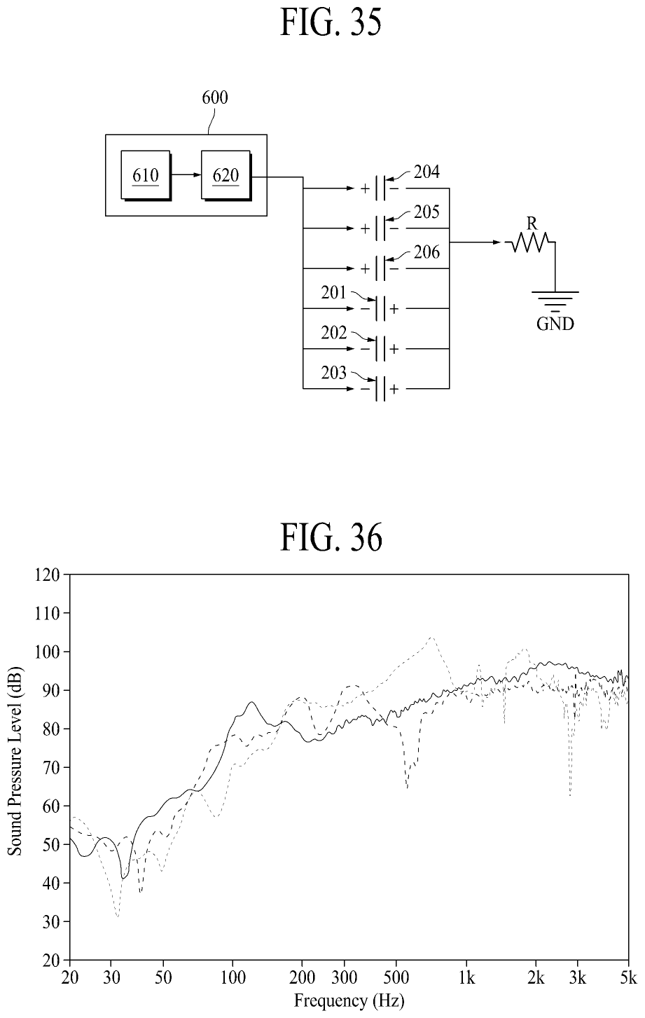

FIG. 35 illustrates a driving circuit of an acoustic apparatus according to an embodiment of the present disclosure. FIG. 35 illustrates an example where a driving circuit is applied based on an arrangement structure of the vibration apparatus 200 illustrated in FIGS. 8 to 13, but embodiments of the present disclosure are not limited thereto.

Referring to FIG. 35, a driving circuit 600 according to an embodiment of the present disclosure can include a sound processor 610 and a driving signal generator 620.

The sound processor 610 can receive an input signal (or sound source or sound data) input thereto according to control by a host controller of an apparatus and can transfer the received input signal to the driving signal generator 620.

The driving signal generator 620 can generate a driving signal (or vibration driving signal or voice signal), based on the input signal input from the sound processor 610, and can supply the driving signal to each of a plurality of vibration apparatuses 201 to 206. For example, the driving signal generator 620 can include a digital-to-analog converter (DAC) and an amplifier. For example, the plurality of vibration apparatuses 201 to 206 can be connected with a serial resistor R and a ground GND.

The driving signal generator 620 can be connected with the plurality of vibration apparatuses 201 to 206 and can supply different driving signals (or vibration driving signal or voice signal) to the plurality of vibration apparatuses 201 to 206. For example, the driving signal generator 620 can generate an alternating current (AC) driving signal including a first driving signal and a second driving signal, based on the input signal (or sound source or sound data) provided from the sound processor 610. For example, the first driving signal (or first vibration driving signal or first voice signal) can be one of a positive (+) driving signal and a negative (−) driving signal, and the second driving signal (or second vibration driving signal or second voice signal) can be one of the positive (+) driving signal and the negative (−) driving signal. For example, the first driving signal (or first vibration driving signal or first voice signal) can be one of a driving signal having a first voltage level and a driving signal having a second voltage level, and the second driving signal (or second vibration driving signal or second voice signal) can be one of the driving signal having the first voltage level and the driving signal having the second voltage level. For example, the first driving signal (or first vibration driving signal or first voice signal) and the second driving signal (or second vibration driving signal or second voice signal) can be a voltage signals having phases opposite to each other.

The driving signal generator 620 can be configured so that different driving signals are applied to fourth to sixth vibration generators 204 to 206 disposed at a second surface 100b of a vibration member 100 and first to third vibration generators 201 to 203 disposed at a first surface 100a of the vibration member 100. For example, the driving signal generator 620 can be configured so that a positive (+) first driving signal is applied to the fourth to sixth vibration generators 204 to 206 disposed at the second surface 100b of the vibration member 100 and a negative (−) second driving signal is applied to the first to third vibration generators 201 to 203 disposed at the first surface 100a of the vibration member 100. For example, the first driving signal and the second driving signal can have phases opposite to each other.

The driving circuit 600 according to an embodiment of the present disclosure can apply the driving signals having opposite phases to the first to third vibration generators 201 to 203 disposed at the first surface 100a of the vibration member 100 and the fourth to sixth vibration generators 204 to 206 disposed at the second surface 100b of the vibration member 100. Accordingly, the first to third vibration generators 201 to 203 and the fourth to sixth vibration generators 204 to 206 can be driven in a bimorph structure which is vibration-driven in the same direction, and thus, a sound characteristic and/or a sound pressure level characteristic of a sound can be more enhanced.

FIG. 36 illustrates a sound output characteristic of an acoustic apparatus according to an embodiment of the present disclosure.

In FIG. 36, the abscissa axis represents a frequency (Hz), and the ordinate axis represents a sound pressure level (SPL) (decibel (dB)). A solid line represents a sound output characteristic of a configuration where the plurality of weight members 510 and 520 are applied to the acoustic apparatus 30 described above with reference to FIG. 31. A thin dotted line represents a sound output characteristic of a configuration where a weight member is not applied to the acoustic apparatus 30 described above with reference to FIG. 31. A thick dotted line represents a sound output characteristic of a configuration where a weight member is applied to only a center of the acoustic apparatus 30 described above with reference to FIG. 31.

A sound output characteristic can be measured by a sound analysis apparatus. The sound analysis apparatus can include a sound card which transmits or receives a sound to or from a control personal computer (PC), an amplifier which amplifies a signal generated from the sound card and transfers the amplified signal to a vibration apparatus, and a microphone which collects a sound generated in an acoustic apparatus on the basis of driving of the vibration apparatus. The sound collected through the microphone can be input to the control PC through the sound card, and a control program can check the input sound to analyze a sound output characteristic of the acoustic apparatus.

A sound output characteristic has been measured in a half anechoic chamber. In measuring, a serial resistor of 3Ω(ohm) has been installed in an acoustic apparatus, a driving voltage is 10 Vrms, a frequency signal applied from the outside has been applied as a sine sweep within a range of 20 Hz to 5 kHz, and a separation distance between an apparatus and a microphone is 1 m, however, a measurement method for a sound output characteristic is not limited thereto.

Referring to FIG. 36, comparing with the thin dotted line, in the solid line, it can be seen that a sound pressure level is high in a frequency range of 40 Hz to 170 Hz and a peak phenomenon and/or a dip phenomenon decreases in a pitched sound band of 200 Hz or more, and thus, a flatness characteristic of a sound pressure level is enhanced. Comparing with the thick dotted line, in the solid line, it can be seen that a sound pressure level is high in a frequency range of 90 Hz to 170 Hz and a peak phenomenon and/or a dip phenomenon decreases in a pitched sound band of 200 Hz or more, and thus, a flatness characteristic of a sound pressure level is enhanced. The peak can be a phenomenon where a sound pressure level bounces in a specific frequency, and the dip can be a phenomenon where a low sound pressure level is generated as the occurrence of a sound having a specific frequency is prevented. The flatness of a sound pressure level can be a difference between a highest sound pressure level and a lowest sound pressure level in a specific frequency.

Accordingly, in the acoustic apparatus according to an embodiment of the present disclosure, because the plurality of weight members 510 and 520 are provided, a sound characteristic and/or a sound pressure level characteristic of a low-pitched sound band can be enhanced, and a flatness characteristic of a sound pressure level of a high-pitched sound band and a middle-low-pitched sound band of 200 Hz or more can be enhanced.

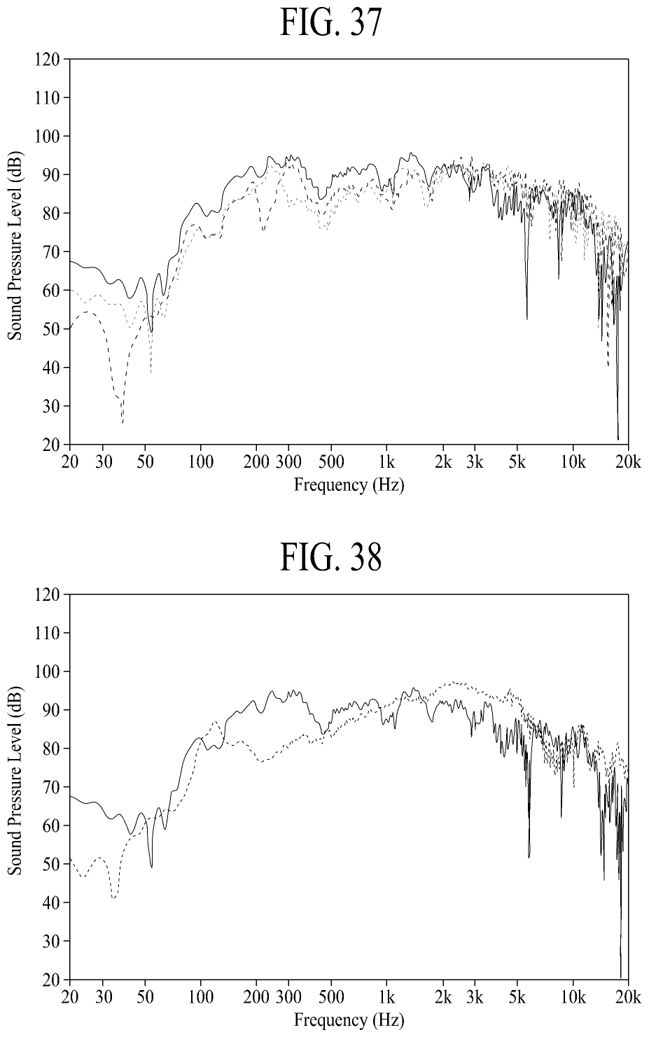

FIG. 37 illustrates a sound output characteristic of an acoustic apparatus according to an embodiment of the present disclosure.

In FIG. 37, the abscissa axis represents a frequency (Hz), and the ordinate axis represents a sound pressure level (SPL) (decibel (dB)). A solid line represents a sound output characteristic of a configuration where the plurality of first and second weight members 510 and 520 illustrated in FIG. 34 are applied to the acoustic apparatus 30 described above with reference to FIG. 31. A thin dotted line represents a sound output characteristic of a configuration where the plurality of second weight members 520 illustrated in FIG. 34 are applied to the acoustic apparatus 30 described above with reference to FIG. 31. A thick dotted line represents a sound output characteristic of a configuration where the plurality of first weight members 510 illustrated in FIG. 34 are applied to the acoustic apparatus 30 described above with reference to FIG. 31.

Except for that an applied frequency signal is applied as a sine sweep up to a range of 20 Hz to 20 kHz, a measurement method for a sound output characteristic can be substantially the same as the description of FIG. 36, and thus, repeated descriptions thereof are omitted.

Referring to FIG. 37, comparing with the thin dotted line and the thick dotted line, in the solid line, it can be seen that a sound pressure level is high in a full frequency range and a peak phenomenon and/or a dip phenomenon decreases in a pitched sound band of 200 Hz or more, and thus, a flatness characteristic of a sound pressure level is enhanced.

Accordingly, in the acoustic apparatus according to an embodiment of the present disclosure, because the plurality of first weight members 510 and the plurality of second weight members 520 respectively disposed in the first vibration apparatus 110 and the second vibration apparatus 120 are asymmetrical with one another, a sound characteristic and/or a sound pressure level characteristic can be enhanced in a full frequency range, and a flatness characteristic of a sound pressure level of a high-pitched sound band and a middle-low-pitched sound band of 200 Hz or more can be enhanced.

FIG. 38 illustrates a sound output characteristic of an acoustic apparatus according to an embodiment of the present disclosure.

In FIG. 38, the abscissa axis represents a frequency (Hz), and the ordinate axis represents a sound pressure level (SPL) (decibel (dB)). A solid line represents a sound output characteristic of a configuration where the plurality of first and second weight members 510 and 520 illustrated in FIG. 34 are applied to the acoustic apparatus 30 described above with reference to FIG. 31. A dotted line represents a sound output characteristic of a configuration where the plurality of first and second weight members 510 and 520 illustrated in FIG. 33 are applied to the acoustic apparatus 30 described above with reference to FIG. 31.

Except for that an applied frequency signal is applied as a sine sweep up to 20 Hz to 20 kHz, a measurement method for a sound output characteristic can be substantially the same as the description of FIG. 36, and thus, repeated descriptions thereof are omitted.

Referring to FIG. 38, comparing with the dotted line, in the solid line, it can be seen that a sound pressure level is high in a frequency range of 50 Hz or less, and a sound pressure level is high in a frequency range of 70 Hz to 100 Hz and 150 Hz to 900 Hz. Comparing with the solid line, in the dotted line, it can be seen that a dip phenomenon and/or a peak phenomenon decrease in a pitched sound band of 200 Hz or more, and thus, a flatness characteristic of a sound pressure level is enhanced.

Accordingly, in the acoustic apparatus according to an embodiment of the present disclosure, because the plurality of first weight members 510 and the plurality of second weight members 520 respectively disposed in the first vibration apparatus 110 and the second vibration apparatus 120 are asymmetrical with one another, a sound characteristic and/or a sound pressure level characteristic of a low-pitched sound band and a middle-low-pitched sound band of 900 Hz or less can be enhanced. Further, in the acoustic apparatus according to an embodiment of the present disclosure, because the plurality of first weight members 510 and the plurality of second weight members 520 respectively disposed in the first vibration apparatus 110 and the second vibration apparatus 120 are symmetrical with one another, a sound characteristic and/or a sound pressure level characteristic of a high-pitched sound band and a middle-low-pitched sound band of 200 Hz or more can be enhanced.

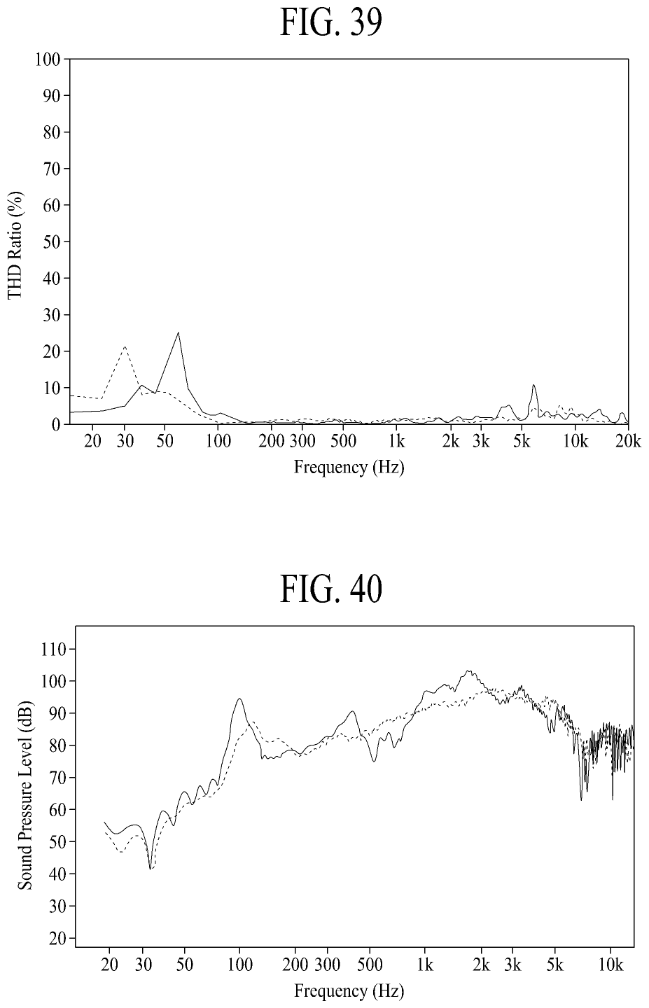

FIG. 39 illustrates a total harmonic distortion characteristic of an acoustic apparatus according to an embodiment of the present disclosure.

In FIG. 39, the abscissa axis represents a frequency (Hz), and the ordinate axis represents a total harmonic distortion (THD) ratio (%). A solid line represents a THD ratio of a configuration where the plurality of first and second weight members 510 and 520 illustrated in FIG. 34 are applied to the acoustic apparatus 30 described above with reference to FIG. 31. A dotted line represents a THD ratio of a configuration where the plurality of first and second weight members 510 and 520 illustrated in FIG. 33 are applied to the acoustic apparatus 30 described above with reference to FIG. 31. THD can denote the distortion of a sound. For example, THD can be a phenomenon where only a desired frequency is not reproduced in a sound signal applied from the outside and is dispersed to a peripheral frequency, and due to this, undesired harmonic components occur to cause distortion.

Referring to FIG. 39, it can be seen that the solid line and the dotted line have a THD characteristic of 3% or less within a frequency range of 140 Hz to 4 kHz. It can be seen that the dotted line has a THD characteristic of 20% or more in a frequency of 60 Hz, and the solid line has a THD characteristic of 20% or more in a frequency of 30 Hz and causes fluctuation of a THD characteristic in a frequency range of 4 kHz or more. It can be seen that, as a THD ratio decreases, the distortion or noise of a sound is reduced, and thus, as a THD ratio decreases, a desired reproduction sound where the distortion or noise of a sound is small in a desired frequency range is output.

Accordingly, in the acoustic apparatus according to an embodiment of the present disclosure, because the plurality of first weight members 510 and the plurality of second weight members 520 respectively disposed in the first vibration apparatus 110 and the second vibration apparatus 120 are symmetrical and/or asymmetrical with one another, a THD ratio of 3% or less is low in a frequency range of 140 Hz to 4 kHz, and because there is no rapid fluctuation period in a frequency area, a flatness characteristic of a sound pressure level can be enhanced.

FIG. 40 illustrates a sound output characteristic of an acoustic apparatus according to an embodiment of the present disclosure.

In FIG. 40, the abscissa axis represents a frequency (Hz), and the ordinate axis represents a sound pressure level (SPL) (decibel (dB)). A solid line represents a sound output characteristic of a configuration where a size of the housing 300 in the acoustic apparatus 30 described above with reference to FIG. 31 is set to a horizontal width of 355 mm, a vertical length of 270 mm, and a height of 80 mm. A dotted line represents a sound output characteristic of a configuration where a size of the housing 300 in the acoustic apparatus 30 described above with reference to FIG. 31 is set to a horizontal width of 355 mm, a vertical length of 270 mm, and a height of 50 mm.

Except for that an applied frequency signal is applied as a sine sweep up to 10 Hz to 20 kHz, a measurement method for a sound output characteristic can be substantially the same as the description of FIG. 36, and thus, repeated descriptions thereof are omitted.

Referring to FIG. 40, it can be seen that the solid line represents that a primary peak frequency response has a sound pressure level of about 95 dB in a frequency of 100 Hz, and the dotted line represents that a primary peak frequency response has a sound pressure level of about 87 dB in a frequency of 150 Hz. Comparing with the dotted line, in the solid line, it can be seen that a primary peak frequency area decreases by 100 Hz, and a sound pressure level of about 95 dB is high. Comparing with the solid line, in the dotted line, it can be seen that a peak phenomenon and/or a dip phenomenon decrease in a pitched sound band of 200 Hz or more, and thus, a flatness characteristic of a sound pressure level is enhanced.

Therefore, in the acoustic apparatus according to an embodiment of the present disclosure, as a size (or capacity) of the housing 300 increases, a primary peak frequency can decrease and a sound pressure level can increase in a low-pitched sound band, and thus, a sound characteristic and/or a sound pressure level characteristic of a low-pitched sound band can be enhanced. For example, in the acoustic apparatus according to an embodiment of the present disclosure, the vibration apparatuses 210 and 220 configured with two woofers can be provided, and thus, a sound characteristic and/or a sound pressure level characteristic of the low-pitched sound band can be enhanced. Further, in the acoustic apparatus according to an embodiment of the present disclosure, a size (or capacity) of the housing 300 can be reduced, and thus, a flatness characteristic of a high-pitched sound band and a middle-low-pitched sound band of 200 Hz or more can be enhanced.

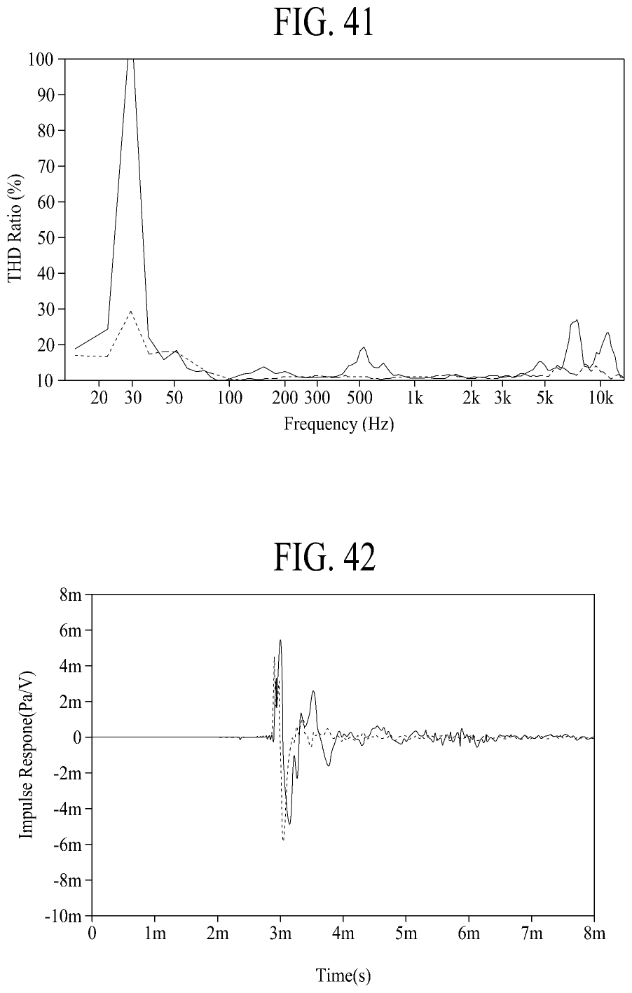

FIG. 41 illustrates a THD characteristic of an acoustic apparatus according to an embodiment of the present disclosure.

In FIG. 41, the abscissa axis represents a frequency (Hz), and the ordinate axis represents a THD ratio (%). A solid line represents a sound output characteristic of a configuration where a size of the housing 300 in the acoustic apparatus 30 described above with reference to FIG. 31 is set to a horizontal width of 355 mm, a vertical length of 270 mm, and a height of 80 mm. A dotted line represents a THD ratio of a configuration where a size of the housing 300 in the acoustic apparatus 30 described above with reference to FIG. 31 is set to a horizontal width of 355 mm, a vertical length of 270 mm, and a height of 50 mm. A measurement result of a THD ratio has been obtained by performing 1/12 octave smoothing.

Referring to FIG. 41, it can be seen that the solid line and the dotted line have a THD characteristic of 10% or less within a frequency range of 40 Hz to 6 kHz. It can be seen that the dotted line has a low THD characteristic of 3% or less in a frequency range of 70 Hz to 5 kHz, and the solid line has a THD characteristic of 3% or less in a frequency range of 70 Hz to 150 Hz, 200 Hz to 420 Hz, and 750 Hz to 4 kHz.

Accordingly, the acoustic apparatus according to an embodiment of the present disclosure can have a THD characteristic of 10% or less within a frequency range of 40 Hz to 6 kHz. Particularly, as a size (or capacity) of the housing 300 decreases, the acoustic apparatus according to an embodiment of the present disclosure can have a low THD characteristic of 3% or less in a frequency range of 70 Hz to 5 kHz, and because there is no rapid fluctuation period in a frequency area, a flatness characteristic of a sound pressure level can be more enhanced.

FIG. 42 illustrates an impulse response characteristic of an acoustic apparatus according to an embodiment of the present disclosure.

In FIG. 42, the abscissa axis represents a time (msec), and the ordinate axis represents an impulse response (Pa/V).

A solid line represents a sound output characteristic of a configuration where a size of the housing 300 in the acoustic apparatus 30 described above with reference to FIG. 31 is set to a horizontal width of 355 mm, a vertical length of 270 mm, and a height of 80 mm. A dotted line represents an impulse response characteristic of a configuration where a size of the housing 300 in the acoustic apparatus 30 described above with reference to FIG. 31 is set to a horizontal width of 355 mm, a vertical length of 270 mm, and a height of 50 mm.

Referring to FIG. 42, in the solid line and the dotted line, it can be seen that an impulse response is output in 3 msec. It can be seen that the solid line represents that a residual impulse response is shown up to 6 msec after 3 msec, and the dotted line represents that a residual impulse response is shown up to 4 msec after 3 msec. Comparing with the dotted line, in the solid line, it can be seen that a residual impulse response is long shown up to 6 msec, and thus, a sound characteristic and/or a sound pressure level characteristic of a low-pitched sound band can be enhanced.

Therefore, in the acoustic apparatus according to an embodiment of the present disclosure, as a size (or capacity) of the housing 300 increases, a residual impulse response can be shown up to 6 msec, and thus, a sound characteristic and/or a sound pressure level characteristic of the low-pitched sound band can be enhanced. For example, in the acoustic apparatus according to an embodiment of the present disclosure, the vibration apparatuses 210 and 220 configured with two woofers can be provided, and thus, a sound characteristic and/or a sound pressure level characteristic of the low-pitched sound band can be enhanced.

An acoustic apparatus according to various embodiments of the present disclosure will be described below.

An acoustic apparatus according to various embodiments of the present disclosure can include a vibration member having a first length in a first direction that is longer than a second length in a second direction perpendicular to the first direction, at least one vibration apparatus including a long side in the second direction, and a housing configured to include an internal space provided at a rear surface of the vibration member.

According to various embodiments of the present disclosure, the first length of the vibration member can intersect with the long side of the at least one vibration apparatus.

According to various embodiments of the present disclosure, the at least one vibration apparatus can be disposed on at least one surface of the vibration member.

According to various embodiments of the present disclosure, the at least one vibration apparatus can be connected with a front surface of the vibration member, or can be connected with a rear surface of the vibration member, or can be connected with the front surface and the rear surface of the vibration member.

According to various embodiments of the present disclosure, the at least one vibration apparatus can be symmetrical with respect to a center portion of the vibration member in the first direction.

According to various embodiments of the present disclosure, the at least one vibration apparatus can be disposed to either overlap or not overlap the center portion of the vibration member in the first direction.

According to various embodiments of the present disclosure, the at least one vibration apparatus can include a first vibration apparatus disposed at a front surface of the vibration member and a second vibration apparatus disposed at a rear surface of the vibration member, and the first vibration apparatus and the second vibration apparatus can be disposed to overlap each other.

According to various embodiments of the present disclosure, the at least one vibration apparatus can include a plurality of vibration apparatuses, and the plurality of vibration apparatuses can be disposed to be spaced apart from one another in the first direction on the vibration member.

According to various embodiments of the present disclosure, the plurality of vibration apparatuses disposed on the vibration member can be disposed to be symmetrical with one another with respect to a center portion of the vibration member in the first direction.

According to various embodiments of the present disclosure, the plurality of vibration apparatuses can be provided as an odd number or even number, and one of the plurality of vibration apparatuses can be disposed to overlap the center portion of the vibration member in the first direction when the plurality of vibration apparatuses are provided as an odd number, and none of the plurality of vibration apparatuses can be disposed to overlap the center portion of the vibration member in the first direction when the plurality of vibration apparatuses are provided as the even number.

According to various embodiments of the present disclosure, the plurality of vibration apparatuses can be provided as an even number, and the plurality of vibration apparatuses can be disposed not to overlap the center portion of the vibration member in the first direction.

According to various embodiments of the present disclosure, the plurality of vibration apparatuses disposed at a front surface of the vibration member and the plurality of vibration apparatuses disposed at a rear surface of the vibration member can be disposed to overlap each other.

According to various embodiments of the present disclosure, the acoustic apparatus can further include at least one duct connecting an internal space of the housing with the outside.

According to various embodiments of the present disclosure, the at least one duct can be disposed at a periphery of each of both edges of the vibration member in the first direction.

According to various embodiments of the present disclosure, the at least one duct can be disposed between the vibration member and the housing.

According to various embodiments of the present disclosure, the at least one duct need not overlap the vibration member with respect to a plane.

According to various embodiments of the present disclosure, the housing can include a supporting portion configured to support a periphery of the vibration member, and a bottom portion connected to the supporting portion with the internal space between the bottom portion and the vibration member.

According to various embodiments of the present disclosure, the supporting portion can protrude vertically from the bottom portion, and can be connected with a rear surface of a periphery of the vibration member.

According to various embodiments of the present disclosure, the acoustic apparatus can further include a connection portion between the supporting portion and the bottom portion, and having a curvature.

According to various embodiments of the present disclosure, the supporting portion can include a first supporting portion connected with the bottom portion to protrude vertically from the bottom portion, and a second supporting portion connected with the first supporting portion in parallel to the bottom portion and connected with a periphery of the vibration member.

According to various embodiments of the present disclosure, the second supporting portion can be connected with the rear surface of the vibration member at a periphery thereof.

According to various embodiments of the present disclosure, the second supporting portion can include a groove portion accommodating at least a portion of a lateral surface and the rear surface of the vibration member at a periphery thereof.

According to various embodiments of the present disclosure, the second supporting portion can include at least one duct connecting an internal space of the housing with the outside.

According to various embodiments of the present disclosure, the at least one duct can be disposed in the second supporting portion at a periphery of each of both edges of the vibration member in the first direction.

According to various embodiments of the present disclosure, at least one duct can be disposed in the second supporting portion at a periphery of the vibration member.

According to various embodiments of the present disclosure, the at least one vibration apparatus can include a contact surface contacting the vibration member and an exposure surface opposite to the contact surface, and the acoustic apparatus can further include at least one weight member disposed at the exposure surface of the at least one vibration apparatus.

According to various embodiments of the present disclosure, the at least one vibration apparatus can include a plurality of vibration apparatuses, and the at least one weight member can be disposed on exposure surfaces of the plurality of vibration apparatuses, or can be disposed between adjacent vibration apparatuses among the plurality of vibration apparatuses.

According to various embodiments of the present disclosure, the at least one weight member can include a plurality of weight members, and the plurality of weight members can be disposed to be symmetrical with one another on the exposure surfaces of the plurality of vibration apparatuses, respectively, with respect to a center portion of the vibration member in the first direction.

According to various embodiments of the present disclosure, the housing can include a first area and a second area adjacent to the first area in the second direction, the vibration member can include a first vibration member provided in the first area of the housing, and a second vibration member provided in the second area of the housing, and the at least one vibration apparatus can include at least one first vibration apparatus connected with the first vibration member, and at least one second vibration apparatus connected with the second vibration member.

According to various embodiments of the present disclosure, the first vibration member and the second vibration member can be parallel to each other in the first direction and can be disposed to be spaced apart from each other in the second direction.

According to various embodiments of the present disclosure, the at least one first vibration apparatus and the at least one second vibration apparatus can be disposed to be symmetrical with each other in each of the first vibration member and the second vibration member.

According to various embodiments of the present disclosure, the housing can include a supporting portion configured to support a periphery of each of the first vibration member and the second vibration member, and a bottom portion provided in parallel to the first vibration member and the second vibration member with the internal space therebetween.

According to various embodiments of the present disclosure, the supporting portion can include a first supporting portion connected with the bottom portion and provided to protrude vertically from the bottom portion, and the first supporting portion surround the first area and the second area, and a second supporting portion connected with the first supporting portion in parallel to the bottom portion and connected with the periphery of each of the first vibration member and the second vibration member.

According to various embodiments of the present disclosure, the housing can further include a third supporting portion protruding vertically from the bottom portion between the first area and the second area.

According to various embodiments of the present disclosure, the third supporting portion can protrude vertically from the bottom portion and can separate the internal space of each of the first area and the second area.

According to various embodiments of the present disclosure, the third supporting portion can be disposed between the second supporting portion and the bottom portion.

According to various embodiments of the present disclosure, each of the at least one first vibration apparatus and the at least one second vibration apparatus can include a contact surface contacting each of the first vibration member and the second vibration member and an exposure surface opposite to the contact surface, and the acoustic apparatus can further include a plurality of weight members disposed at the exposure surface of each of the at least one first vibration apparatus and the at least one second vibration apparatus.

According to various embodiments of the present disclosure, the plurality of weight members can include at least one first weight member disposed at the exposure surface of the at least one first vibration apparatus, and at least one second weight member disposed at the exposure surface of the at least one second vibration apparatus.

According to various embodiments of the present disclosure, the at least one first weight member and the at least one second weight member can be disposed to be symmetrical with each other at the exposure surface of each of the at least one first vibration apparatus and the at least one second vibration apparatus.

According to various embodiments of the present disclosure, the at least one first weight member and the at least one second weight member can be disposed to be asymmetrical with each other at the exposure surface of each of the at least one first vibration apparatus and the at least one second vibration apparatus.

According to various embodiments of the present disclosure, each of the at least one vibration apparatus can include a vibration portion including a piezoelectric material, and a cover member configured to cover one or more of a first surface of the vibration portion and a second surface, which is opposite to the first surface, of the vibration portion.

According to various embodiments of the present disclosure, the vibration member can include one or more of a metal material, plastic, fiber reinforced plastic, fiber, leather, wood, cloth, rubber, carbon, glass, and paper.

An acoustic apparatus according to various embodiments of the present disclosure can include a vibration member having a first length in a first direction and a second length in a second direction, the first length of the vibration member being greater than the second length of the vibration member, a vibration apparatus on the vibration member and having a first length in the first direction and a second length in the second direction, the second length of the vibration apparatus being greater than the first length of the vibration apparatus, and a housing under the vibration member and having a first length in the first direction and a second length in the second direction, the first length of the housing being greater than the second length of the housing. The first length of the housing can be greater than or equal to the first length of the vibration member, and the second length of the housing can be greater than or equal to the second length of the vibration member.

According to various embodiments of the present disclosure, the vibration apparatus can include a first vibration apparatus disposed at a front surface of the vibration member and a second vibration apparatus disposed at a front surface of the vibration member, and the first vibration apparatus and the second vibration apparatus can be disposed to overlap each other.

According to various embodiments of the present disclosure, can further include at least one duct connecting an internal space of the housing with an outside.

According to various embodiments of the present disclosure, the at least one duct can be disposed between the vibration member and the housing.

According to various embodiments of the present disclosure, the at least one vibration apparatus can include a contact surface contacting the vibration member and an exposure surface opposite to the contact surface, and the acoustic apparatus can further include at least one weight member disposed at the exposure surface of the vibration apparatus.

According to various embodiments of the present disclosure, the vibration apparatus can include a plurality of vibration apparatuses, and the at least one weight member can be disposed on exposure surfaces of the plurality of vibration apparatuses, or can be disposed between adjacent vibration apparatuses among the plurality of vibration apparatuses.

It will be apparent to those skilled in the art that various modifications and variations can be made in the apparatus of the present disclosure without departing from the scope of the disclosure. Thus, it is intended that the present disclosure cover the modifications and variations of this disclosure provided that within the scope of the claims and their equivalents.

What is claimed is:

1. An acoustic apparatus, comprising:
a vibration member having a first length in a first direction that is longer than a second length in a second direction perpendicular to the first direction;
at least one vibration apparatus including a long side in the second direction; and
a housing including an internal space provided at a rear surface of the vibration member.

2. The acoustic apparatus of claim 1, wherein the first length of the vibration member intersects with the long side of the at least one vibration apparatus.

3. The acoustic apparatus of claim 1, wherein the at least one vibration apparatus is connected with a front surface of the vibration member, or is connected with a rear surface of the vibration member, or is connected with the front surface and the rear surface of the vibration member.

4. The acoustic apparatus of claim 1, wherein the at least one vibration apparatus is symmetrical with respect to a center portion of the vibration member in the first direction.

5. The acoustic apparatus of claim 4, wherein the at least one vibration apparatus is disposed to either overlap or not overlap the center portion of the vibration member in the first direction.

6. The acoustic apparatus of claim 1, wherein the at least one vibration apparatus includes a first vibration apparatus disposed at a front surface of the vibration member and a second vibration apparatus disposed at a rear surface of the vibration member, and
wherein the first vibration apparatus and the second vibration apparatus are disposed to overlap each other.

7. The acoustic apparatus of claim 1, wherein the at least one vibration apparatus comprises a plurality of vibration apparatuses, and
wherein the plurality of vibration apparatuses are disposed to be spaced apart from one another in the first direction on the vibration member.

8. The acoustic apparatus of claim 7, wherein the plurality of vibration apparatuses disposed on the vibration member are disposed to be symmetrical with one another with respect to a center portion of the vibration member in the first direction.

9. The acoustic apparatus of claim 8, wherein the plurality of vibration apparatuses are provided as an odd number or even number, and
wherein one of the plurality of vibration apparatuses is disposed to overlap the center portion of the vibration member in the first direction when the plurality of vibration apparatuses are provided as an odd number, and none of the plurality of vibration apparatuses is disposed to overlap the center portion of the vibration member in the first direction when the plurality of vibration apparatuses are provided as the even number.

10. The acoustic apparatus of claim 1, further comprising at least one duct connecting an internal space of the housing with an outside.

11. The acoustic apparatus of claim 10, wherein the at least one duct is disposed between the vibration member and the housing.

12. The acoustic apparatus of claim 1, wherein the housing comprises:
a supporting portion configured to support a periphery of the vibration member; and
a bottom portion connected to the supporting portion with the internal space between the bottom portion and the vibration member.

13. The acoustic apparatus of claim 12, wherein the supporting portion protrudes vertically from the bottom portion, and is connected with a rear surface of a periphery of the vibration member.

14. The acoustic apparatus of claim 13, further comprising a connection portion between the supporting portion and the bottom portion, and having a curvature.

15. The acoustic apparatus of claim 12, wherein the supporting portion comprises:
a first supporting portion connected with the bottom portion and protruding vertically from the bottom portion; and
a second supporting portion connected with the first supporting portion in parallel to the bottom portion and connected with a periphery of the vibration member.

16. The acoustic apparatus of claim 15, wherein the second supporting portion is connected with the rear surface of the vibration member at a periphery thereof.

17. The acoustic apparatus of claim 15, wherein the second supporting portion comprises a groove portion accommodating at least a portion of a lateral surface and the rear surface of the vibration member at a periphery thereof.

18. The acoustic apparatus of claim 15, wherein at least one duct is disposed in the second supporting portion at a periphery of the vibration member.

19. The acoustic apparatus of claim 1, wherein the at least one vibration apparatus comprises a contact surface contacting the vibration member and an exposure surface opposite to the contact surface, and
wherein the acoustic apparatus further comprises at least one weight member disposed at the exposure surface of the at least one vibration apparatus.

20. The acoustic apparatus of claim 19, wherein the at least one vibration apparatus comprises a plurality of vibration apparatuses, and
wherein the at least one weight member is disposed on exposure surfaces of the plurality of vibration apparatuses, or is disposed between adjacent vibration apparatuses among the plurality of vibration apparatuses.

21. The acoustic apparatus of claim 20, wherein the at least one weight member comprises a plurality of weight members, and
wherein the plurality of weight members are disposed to be symmetrical with one another on the exposure surfaces of the plurality of vibration apparatuses, respectively, with respect to a center portion of the vibration member in the first direction.

22. The acoustic apparatus of claim 1, wherein the housing comprises a first area and a second area adjacent to the first area in the second direction,
wherein the vibration member comprises:
a first vibration member at the first area of the housing; and
a second vibration member at the second area of the housing, and
wherein the at least one vibration apparatus comprises:
at least one first vibration apparatus connected with the first vibration member; and
at least one second vibration apparatus connected with the second vibration member.

23. The acoustic apparatus of claim 22, wherein the first vibration member and the second vibration member are parallel to each other in the first direction and are disposed to be spaced apart from each other in the second direction, or
wherein the at least one first vibration apparatus and the at least one second vibration apparatus are disposed to be symmetrical with each other in each of the first vibration member and the second vibration member.

24. The acoustic apparatus of claim 22, wherein the housing comprises:
a supporting portion configured to support a periphery of the first vibration member and the second vibration member; and
a bottom portion provided in parallel to the first vibration member and the second vibration member with the internal space therebetween.

25. The acoustic apparatus of claim 24, wherein the supporting portion comprises:
a first supporting portion connected with the bottom portion and provided to protrude vertically from the bottom portion, and the first supporting portion surrounding the first area and the second area; and
a second supporting portion connected with the first supporting portion in parallel to the bottom portion and connected with the periphery of each of the first vibration member and the second vibration member.

26. The acoustic apparatus of claim 25, wherein the housing further comprises a third supporting portion protruding vertically from the bottom portion between the first area and the second area.

27. The acoustic apparatus of claim 22, wherein each of the at least one first vibration apparatus and the at least one second vibration apparatus comprises a contact surface contacting each of the first vibration member and the second vibration member and an exposure surface opposite to the contact surface, and
wherein the acoustic apparatus further comprises a plurality of weight members disposed at the exposure surface of each of the at least one first vibration apparatus and the at least one second vibration apparatus.

28. The acoustic apparatus of claim 27, wherein the plurality of weight members comprises:
at least one first weight member disposed at the exposure surface of the at least one first vibration apparatus; and
at least one second weight member disposed at the exposure surface of the at least one second vibration apparatus.

29. The acoustic apparatus of claim 1, wherein each of the at least one vibration apparatus comprises:
a vibration part including a piezoelectric material; and
a cover member configured to cover one or more of a first surface of the vibration part and a second surface, which is opposite to the first surface, of the vibration part.

30. An acoustic apparatus, comprising:
a vibration member having a first length in a first direction and a second length in a second direction, the first length of the vibration member being greater than the second length of the vibration member;
a vibration apparatus on the vibration member and having a first length in the first direction and a second length in the second direction, the second length of the vibration apparatus being greater than the first length of the vibration apparatus; and
a housing under the vibration member and having a first length in the first direction and a second length in the second direction, the first length of the housing being greater than the second length of the housing,
wherein the first length of the housing is greater than or equal to the first length of the vibration member, and the second length of the housing is greater than or equal to the second length of the vibration member.

31. The acoustic apparatus of claim 30, wherein the vibration apparatus includes a first vibration apparatus disposed at a front surface of the vibration member and a second vibration apparatus disposed at a front surface of the vibration member, and
wherein the first vibration apparatus and the second vibration apparatus are disposed to overlap each other.

32. The acoustic apparatus of claim 30, further comprising at least one duct connecting an internal space of the housing with an outside.

33. The acoustic apparatus of claim 32, wherein the at least one duct is disposed between the vibration member and the housing.

34. The acoustic apparatus of claim 1, wherein the at least one vibration apparatus comprises a contact surface contacting the vibration member and an exposure surface opposite to the contact surface, and
wherein the acoustic apparatus further comprises at least one weight member disposed at the exposure surface of the vibration apparatus.

35. The acoustic apparatus of claim 34, wherein the vibration apparatus comprises a plurality of vibration apparatuses, and
wherein the at least one weight member is disposed on exposure surfaces of the plurality of vibration apparatuses, or is disposed between adjacent vibration apparatuses among the plurality of vibration apparatuses.
